(19) United States
(12) Patent Application Publication
(10) Pub. No.: US 2016/0104107 A1
(43) Pub. Date: Apr. 14, 2016

(54) SYSTEMS AND METHODS FOR DYNAMIC MANAGMENT OF OBJECT TRANSMISSION

(71) Applicant: Move Captain Holdings, LLC, Wilmington, DE (US)

(72) Inventor: Aldo Disorbo, Davie, FL (US)

(21) Appl. No.: 14/859,499

(22) Filed: Sep. 21, 2015

Related U.S. Application Data
(63) Continuation-in-part of application No. 14/825,283, filed on Aug. 13, 2015.
Application No. 14/825,283 is a continuation-in-part of application No. 14/840,299, filed on Aug. 31, 2015.
(60) Provisional application No. 62/059,961, filed on Oct. 5, 2014.

(51) Int. Cl. G06Q 10/08; G06Q 20/14

(52) U.S. Cl. CPC G06Q 10/0838; G06Q 10/087; G06Q 20/14

(57) ABSTRACT

A method for dynamically orchestrating a set of driver functions, the method comprising (1) authenticating credentials of a driver (2) displaying a main interface presenting a set of options to the driver (3) displaying an inventory list interface enumerating the items to be moved and packed (4) displaying a furniture list enumerating a set of items and an associated set of furniture attributes for each item in the set of items (5) displaying an estimate interface indicating a set of load attributes as received by the estimator at time of booking (6) presenting a set of valuation coverage options to the client to protect the contents of the move (7) displaying an inventory check in interface at the destination location for the client to inspect each item in the inventory and (8) presenting a final bill of lending to the client before displaying a payment screen interface for the driver to select a form of payment.

This application claims priority to provisional patent application 62/059,961 filed Oct. 5, 2014, patent application Ser. No. 14/825,283 filed Aug. 13, 2015 and Ser. No. 14/840,299 filed Aug. 31, 2015 and hereby incorporates each application by reference in its entirety.

### BACKGROUND

1. Field of Disclosure

The present invention relates to systems and methods for dynamically orchestrating a set of driver functions during transportation of a load from a source location to a destination location. More particularly, the invention relates to the use of a single portal for drivers configured to manage several stages of transportation assignments right from initial stage of generating an estimate to the final stage of conducting the customer survey.

2. Brief Description of Related Art

A driver working for a moving company (i.e., an entity which transports items belonging to a person or business from one location to another) may typically perform several driver functions to coordinate a set of transportation assignments. The driver functions, for example may include, but are not necessarily limited to management of equipment, management of time, keeping record of driver activity logs, observing ordinances, managing storage and/or condition of goods, and the like.

The transportation assignments may comprise transporting various items (e.g., perishable consumer goods, nonperishable commercial goods, residential goods which may comprise transporting furniture, appliances, personal belongings and the like) from one or more source locations to one or more destination locations. Managing the transportation of goods from a residence or business at one location to a residence or business at another location can be a complex and time-consuming process. A driver may typically have to spend a significant amount of time and resources to coordinate several aspects of a given move, and even then may end up having to face and resolve unforeseen transportation issues while completing the transportation assignments.

Conventional transportation systems do not have a way of dynamically enabling a driver to perform various duties while driving a load for a transportation assignment. An administrator using the conventional systems may neither be able to monitor status of a driver on the road, nor alert the driver who may be driving an equipment that is in an unsound mechanical condition Likewise, the administrators may not be able to alert a driver who is unknowingly breaking the law of a state the equipment is situated in.

A driver may typically need access to information such as a location of the nearby weight station, a packing material retailer location, a truck stop location information, a truck repair shop location information and the like. While most of this electronic information is available on the Internet all across the globe, while driving, the driver may not have access to this electronic information. For example, if the driver senses a vehicle battery issue, more specifically, if the driver learns that the battery is weak and that the equipment will not restart if turned off. In this situation, the driver may have to pull over, stop the vehicle, keep the vehicle turned on and then pull up his mobile device, search for cellular network provider's signal and then conduct a search for a nearby repair facility.

Therefore, there is a need in the art for methods and systems for the driver may quickly identify the nearby repair facility and drive straight to the identified repair facility to get the repairs done without having to search for cell phone signal or having to pull over to search a nearby repair facility. Further, it is desirable for the administrators to electronically monitor a driver's crisis situation from a remote location or take an action to reduce the driver's burden and offer the driver much needed help. Similarly, it is desirable for the compliance officials to have a way of electronically monitoring a driver's activities from a remote location. It would be advantageous if such a method and system availed a single portal to electronically monitor driver's activities and manage special situations that are frequently encountered in the transportation world such as bad weather and malfunctioning equipment.

### BRIEF SUMMARY

By way of introduction only, the present embodiments provide the methods and systems for dynamically orchestrating a set of driver functions during transportation of a load from a source location to a destination location. More particularly, the invention relates to the use of a single portal for drivers configured to manage several stages of transportation assignments right from initial stage of generating an estimate to the final stage of conducting the customer survey. The disclosed invention presents methods and systems for dynamically orchestrating a set of driver functions during transportation of a load from a source location to a destination location, the system configured to (1) authenticate credentials of a driver; (2) display a main interface to present a set of options to the driver; (3) display an inventory list interface enumerating the items to be moved and packed; (4) display a furniture list enumerating a set of items and an associated set of furniture attributes for each item in the set of items; (5) display an estimate interface to indicate a set of load attributes as received by the estimator at time of booking; (6) present a set of valuation coverage options to the client to protect the contents of the move; (7) display an inventory check in interface at the destination location for the client to inspect each item in the inventory for any possible damage; and (8) present a final bill of lading to the client upon arrival of the client's load at the destination location before displaying a payment screen interface for the driver to select a form of payment.

The system has the set of options presented to the driver via the main interface comprise (1) display a dashboard interface presenting a set of dashboard options to the driver; (2) display a driver's route interface presenting the driver all the incomplete loads; (3) display a log book interface presenting the driver information within a specific time frame, the information comprising: a number of miles driven by the driver, a number of hours of sleep, a number of states the driver went through; (4) display a useful links interface presenting the driver useful links to identify a location of the nearby weight station, a packing material retailer location, a truck stop location information, a truck repair shop location information; (5) display a my stats interface indicating the driver's statistical information comprising: the percentage of assignments where loads were picked up within the scheduled pickup dates, the percentage of assignments where loads were delivered within scheduled the delivery dates, and a claim percentage, the customer satisfaction results based on customer surveys; and (6) display a completed jobs interface showing all the jobs completed by the driver in the past.

The system is further configured to display a weight ticket interface whereby the driver may capture the photographs of the weight tickets at the source location and at the destination location, and optionally conduct a rerate procedure if the weight ticket at the destination location is heavier than the weight ticket at the source location, wherein the rerate procedure may be based on the weight tickets, added items, and services performed. Further, the system may be configured to perform a set of post contract services rendered at time of delivery, but not foreseen at the time of the pickup. The system may be configured to compare the photographs of the damaged items captured at the source location with the photographs of the damaged items captured at the destination location to identify the nature of the damage via a set of condition codes. The set of driver functions system may comprise: (1) view a dashboard displaying a list of loads assigned to the driver, a log book, weather information in the driver's location area, and the driver's statistical information; (2) view a list of incomplete loads before selecting a job for viewing the load specific information; (3) view a job acceptance form to ascertain a set of job attributes comprising: a job number, a job source location, a job destination location, a packing instruction, a storage instruction, an inventory information, and a special handling instruction; (4) accept a selected job via the job acceptance form before getting directions to the selected job destination location and commencing paper work for the selected job; (5) create an inventory indicating a list of items to be moved from the source location to the destination location by capturing a photograph of the actual item and describing a condition of the item, and assigning an item number, a lot number and a color code to each item; (6) create an original cost estimation and revise the original cost estimation after reviewing at least one of: a move estimation as computed at time of booking, a furniture list, an additional charge, an additional service required during the pickup, an additional service required during the delivery, and the packing instruction; and (7) accept a payment upon transmitting the inventory from the source location to the destination location.

The system may further be configured to (1) display a summary of items received and a summary of missing items and optionally displaying a claim submission interface for missing items (2) present a survey interface to the client to take at least one of an account manager survey, and a pickup and delivery crew survey (3) display a job acceptance form interface allowing the driver to view load details and begin the move paper work in response to the driver selecting a job acceptance form option (4) to configure the set of incomplete loads such that the set of incomplete loads comprise a set of pending rerate loads, and a set of pending delivery loads (5) to perform a pre-trip and a post-trip inspection to indicate a condition of the driver's equipment, log the distance driven by the driver, the locations visited by the driver, and time driven by the driver, and log a status of the driver at all times to indicate a condition of the driver (6) to display on the job acceptance form a pickup address, a delivery address, a client contact number, an estimated weight of the load, a pickup date, a delivery date, the miles between source and destination locations, and an estimated cash on demand (7) assign a status to the driver, the status comprise: (a) a driving status to the driver to indicate that the driver is driving (b) assign an off duty status to the driver to indicate that the driver is not performing driving related duties (c) assign a sleeper status to the driver to indicate that the driver was resting; and (d) assign an on duty status to the driver to indicate that the driver is not driving but performing work related duties.

Similarly, the system may further be configured to (1) display the starting odometer reading, the ending odometer reading and making available the driver's log book to a compliance official (2) to configure the set of load attributes which may comprise a shipper name, a load number, a source location city, a source location state, a source location zip, a destination city location, a destination state location, a destination location zip, and an estimate summary, wherein the estimation summary comprises a transportation cost, a bulky furniture transportation charge, an accessory charge, a packing charge, an unpacking charge, a storage charges, and a binding estimate charge (3) to present an add furniture interface to add furniture to the furniture list (4) configure the set of furniture attributes to comprise an item type, an item weight, and a volume of an item (5) display a revised packing charge for packing additional items requested by the client and generate a revised written estimate to reflect a change in the cost of the original estimate based on the revised packing charge, revised charge based on additional items and additional services (6) to note a condition of each item in the inventory list and optionally capturing a picture of each item in the inventory list.

Persons skilled in the art will recognize that the present invention may be used with numerous types of transmission systems. For instance, the method or system of the present invention can be deployed on an interactive resource optimization system or modified for use with a conventional telephone network, a cellular network, a wireless network, or a cable network.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF SEVERAL VIEWS OF THE DRAWINGS

FIG. 1 illustrates a driver login interface according to one embodiment of the system of the disclosed invention;

FIG. 2 shows a dashboard interface for the driver according to a preferred embodiment of the disclosed invention;

FIG. 3 depicts a useful links interface according to one embodiment of the system of the disclosed invention;

FIG. 4 depicts an exemplary interface displayed upon the driver selecting a driver's route option from the dashboard menu;

FIG. 5 depicts an advanced search interface according to one embodiment of the system of the disclosed invention;

FIG. 6 depicts a job acceptance form interface according to one embodiment of the system of the disclosed invention;

FIG. 7 depicts an estimate interface according to one embodiment of the system of the disclosed invention;

FIG. 8 depicts a signature interface according to one embodiment of the system of the disclosed invention;

FIG. 9 depicts a furniture list interface according to one embodiment of the system of the disclosed invention;

FIG. 10 illustrates a add furniture interface according to one embodiment of the system of the disclosed invention;

FIG. 11 depicts a furniture addition approval interface according to one embodiment of the system of the disclosed invention;

FIG. 12 depicts a client approval for added items interface according to one embodiment of the system of the disclosed invention;

FIG. 13 depicts a driver approval for added items interface according to one embodiment of the disclosed invention;

FIG. 14 displays an accessorial/bulky charges interface according to one embodiment of the disclosed invention;

FIG. 15 displays an accessorial/bulky charges summary interface according to one embodiment of the disclosed invention;

FIG. 16 displays a client accessorial/bulky charge approval interface according to one embodiment of the disclosed invention;

FIG. 17 displays a driver accessorial/bulky charge approval interface according to one embodiment of the disclosed invention;

FIGS. 18-22 display various packing costs for packing additional items requested by the client according to one embodiment of the disclosed invention;

FIGS. 23-27 display various aspects of revised written estimate functionality according to one embodiment of the disclosed invention;

FIG. 28 displays an exemplary valuation interface according to one embodiment of the disclosed invention;

FIGS. 29-32 display various interfaces showing valuation options according to one embodiment of the disclosed invention;

FIGS. 33-36 display various aspects of bill of lading according to one embodiment of the disclosed invention;

FIGS. 37-41 display various inventory interfaces according to one embodiment of the disclosed invention;

FIGS. 42-44 display a set of confirmation interfaces according to one embodiment of the disclosed invention;

FIGS. 45-46 display weight ticket interface of the system of the disclosed invention;

FIGS. 47-49 show various post contract services interfaces according to one embodiment of the disclosed invention;

FIGS. 50-52 indicate a final bill of lading interfaces according to one embodiment of the disclosed invention;

FIG. 53 displays a payment interface of the system according to one embodiment of the disclosed invention;

FIG. 54 depicts inventory check in interface according to a preferred embodiment of system of the disclosed invention;

FIG. 55 depicts damage identification code interface according to a preferred embodiment of system of the disclosed invention;

FIG. 56 depicts damage condition representation interface according to a preferred embodiment of system of the disclosed invention;

FIG. 57 illustrates an interface showing summary of items received and summary of missing items according to a preferred embodiment of system of the disclosed invention;

FIG. 58 depicts missing item claim interface according to a preferred embodiment of system of the disclosed invention;

FIG. 59 depicts a furniture condition recoding interface for taking pictures showing damages and filing a damage claim according to a preferred embodiment of system of the disclosed invention;

FIG. 60 depicts inventory interface to label damages based on predefined set of damage codes according to a preferred embodiment of system of the disclosed invention;

FIG. 61 depicts claim form interface according to a preferred embodiment of system of the disclosed invention;

FIG. 62 displays a client claim form approval interface according to one embodiment of the disclosed invention;

FIG. 63 displays a driver claim form approval interface according to one embodiment of the disclosed invention;

FIG. 64 displays a client claim waiver interface according to one embodiment of the disclosed invention;

FIG. 65 displays an estimator survey interface according to one embodiment of the disclosed invention;

FIG. 66 displays an account manager survey interface according to one embodiment of the disclosed invention;

FIG. 67 displays a pickup & delivery survey interface according to one embodiment of the disclosed invention;

FIG. 68 displays a driver's log book interface according to a preferred embodiment of the disclosed invention;

FIG. 69 displays a pre and post inspection interface according to a preferred embodiment of the disclosed invention;

FIG. 70 displays an additional payment interface according to a preferred embodiment of the disclosed invention;

FIG. 71 displays a storage in transit interface according to a preferred embodiment of the disclosed invention;

FIG. 72 displays a thank you interface according to a preferred embodiment of the disclosed invention.

### DETAILED DESCRIPTION OF THE PRESENTLY PREFERRED EMBODIMENTS

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. The present invention provides systems, methods and apparatus for efficiently creating an accurate inventory of items being shipped or transported from one location to another. Items to be transported and included as part of the inventory may be quickly captured and identified in still images and/or video images and/or audio file. In one embodiment, the invention comprises a software application for a smart phone, tablet, or other device having a camera and/or video camera and/or microphone. A driver may start by providing basic information such as driver's name, address, email and other contact information. Further, a driver may designate the particular moving project at hand.

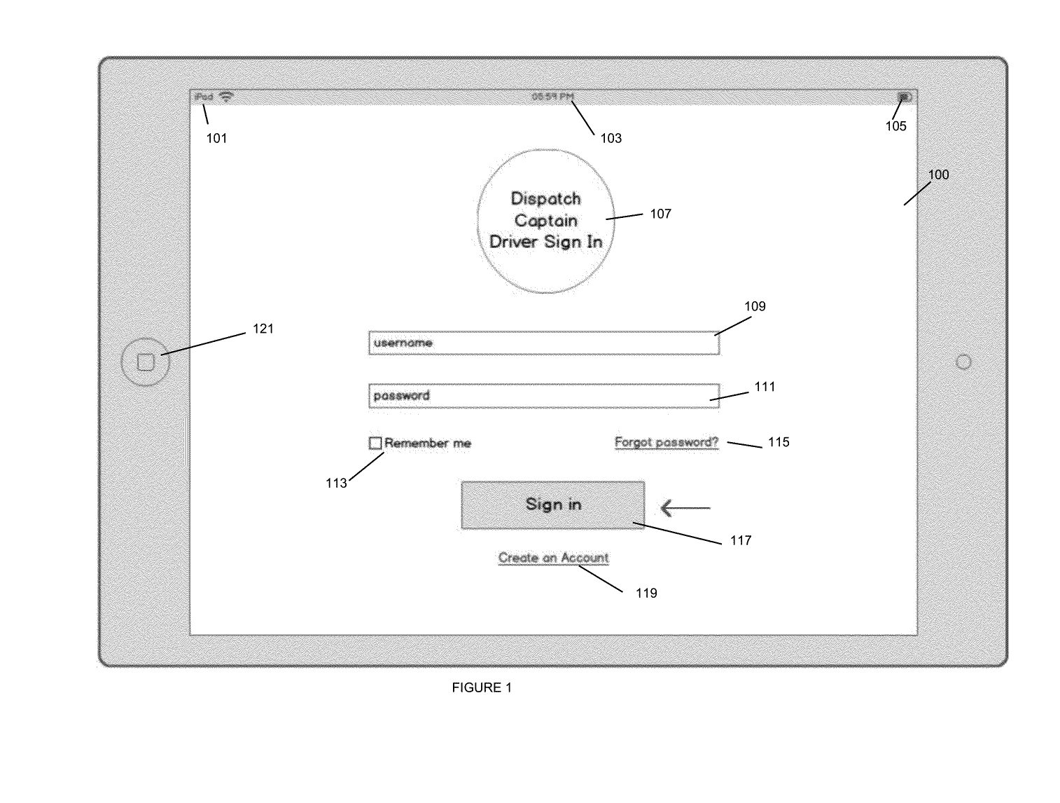

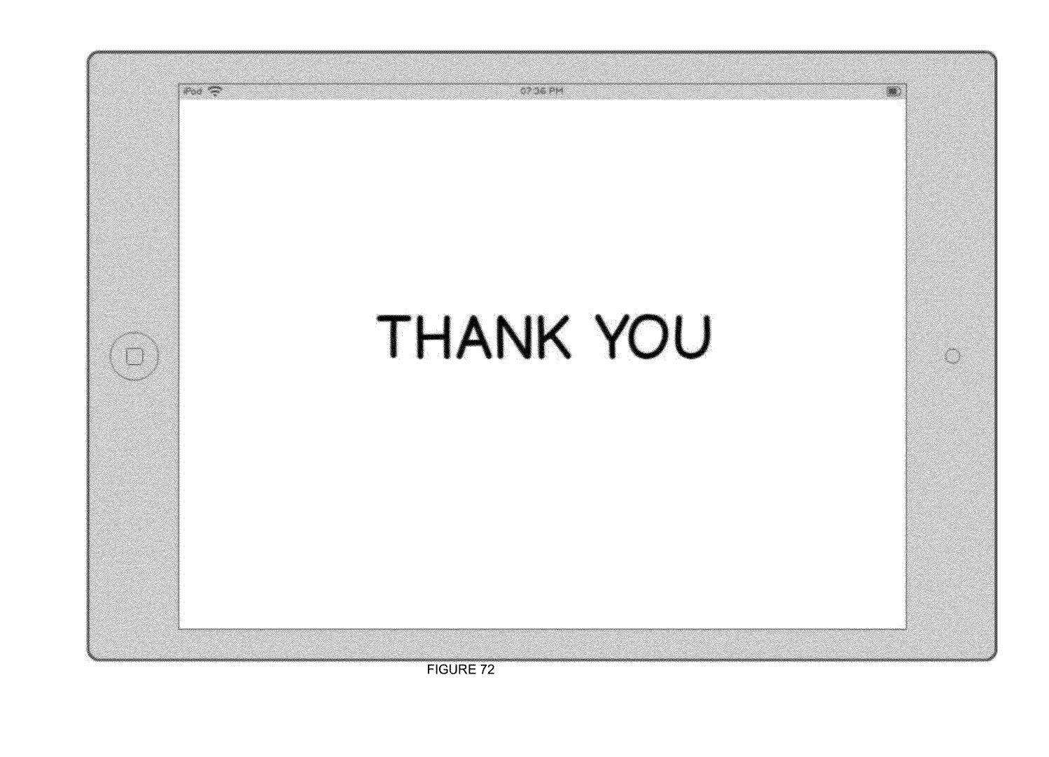

FIGS. 1-72 and descriptions of the FIGS. 1-72 together provide a list of functions and exemplary phone application screens coinciding with several aspects of the disclosed invention. Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated. Optionally, the information gathered by the disclosed invention may be stored on a cloud and other persons, such as a moving company employee, may be given access to the cloud. This may simplify the process and allow more data to be used without overloading various computer systems.

As such, those skilled in the art will appreciate that the conception, upon which this disclosure is based, may readily be utilized as a basis for designing other structures, methods and systems for carrying out the several purposes of the present invention. It is important, therefore, that the claims be regarded as including such equivalent constructions insofar as they do not depart from the spirit and scope of the present invention. A more complete understanding of the present invention, and the attendant advantages and features thereof, will be more readily understood by reference to the following detailed description when considered in conjunction with the accompanying drawings, wherein FIGS. 1-72, located after the step by step description, are representations of screens provided by a software application for use with a smart phone or tablet which guide an driver through the system and method.

By way of introduction only, the present embodiments provide methods and systems for dynamically orchestrating a set of driver functions during transportation of a load from a source location to a destination location, the method comprising: (1) authenticating credentials of a driver; (2) displaying a main interface presenting a set of options to the driver; (3) displaying an inventory list interface enumerating the items to be moved and packed; (4) displaying a furniture list enumerating a set of items and an associated set of furniture attributes for each item in the set of items; (5) displaying an estimate interface indicating a set of load attributes as received by the estimator at time of booking; (6) presenting a set of valuation coverage options to the client to protect the contents of the move; (8) displaying an inventory check in interface at the destination location for the client to inspect each item in the inventory for any possible damage; and (9) presenting a final bill of lading to the client upon arrival of the client's load at the destination location before displaying a payment screen interface for the driver to select a form of payment.

The method as described above, wherein the set of options presented to the driver via the main interface comprise: (1) displaying a dashboard interface presenting a set of dashboard options to the driver; displaying a driver's route interface presenting the driver all the incomplete loads; (2) displaying a log book interface presenting the driver information within a specific time frame, the information comprising: a number of miles driven by the driver, a number of hours of sleep, a number of states the driver went through (3) displaying a useful links interface presenting the driver useful links to identify a location of the nearby weight station, a packing material retailer location, a truck stop location information, a truck repair shop location information (4) displaying a my stats interface indicating the driver's statistical information comprising: the percentage of assignments where loads were picked up within the scheduled pickup dates, the percentage of assignments where loads were delivered within scheduled the delivery dates, customer survey results, and a claim percentage; and (5) displaying a completed jobs interface showing all the jobs completed by the driver in the past.

The method may further comprise the steps of (1) displaying a weight ticket interface whereby the driver may capture the photographs of the weight tickets at the source location and at the destination location, and optionally conduct a rerate procedure if the weight ticket at the destination location is heavier than the weight ticket at the source location, wherein the weight tickets are sent to company prior to the arrival of the inventory at the destination location (2) performing a set of post contract services rendered at time of delivery, but not foreseen at the time of the pickup (3) comparing the photographs of the damaged items captured at the source location with the photographs of the damaged items captured at the destination location to identify the nature of the damage via a set of condition codes.

The set of driver functions may comprise: (1) viewing a dashboard displaying a list of loads assigned to the driver, a log book, weather information in the driver's location area, and the driver's statistical information; (2) viewing a list of incomplete loads before selecting a job for viewing the load specific information; (3) viewing a job acceptance form to ascertain a set of job attributes comprising: a job number, a job source location, a job destination location, a packing instruction, a storage instruction, an inventory information, and a special handling instruction; (4) accepting a selected job via the job acceptance form before getting directions to the selected job destination location and commencing paper work for the selected job; (5) creating an inventory indicating a list of items to be moved from the source location to the destination location by capturing a photograph of the actual item and describing a condition of the item, and assigning an item number, a lot number and a color code to each item; (6) creating an original cost estimation and revising the original cost estimation after reviewing at least one of: a move estimation as computed at time of booking, a furniture list, an additional charge, an additional service required during the pickup, an additional service required during the delivery, and the packing instruction; and (7) accepting a payment upon transmitting the inventory from the source location to the destination location.

The method may further comprise the step of (1) displaying a summary of items received and a summary of missing items and optionally displaying a claim submission interface for missing items (2) presenting a survey interface to the client to take at least one of an account manager survey, and a pickup and delivery crew survey (3) displaying a job acceptance form interface allowing the driver to view load details and begin the move paper work in response to the driver selecting a job acceptance form option.

The set of incomplete loads of method may comprise a set of pending rerate loads, and a set of pending delivery loads. Further, the set of driver functions of the claimed method may comprise performing a pre-trip and a post-trip inspection to indicate a condition of the driver's equipment, logging the distance driven by the driver, the locations visited by the driver, and time driven by the driver, and logging a status of the driver at all times to indicate a condition of the driver.

The method may further comprise the step of displaying on the job acceptance form a pickup address, a delivery address, a client contact number, an estimated weight of the load, a pickup date, a delivery date, the miles between source and destination locations, and an estimated cash on demand. Additionally, the method may comprise the step of maintaining the log book further comprises the steps of: (1) assigning a driving status to the driver indicating that the driver is driving; (2) assigning an off duty status to the driver indicating that the driver is not performing driving related duties; (3) assigning a sleeper status to the driver indicating that the driver was resting; and (4) assigning an on duty status to the driver indicating that the driver is not driving but performing work related duties.

The method may further comprise the step of displaying the starting odometer reading, the ending odometer reading and making available the driver's log book to a compliance official. The set of load attributes of the claimed method may comprise a shipper name, a load number, a source location city, a source location state, a source location zip, a destination city location, a destination state location, a destination location zip, and an estimate summary, wherein the estimation summary comprises a transportation cost, a bulky furniture transportation charge, an accessory charge, a packing charge, an unpacking charge, a storage charges, and a binding estimate charge. The method may further comprise the step of presenting an add furniture interface to add furniture to the furniture list, wherein the set of furniture attributes may comprise an item type, an item weight, an item quantity, and a volume of an item.

The disclosed method may further comprising the steps of: (1) displaying a revised packing charge for packing additional items requested by the client; (2) generating a revised written estimate to reflect a change in the cost of the original estimate based on the revised packing charge, added items, and additional services; and (3) noting a condition of each item in the inventory list and optionally capturing a photograph or a video recording of each item in the inventory list.

FIG. 1 depicts login interface 100 according to one embodiment of the system of the disclosed invention. The interface 100 may be configured for drivers to log into their respective accounts prior to accessing the system. FIGS. 1-72 illustrate various interfaces that may be displayed for drivers or driver's accounts. Likewise the interface 100 may also be configured to create a new instance of driver account for the first time drivers of the system. Note that the interfaces described in this application in FIGS. 1-72 are exemplary interfaces.

As such, many other components may be added or taken out of the interfaces to accomplish the desired effect. Accordingly, any name other than the one displayed on the interface may be replaced for the names shown on the interfaces depicted in FIGS. 1-72. The interface 100 may be displayed on a computing device 101 of a driver upon the driver launching a Dispatch Captain application, a logo 107 indicating name “Dispatch Captain Driver sign in” may be displayed on the interface 100. Several attributes associated with the computing device 101 such as time indicator 103, and battery indicator 105 may also be displayed on the interface 100.

If a driver using the computing device 101, is a registered driver of the disclosed system, then the driver may provide the driver name in an input field 109, and password in an input field 111 prior to selecting a sign in option 117. If the driver desires to have the computing device 101 save the driver's name and password information, the driver may select a “remember me” option 113. Likewise, if the driver is unable to recall the password then the driver may select a forget password option 115, whereby the system may send a password reset link for the driver at a predefined email address or provide password reset instructions via any other means of communication.

However, if the driver is not a registered driver of the disclosed system, the driver may register with the disclosed system by selecting a create an account option 119. Upon selecting this option, the driver may be presented a registration interface not shown in FIG. 1. The driver may return to the main menu interface of the computing device 101 by selecting a return to main menu option 121 of the computing device 101.

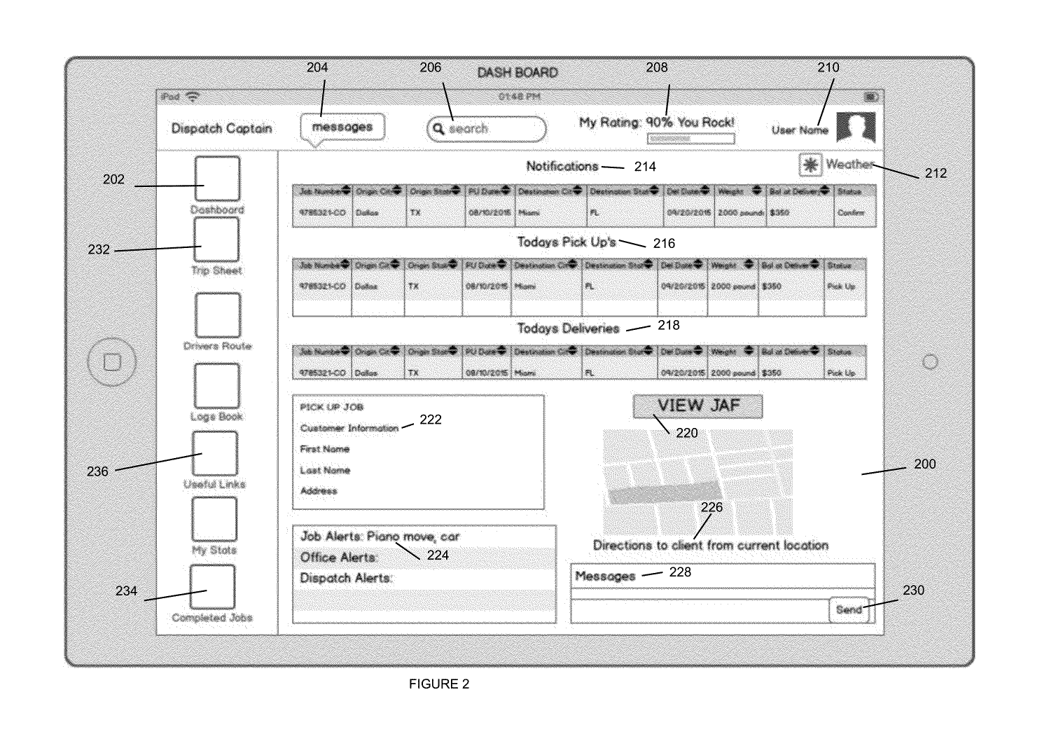

Now turning to FIG. 2 showing dashboard interface 200 for the driver according to a preferred embodiment of the disclosed invention. The interface 200 may be displayed when the driver selects the dashboard option 202. Several additional options may be displayed on the interface 200 for a given driver, for example by selecting a messages option 204 the driver may view all the messages that are sent to either to the driver or to the driver's fleet. The driver may search information regarding the pending jobs by conducting a search via search option 206. Likewise the interface 200 may also display the driver's rating information 208 and the driver's name and photograph 210.

The interface 200 may indicate the driver notifications 214 that require confirmation such as when new loads are assigned to the driver or any change made in the driver's current load assignment i.e. loads that are currently assigned to driver. Further, interface 200 may also display today's pickup and deliveries display areas 216 and 218 respectively, which may show nature of the scheduled jobs i.e. pickup or delivery that are to be completed on the given day and in the priority assigned to the job which may indicate order in which the assigned jobs are to be completed.

In other words, the notification area 214 may indicate any change in job status of the jobs that are assigned to the given driver such as job cancelled, new job assigned, and the like. Display area 216 may indicate information regarding jobs that are assigned to the given driver that are scheduled to be picked up today. Similarly, display area 218 may indicate information regarding jobs that are assigned to the given driver that are scheduled to be delivered today.

Notably, by selecting any of the jobs displayed in the display areas 214, 216 or 218, the driver may be able to view the details regarding the jobs. A JAF Interface not shown in FIG. 2 may be displayed upon the driver selecting a view job acceptance form (JAF) option 220. Information regarding pick up job may be displayed in the display area 222 and job alerts that are configured by the driver may be displayed at the area 224. The directions from the driver's current location to the client location may be displayed at the area 226. The driver may be able to type a message for another administrator of the disclosed system in the input area 228 and dispatch the message by selecting the send option 230. Weather at the source location or destination location may be displayed on the interface 200.

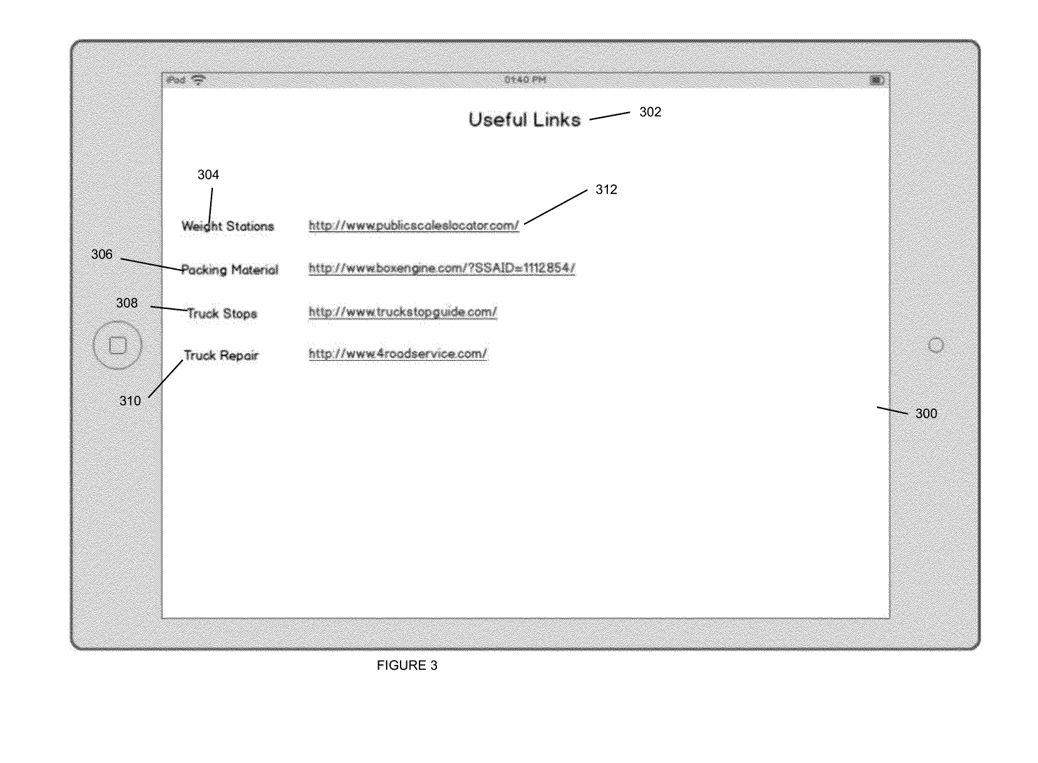

Upon the driver selecting trip sheet or driver's route option 232, the system may display the driver's current assignments and their associated time span reflecting when the assignments needs to be completed. Similarly, upon the driver selecting completed jobs option 234, the system may display the jobs that the driver has completed in the past. The useful Links option 236 may show the driver links to apps and or websites to assist with the day to day operations, this option is described further in conjunction with FIG. 3.

Now referring to FIG. 3 interface 300 may contain useful links such as location of the nearby weight station 304, packing material retailer location 306, truck stop location information 308, truck repair shop location information 310, and the like. Additionally other useful information links such as location information for fuel station, hotels etc. may also be displayed on the interface 300. The driver may be able to view information on the interface 300 by selecting associated links, for example, the driver may be able to view the location information for nearby weight stations by selecting the associated link 312.

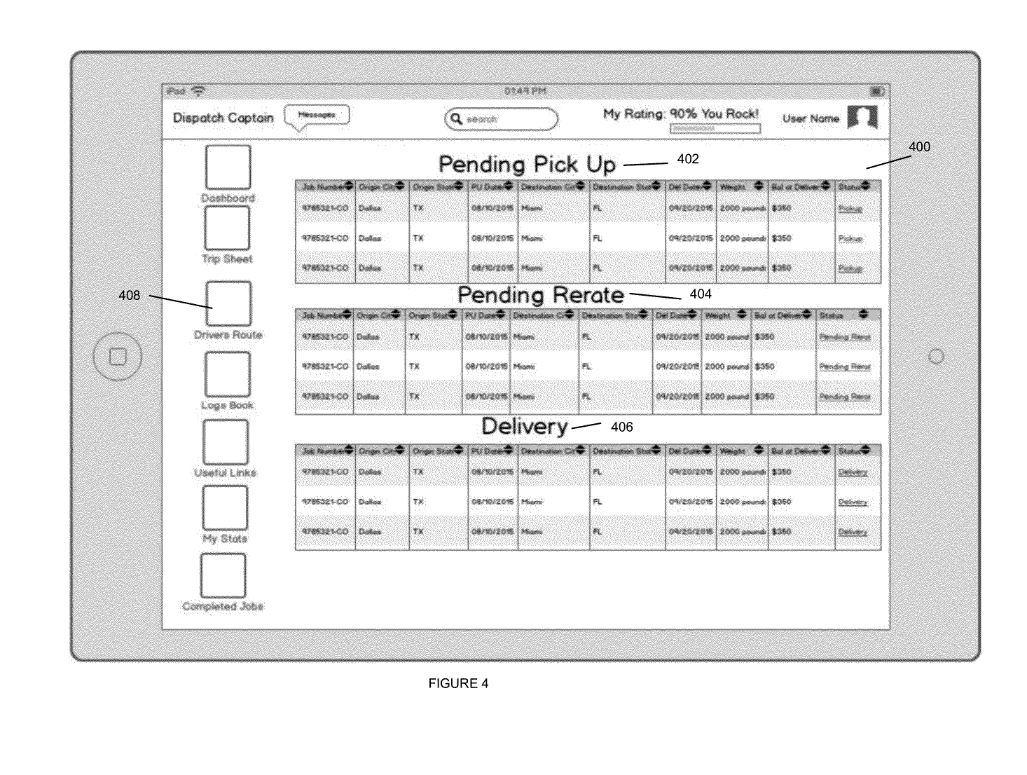

Now turning to FIG. 4 displaying interface 400 displayed upon the driver selecting a driver's route option 408 from the dashboard main menu. The interface 400 may show the driver all loads that have not been completed. The incomplete loads may be classified into or sorted by a set of pending pickup loads 402, a set of pending rerate loads 404 and a set of pending delivery loads 406. Driver can select a load from the three above mentioned incomplete load categories to view specific information associated with the selected load.

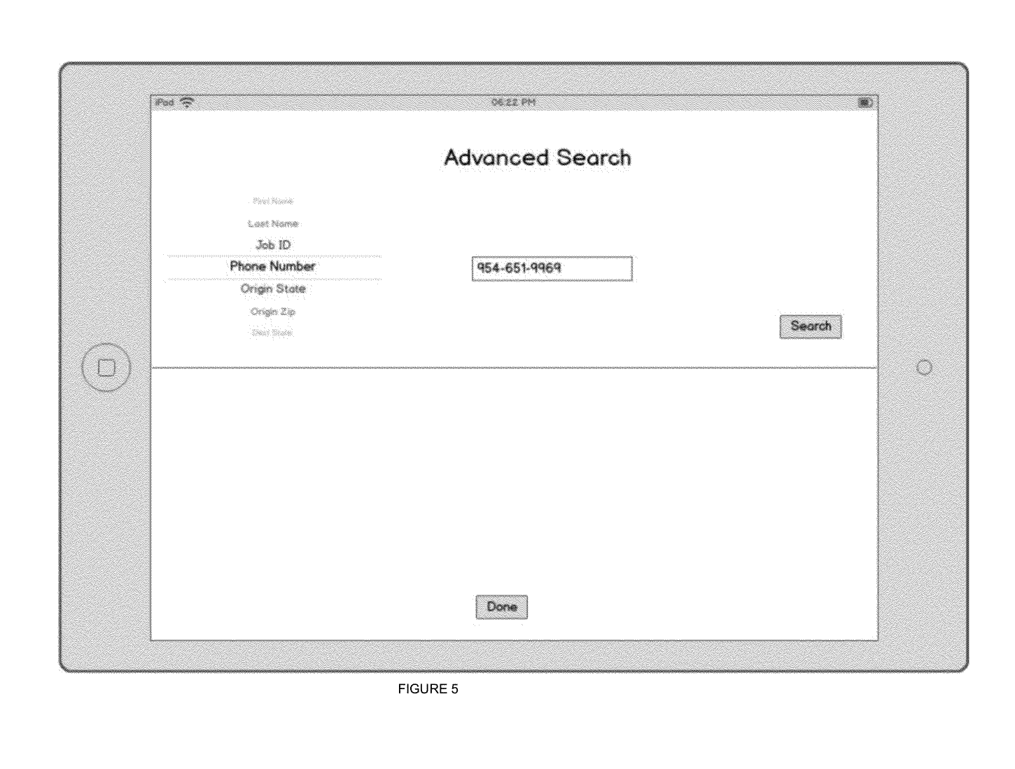

FIG. 5 indicates an advanced search interface displayed upon the driver selecting an advanced search option located near the search option, not shown in FIG. 4. The search interface may search all loads based on a predefined criteria specified by the driver. The driver may via this functionality to search for loads based on the search criteria including but not limited to a phone number, an address, a zip code, a job number, a state, and the like.

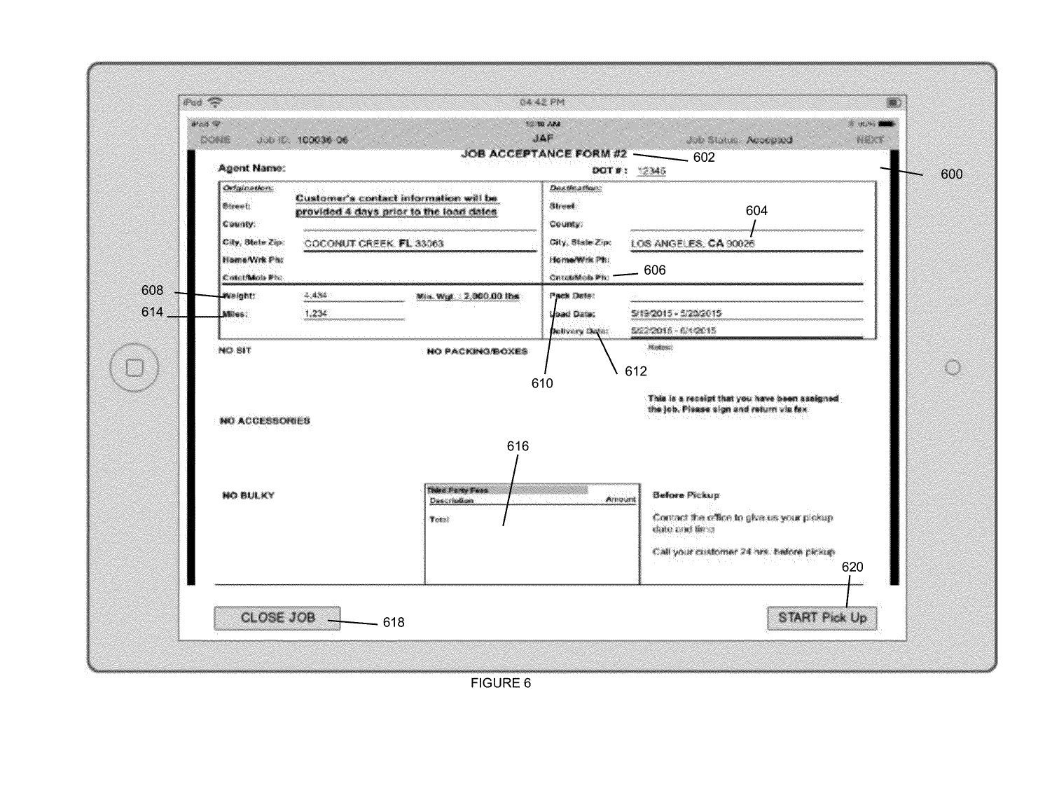

A Job Acceptance Form (JAF) interface 600 is displayed in FIG. 6. The interface 600 may allow the driver to view load details and begin the move paper work by selecting a start pick up option 620 once the driver arrives at the source location or pickup location. Key information displayed on the JAF interface 600 may include but is not limited to pickup and delivery address, for example the delivery city state and zip as shown by the reference numeral 604, contact numbers 606, estimated weight of the load 608, pickup date 610, delivery date 612, miles between pickup and delivery locations 614, estimated cash on demand (COD) 616 and the like. The driver may prior to pick up select option start pick up 620 to begin loading the pickup load in the driver's vehicle. Likewise, upon down loading the load from the driver's vehicle at the destination location, the driver may select close job option 618.

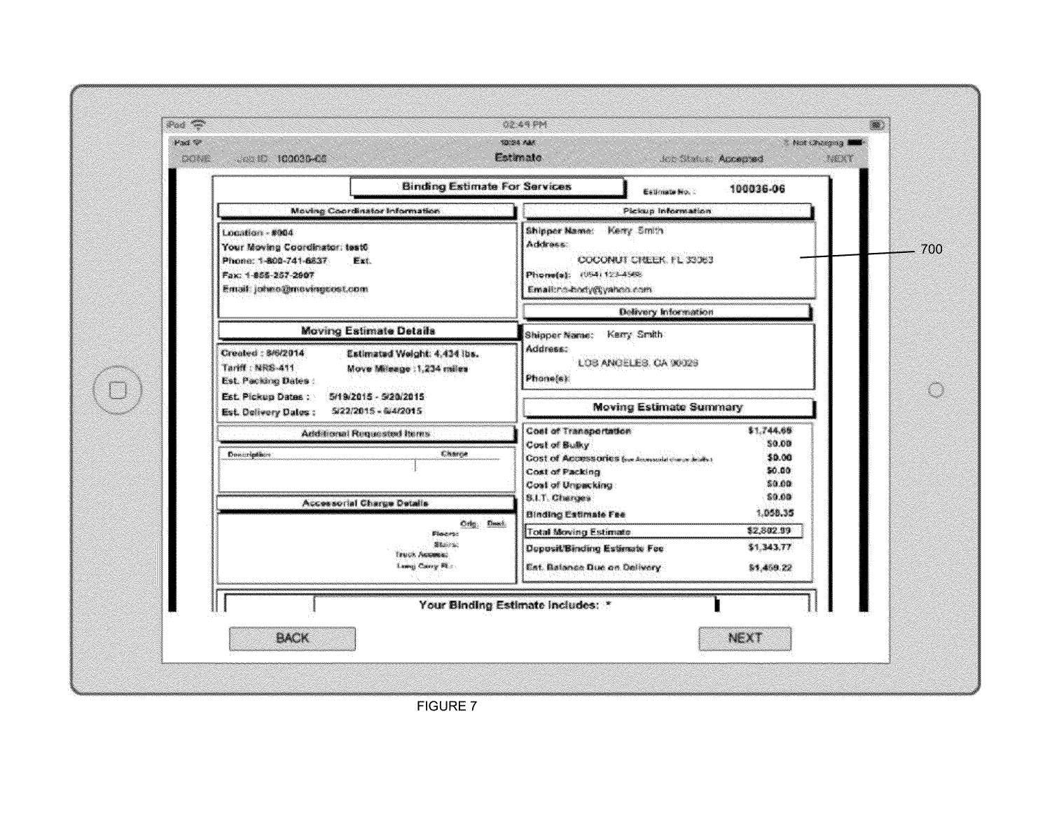

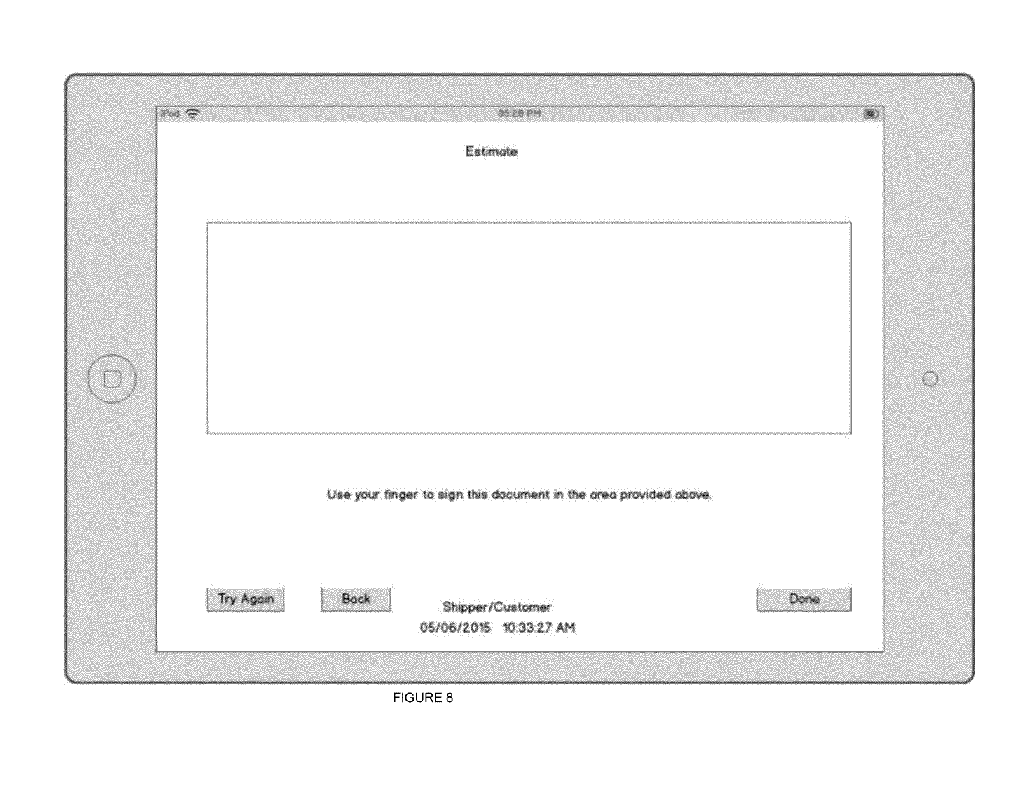

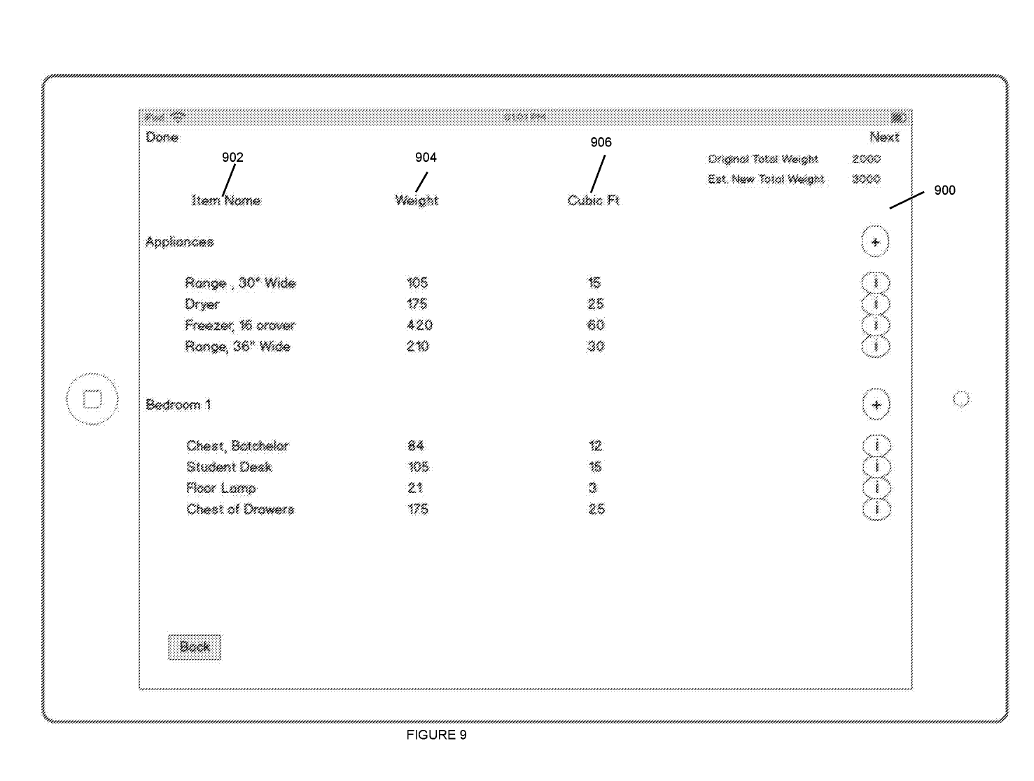

An estimate interface 700 is shown in FIG. 7. The interface 700 may indicate details of the move as received by the estimator at time of booking. The estimate may be reviewed and signed by client upon arrival of the driver at the origin location. The estimate interface may show the move attributes including but not limited to shipper name, address and contact information, pickup and delivery dates, and estimate summary comprising transportation cost, bulky charges, accessory charges, packing charges, unpacking charges, storage charges (SIT), binding estimate charge and the like. The shipper/customer may sign off the generated estimation via signature interface shown in FIG. 8. Now turning to FIG. 9 showing furniture list interface 900 showing item type 902, item weight 904 and volume of the item 906 in cubic feet. Notably, the driver can update furniture items and box weight as items are added or removed from the load. Each item that is added to the list may be displayed in certain color for example, in red color. Resultantly, original weight and estimated new weight may be displayed on the interface 900.

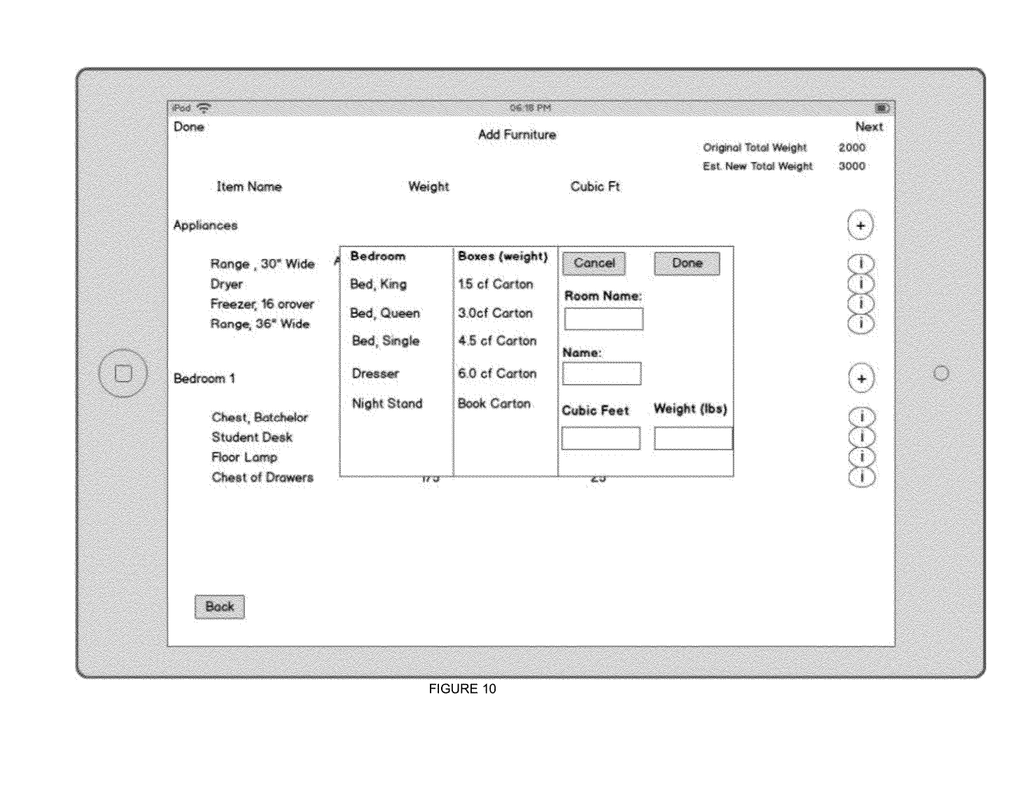

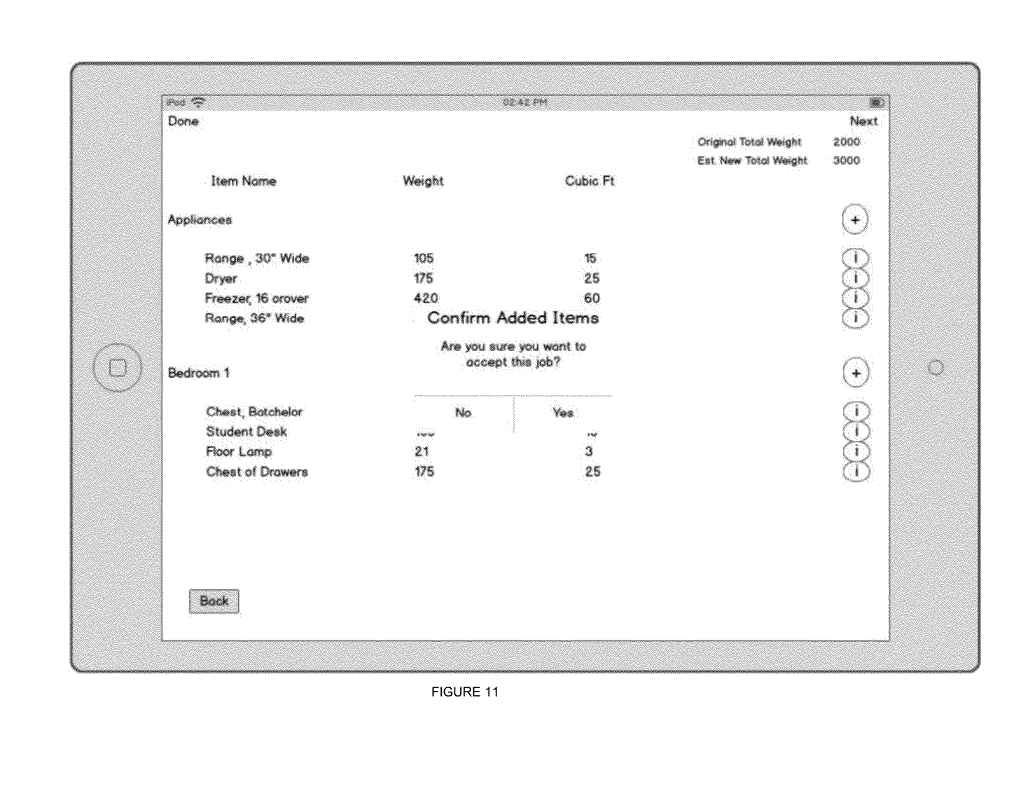

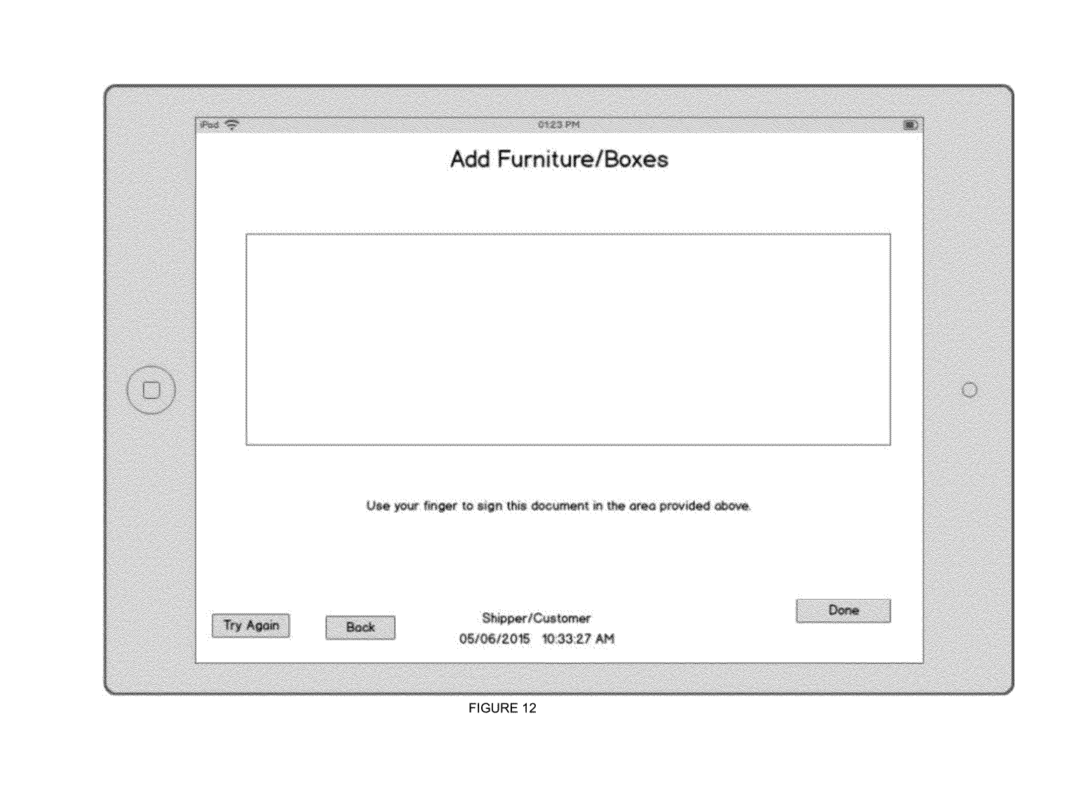

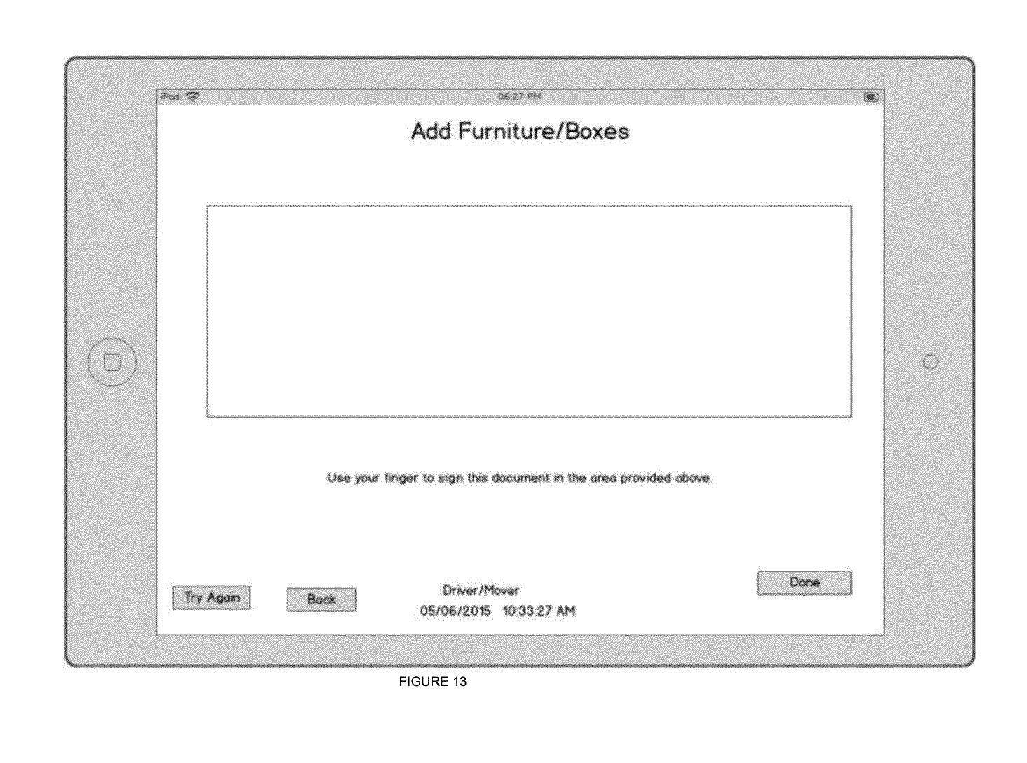

The driver may use add furniture interface 1000 shown in FIG. 10 to add furniture. Once the items in the list are updated by the driver, the client may be asked to approve the addition by confirming the addition as shown in FIG. 11. Then the client may sign a document indicating that the client is approving the changes as shown in FIG. 12 and the driver may counter sign as shown in FIG. 13.

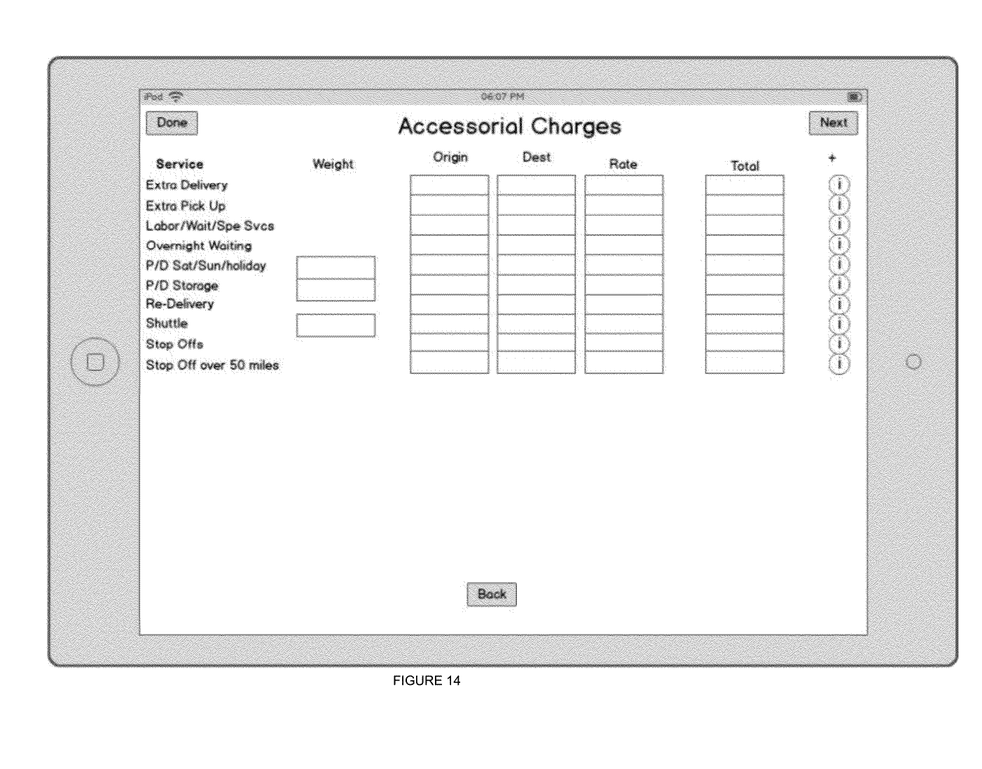

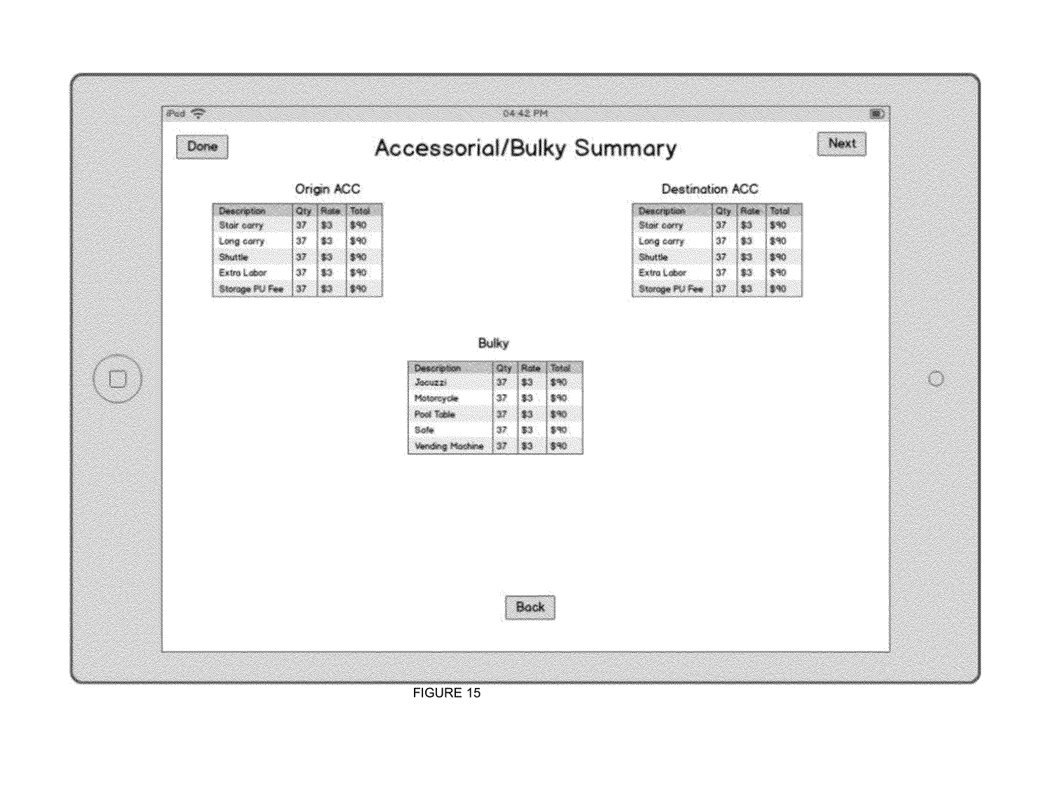

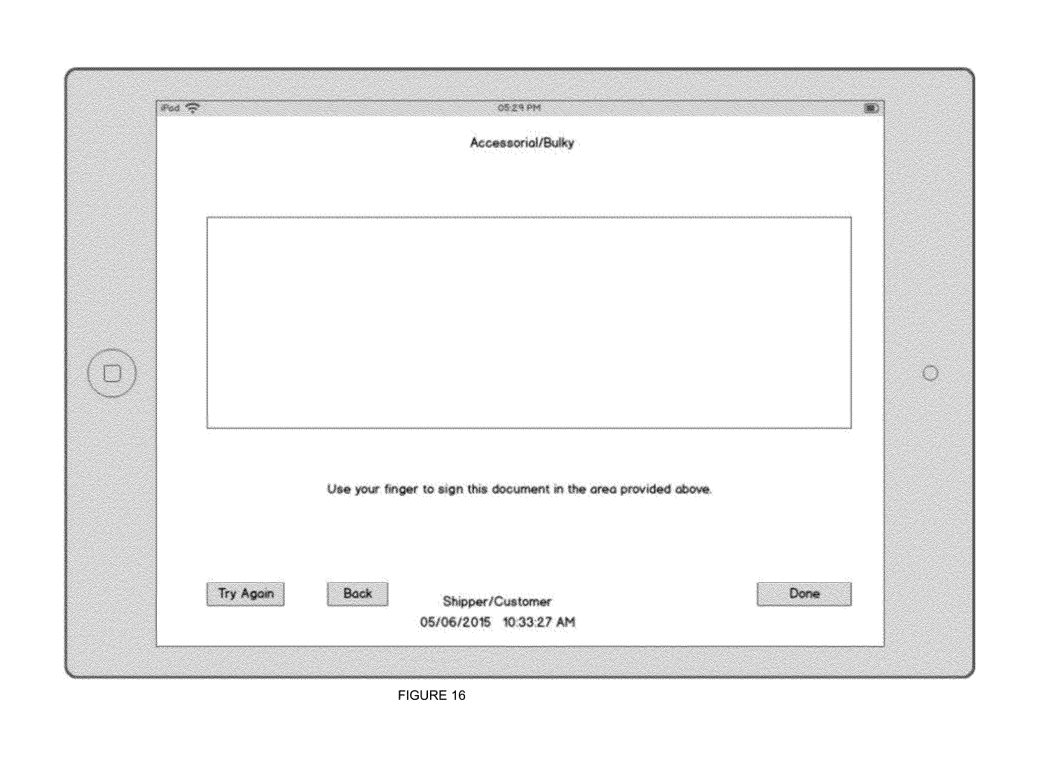

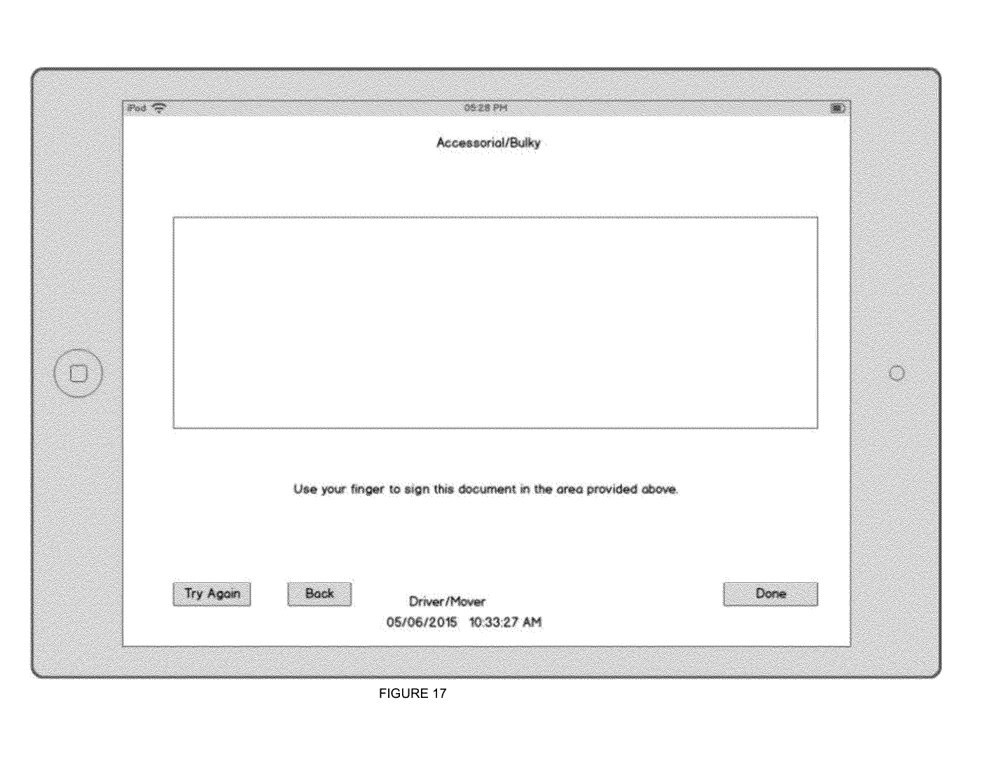

The accessorial/bulky charges interface is shown in FIG. 14. This interface may show additional charges associated with moving certain items and also additional services that may be required during the pick up or delivery of the added item. A driver may add these charges at the time of pick up if the charges have not already been added at the time of booking. A summary page as shown in FIG. 15 may show all the accessorial and bulky charges associated to the move. Notably, this interface may display the accessorial and bulky charges incurred at source location and the destination location. The client may agree to the addition of accessorial/bulky items via interface shown in FIG. 16 before the driver signs agreeing to addition of the accessorial/bulky items via interface shown in FIG. 17.

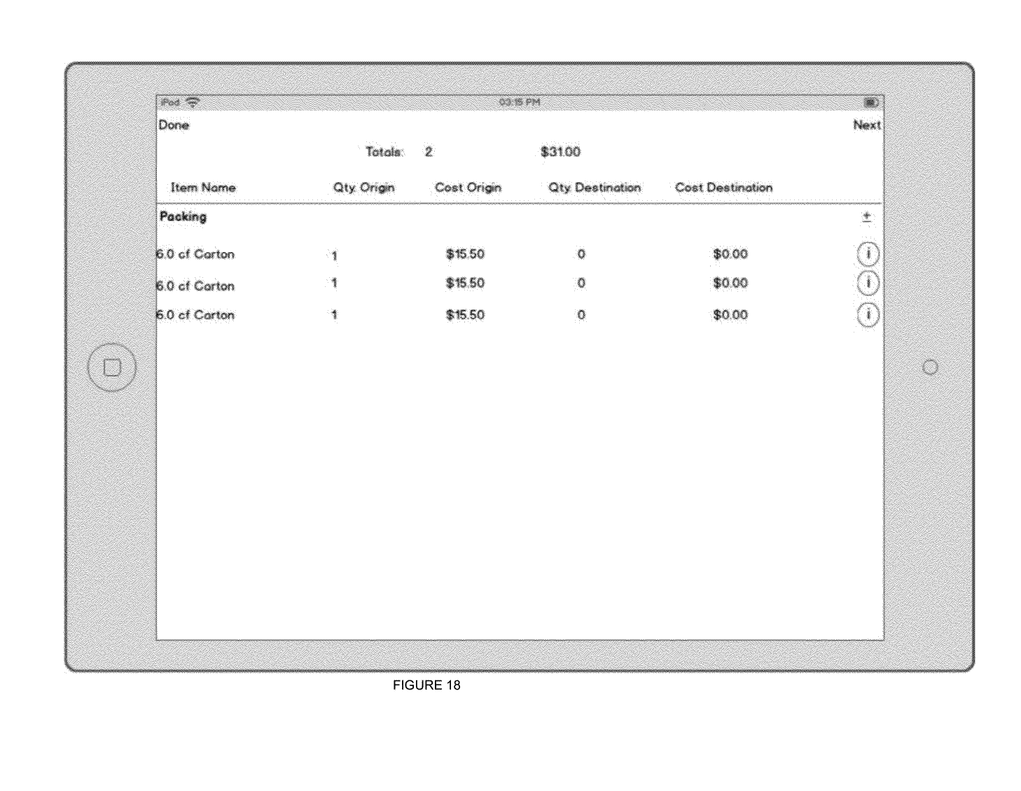

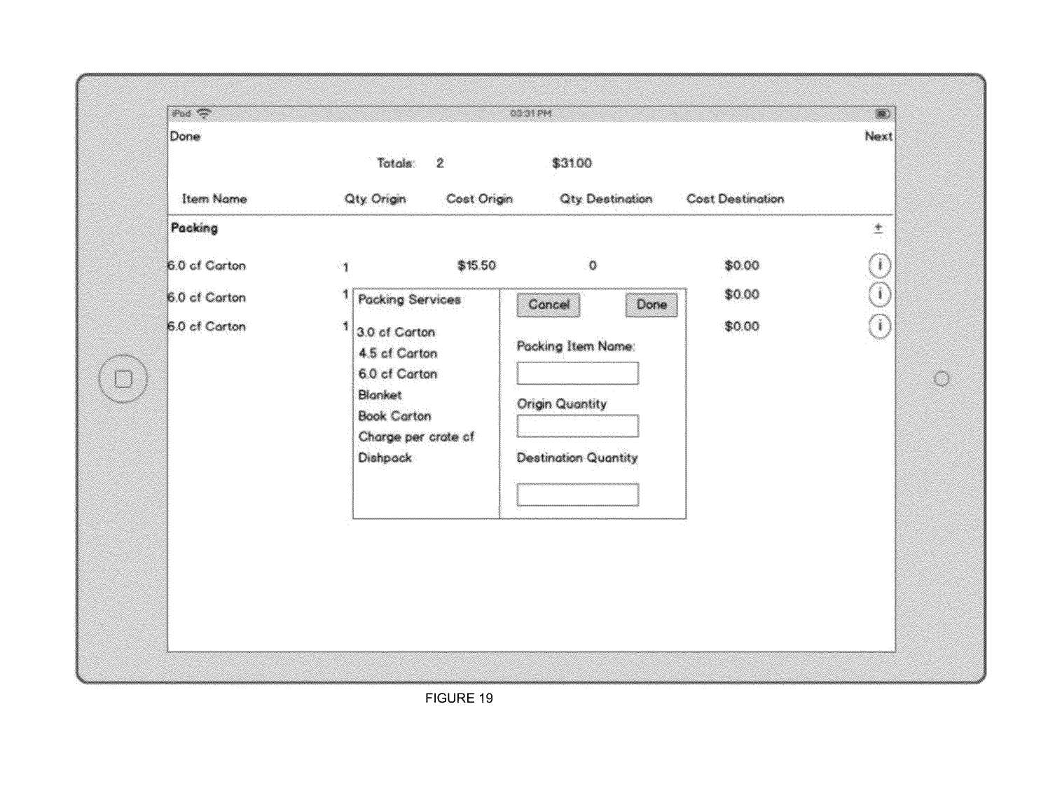

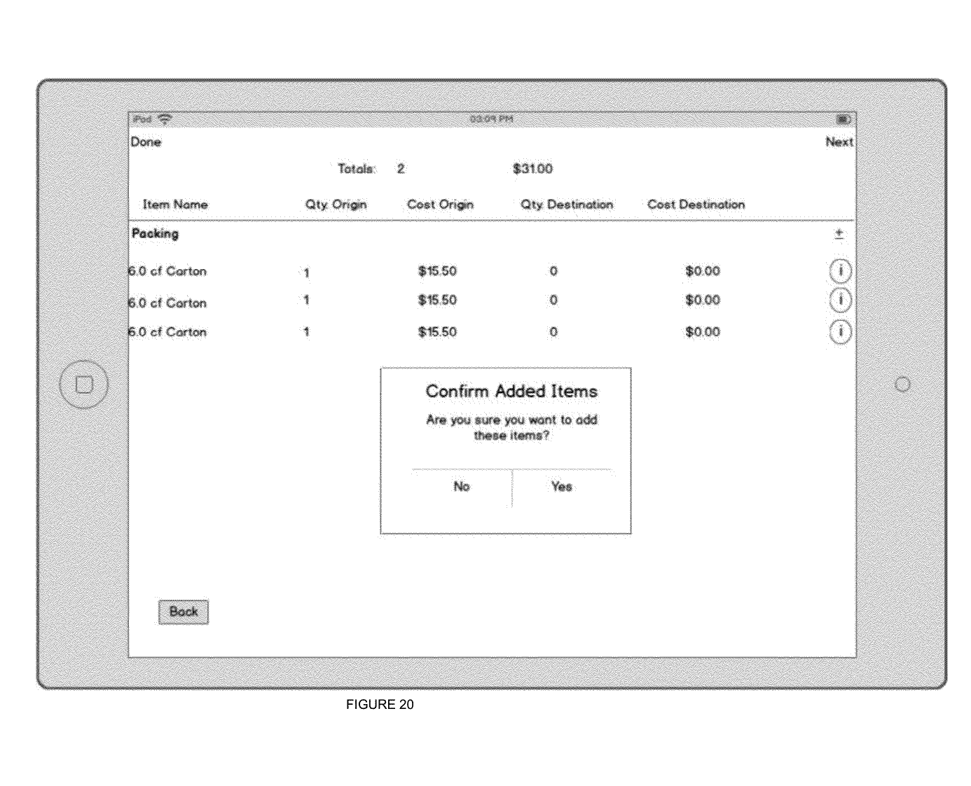

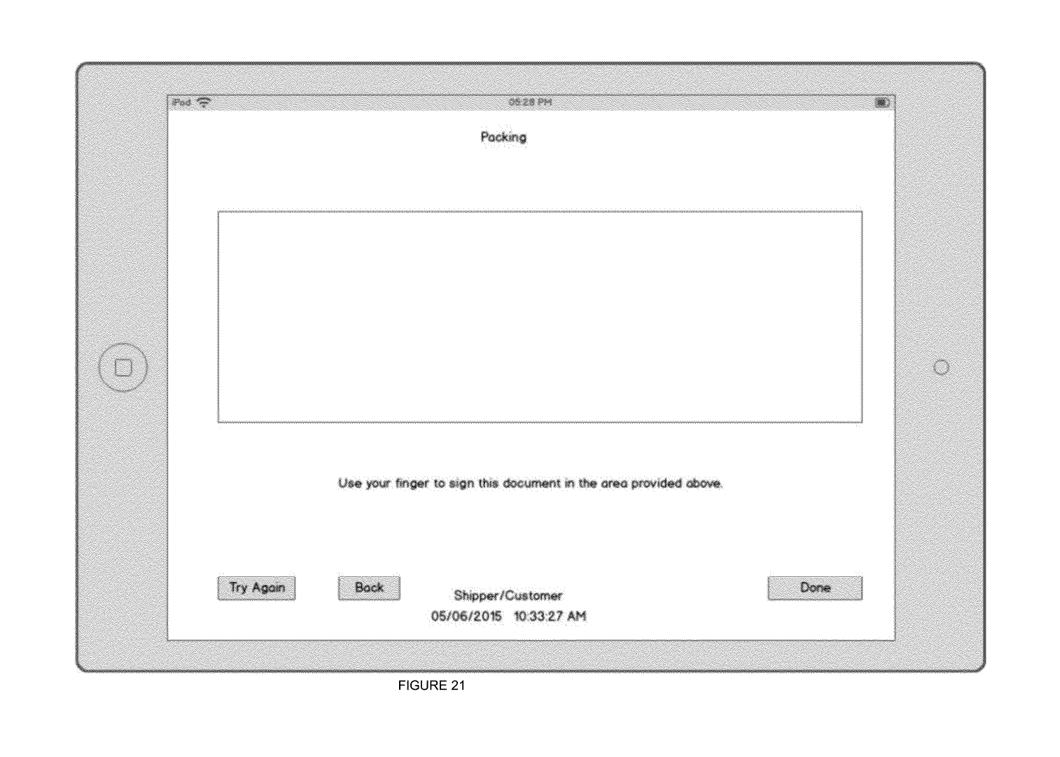

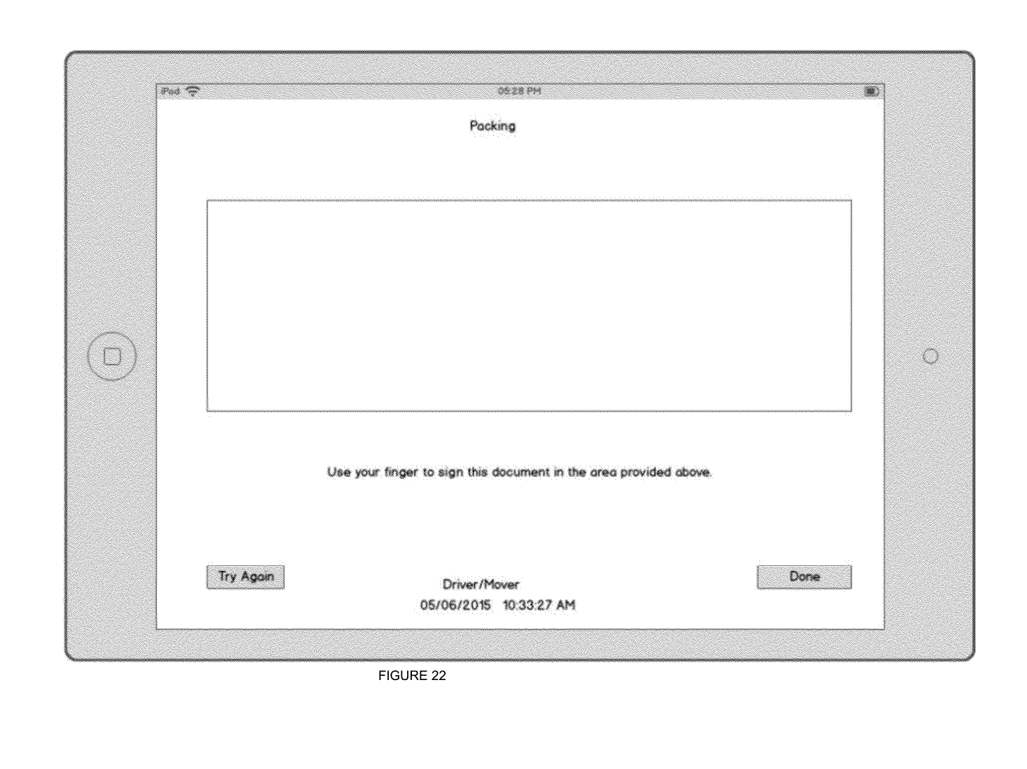

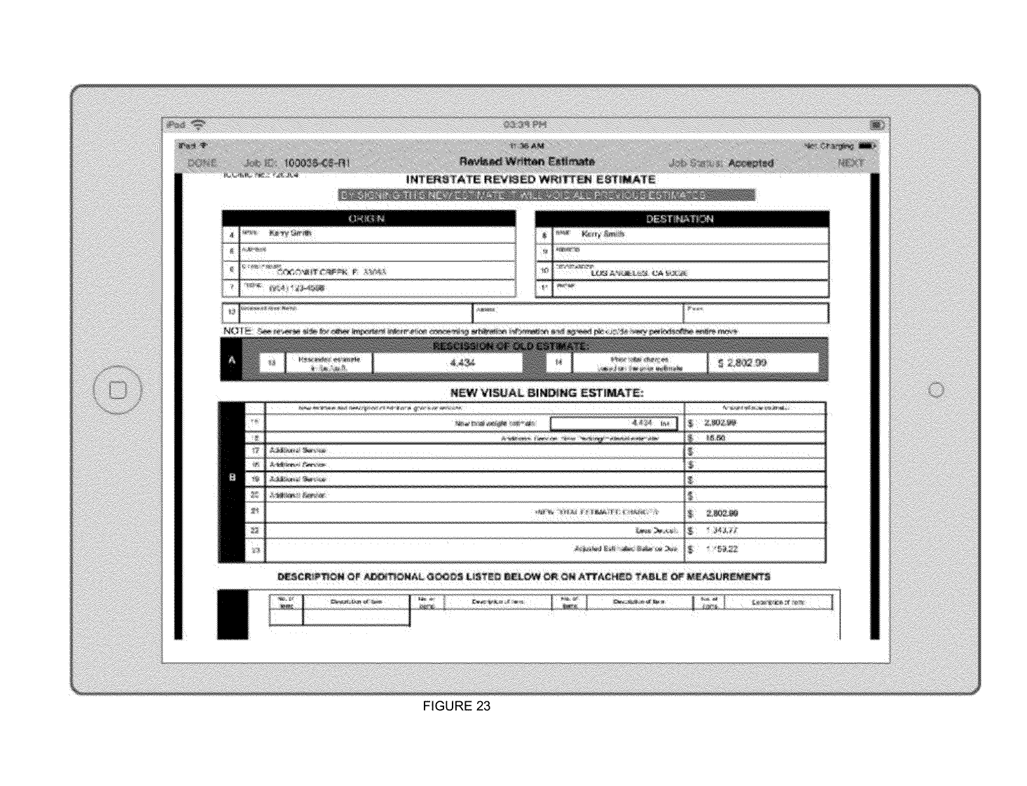

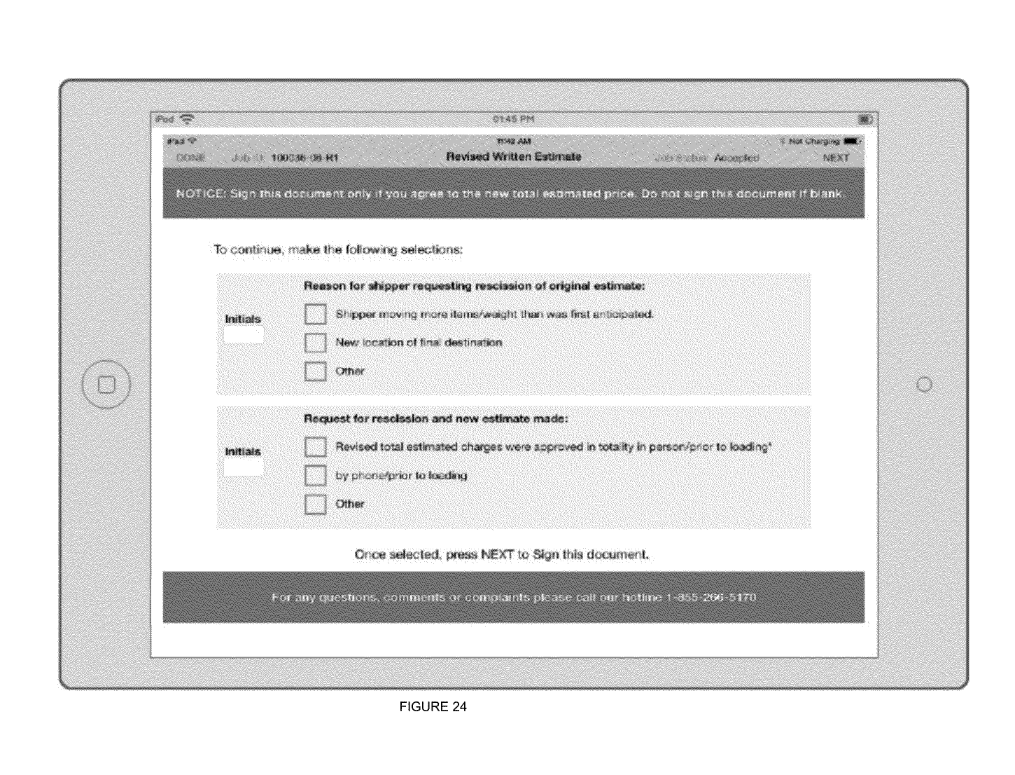

Interfaces shown in FIG. 18-20 display various packing costs for packing additional items requested by the client. Additionally, these interfaces may display items included at the time of booking and present an option to add items whereby a driver may add more items to the inventory. Upon confirming the added items via interface shown in FIG. 18, the client may agree to added items via interface shown in FIG. 20 before signing off the added items via interface shown in FIG. 21, while the driver may sign agreeing to charges via interface shown in FIG. 22.

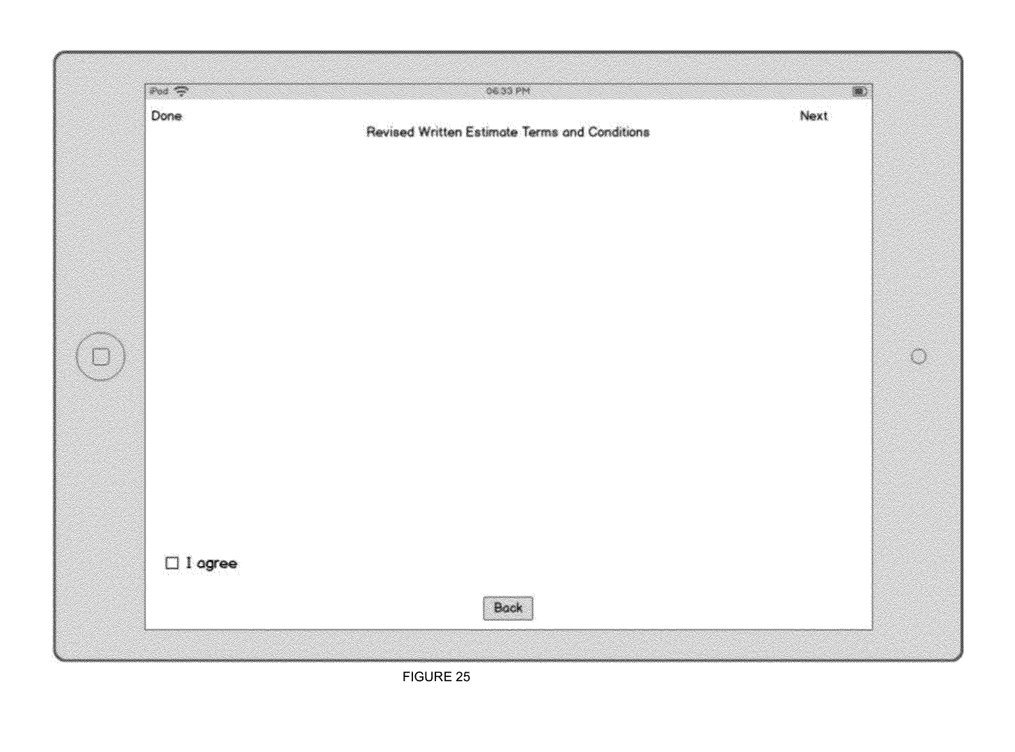

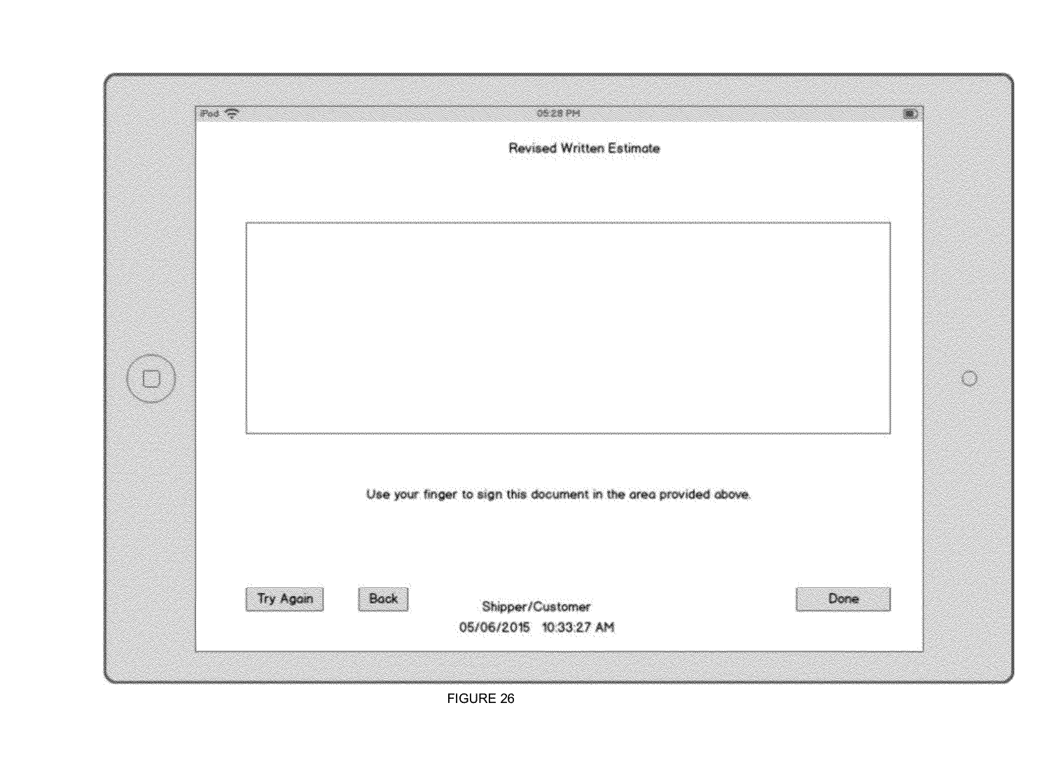

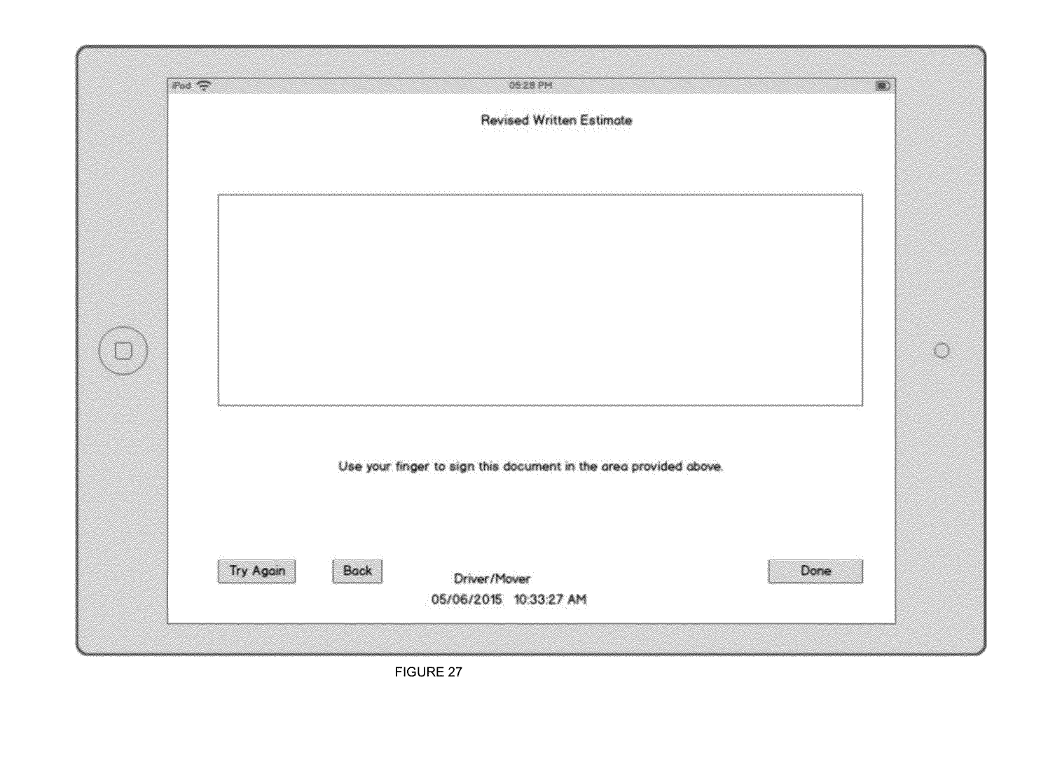

The client and the driver may review and sign the interstate revised written estimate via interfaces 23-27. This interface may reflect a change in the cost of the original estimate. Driver will review the changes and client will be prompted to initial and select the reason why a revised written estimate was created. Client may read and agree to the terms and conditions as shown in FIG. 25 and sign accepting the new estimate as shown in FIG. 26 and driver will counter sign as shown in FIG. 27.

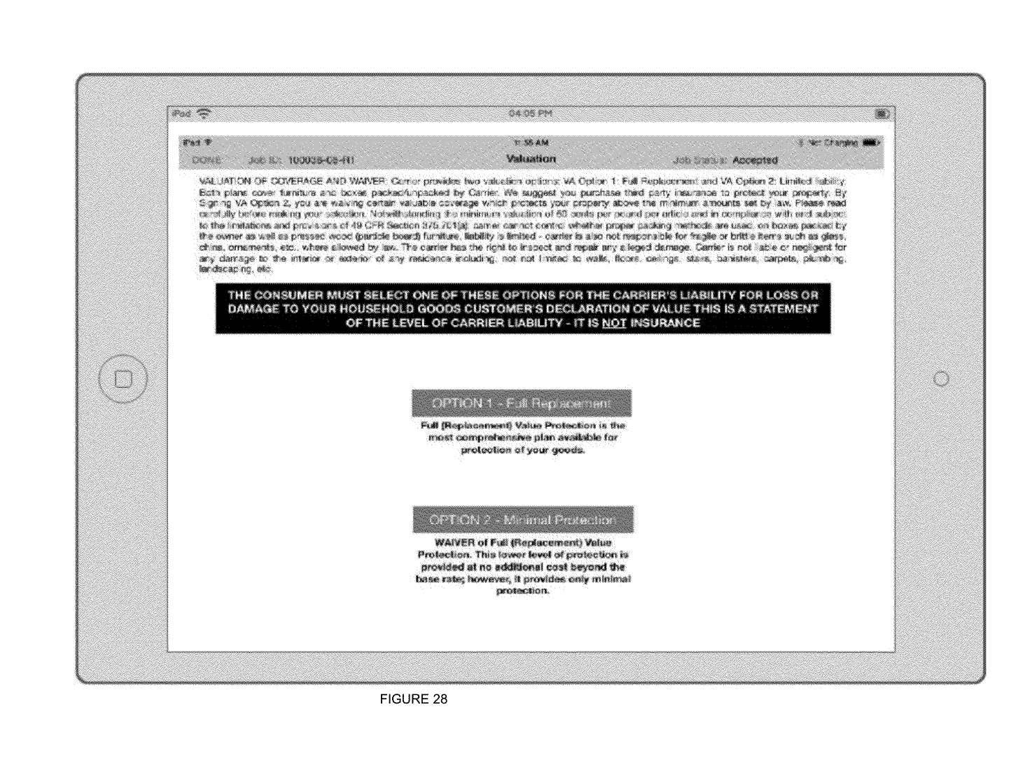

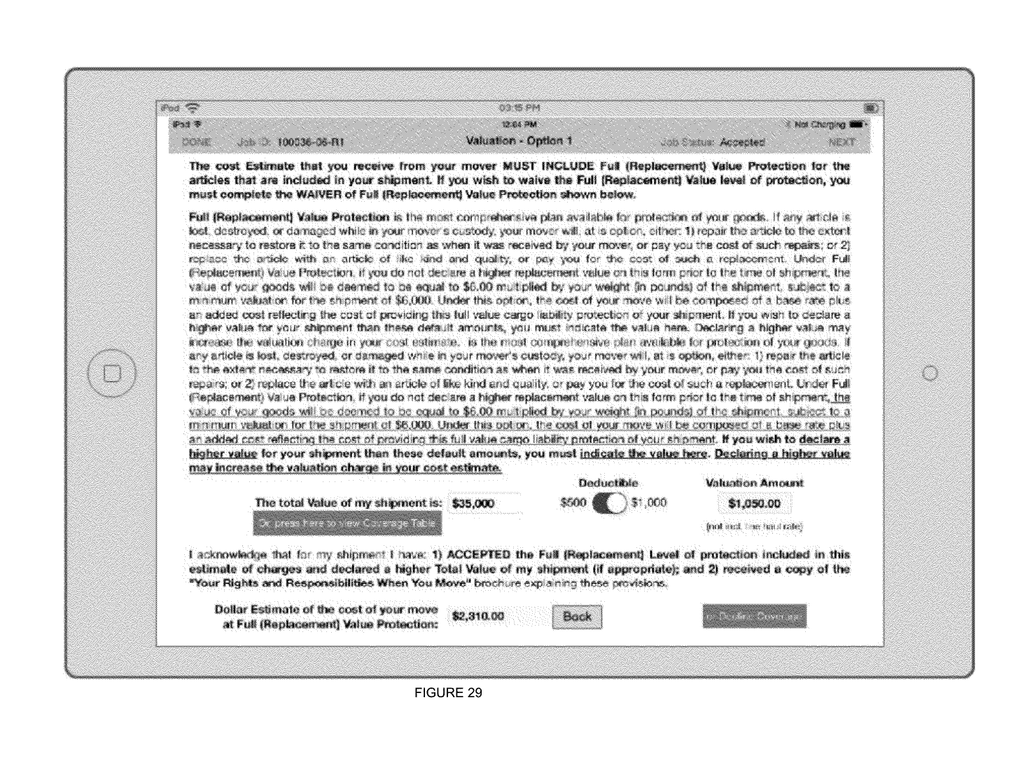

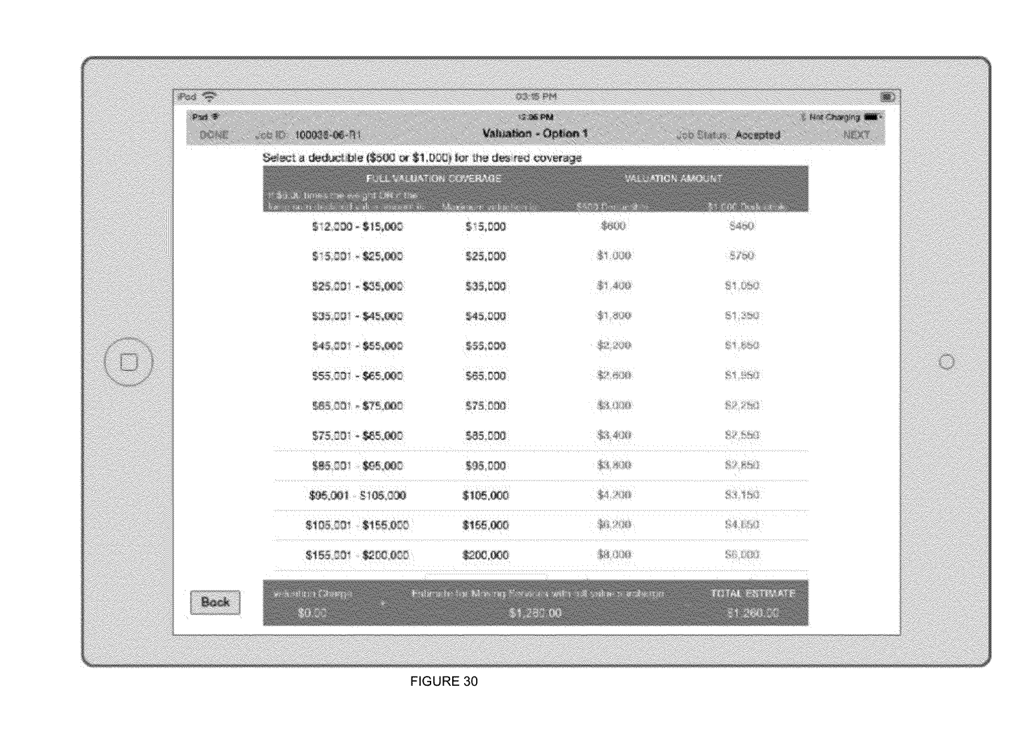

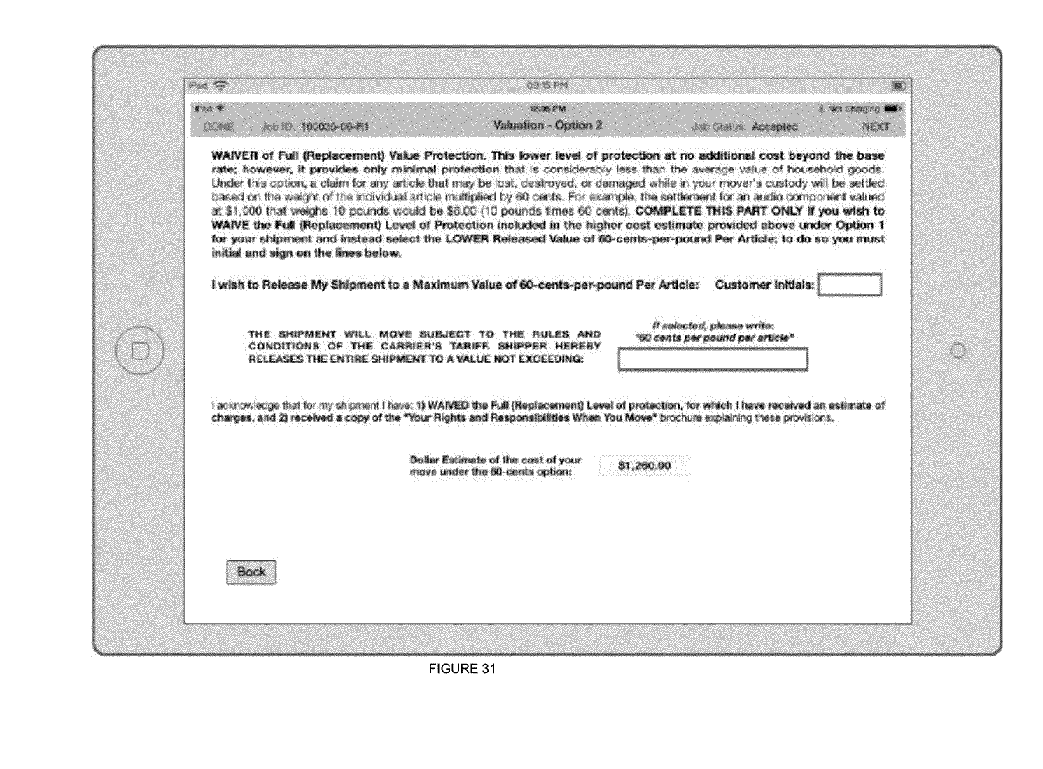

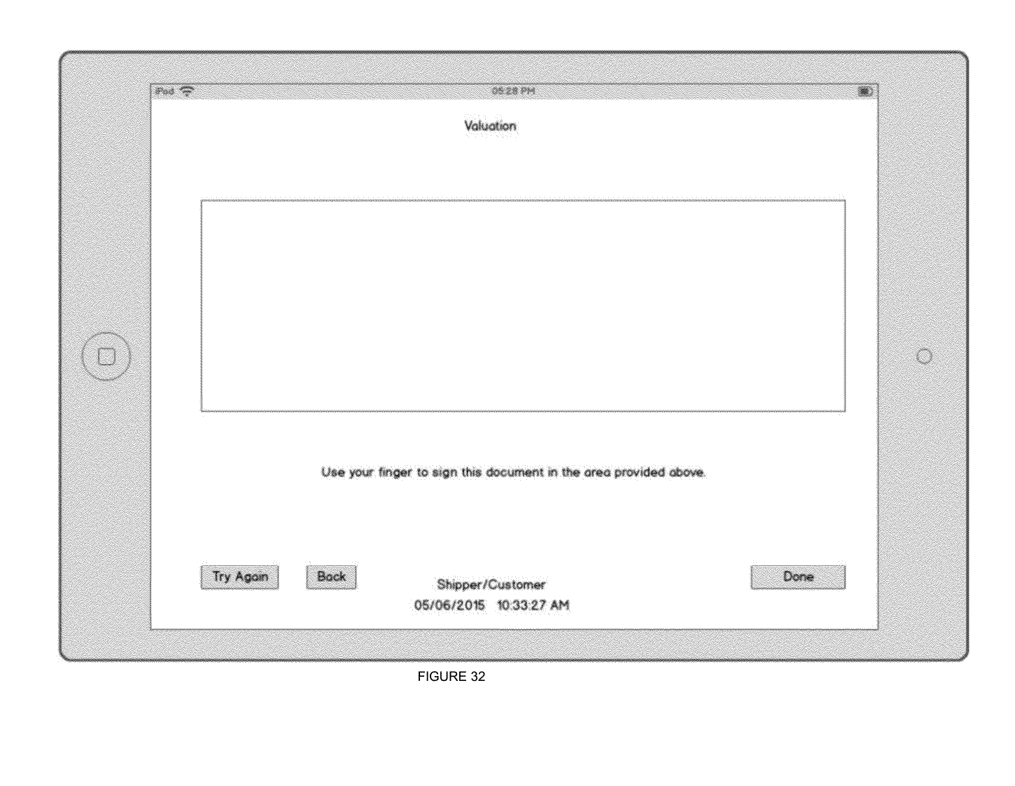

The disclosed system may present to the client several options for valuation coverage to protect the contents that are transported from the source location to the destination location during the course of the move. In the exemplary valuation interface shown in FIG. 28 the client is presented two options and may choose one of the two options. If option one is selected, client may be asked to choose a $500 or $1000 deductible. Notably, the client may view the coverage table and select a higher coverage amount. Alternatively, if option 2 is selected, then client may input 60 cents per pound per article in the input box provided on the interface to select minimal protection for the inventory, which may cover 60 cents per pound per article in the designated boxes. After reviewing various valuation options displayed in FIGS. 29-31, and after making a selection of their valuation option, client may sign accepting the chosen valuation coverage option via interface shown in FIG. 32.

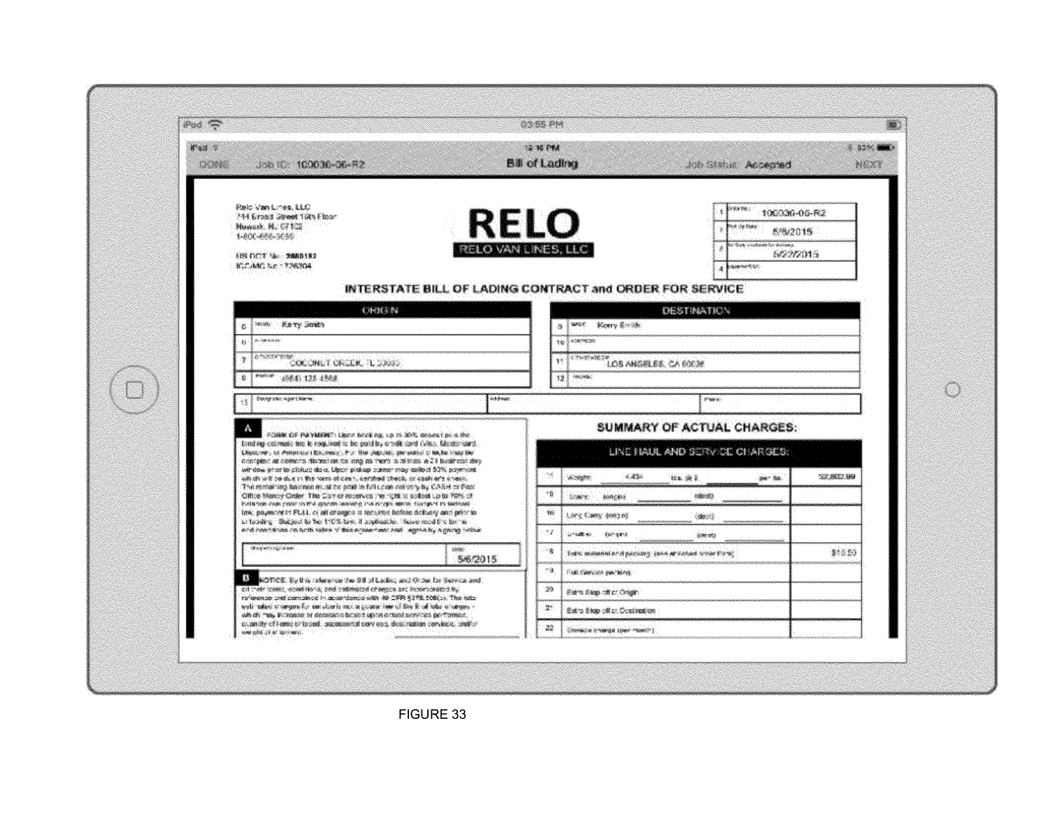

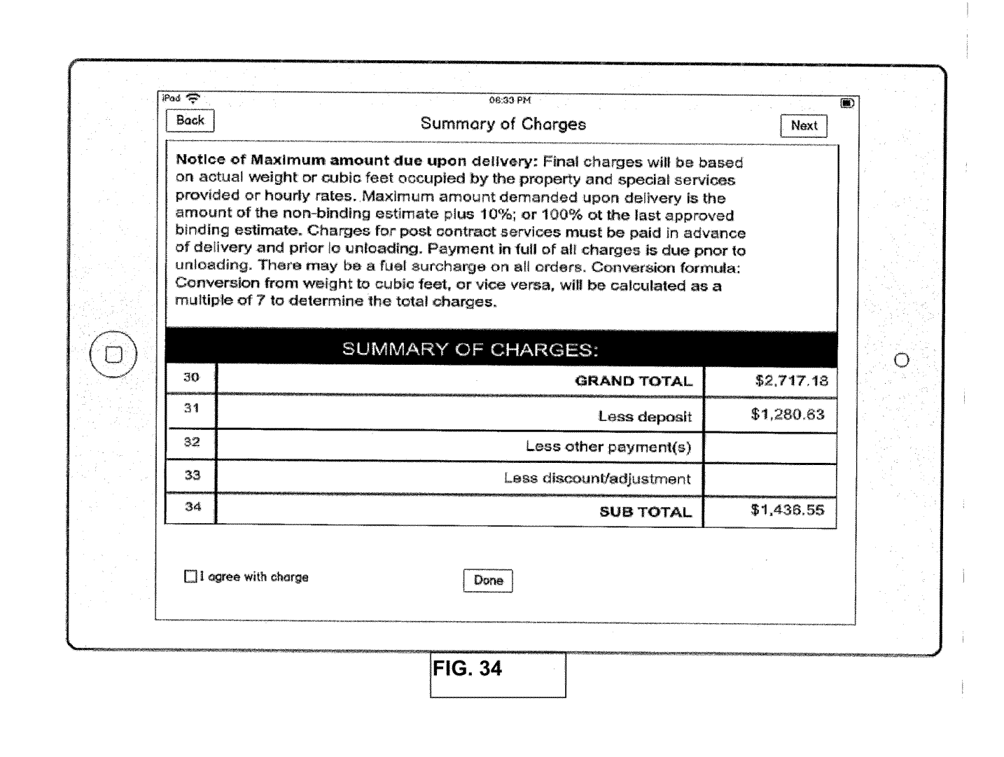

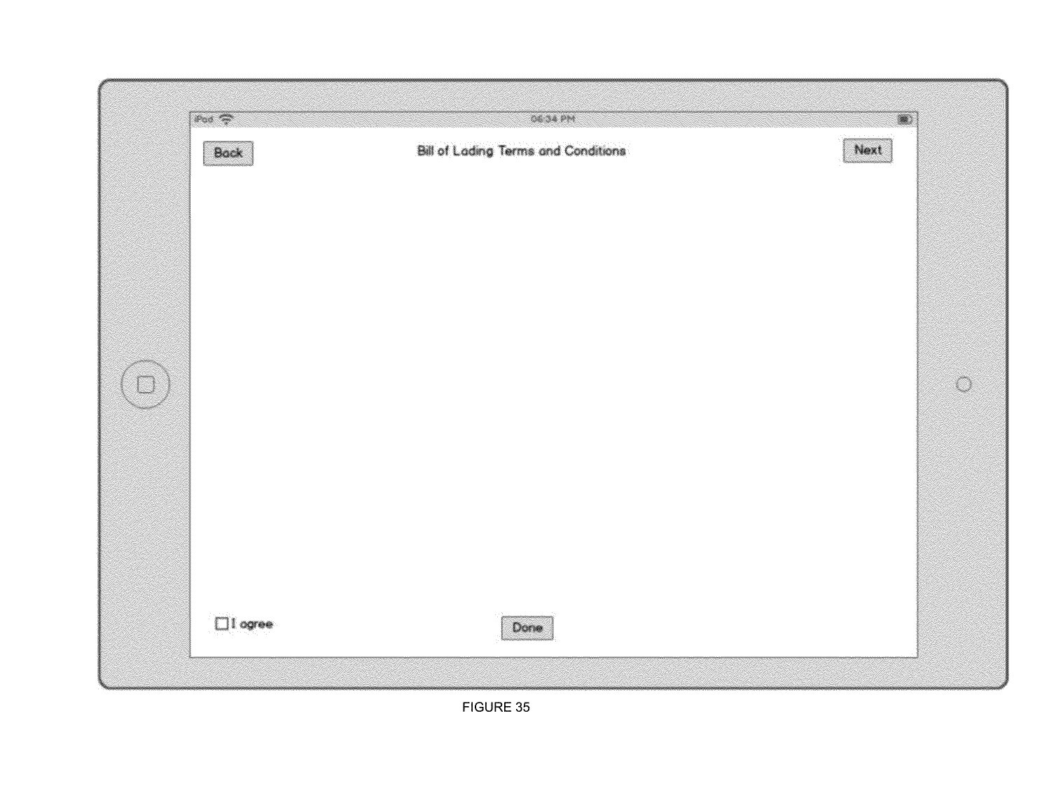

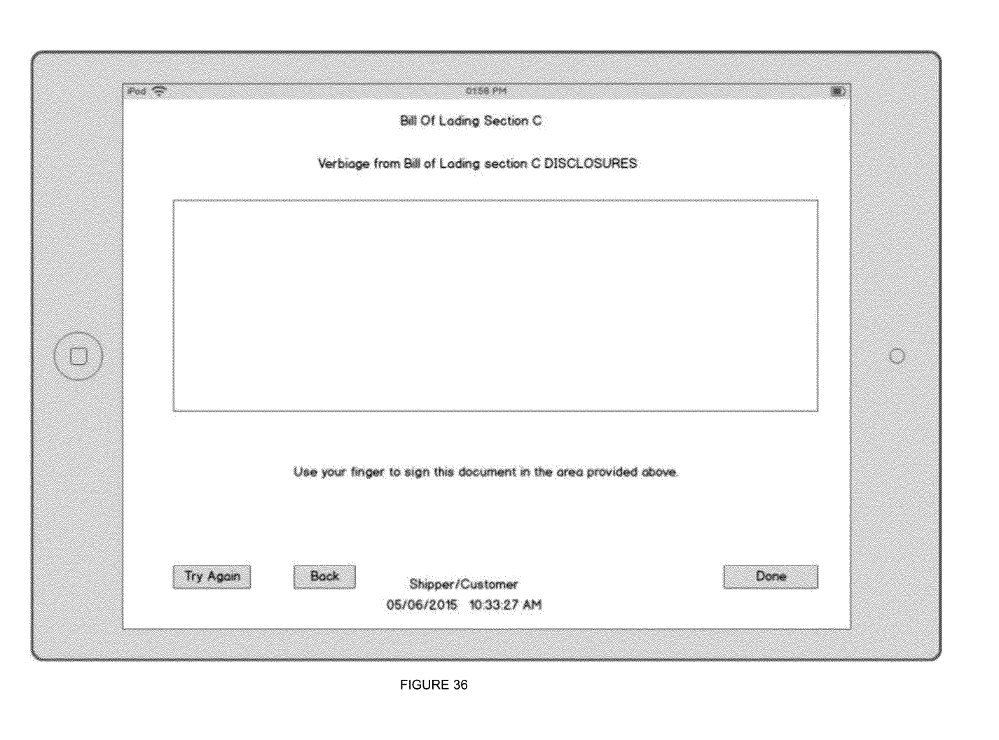

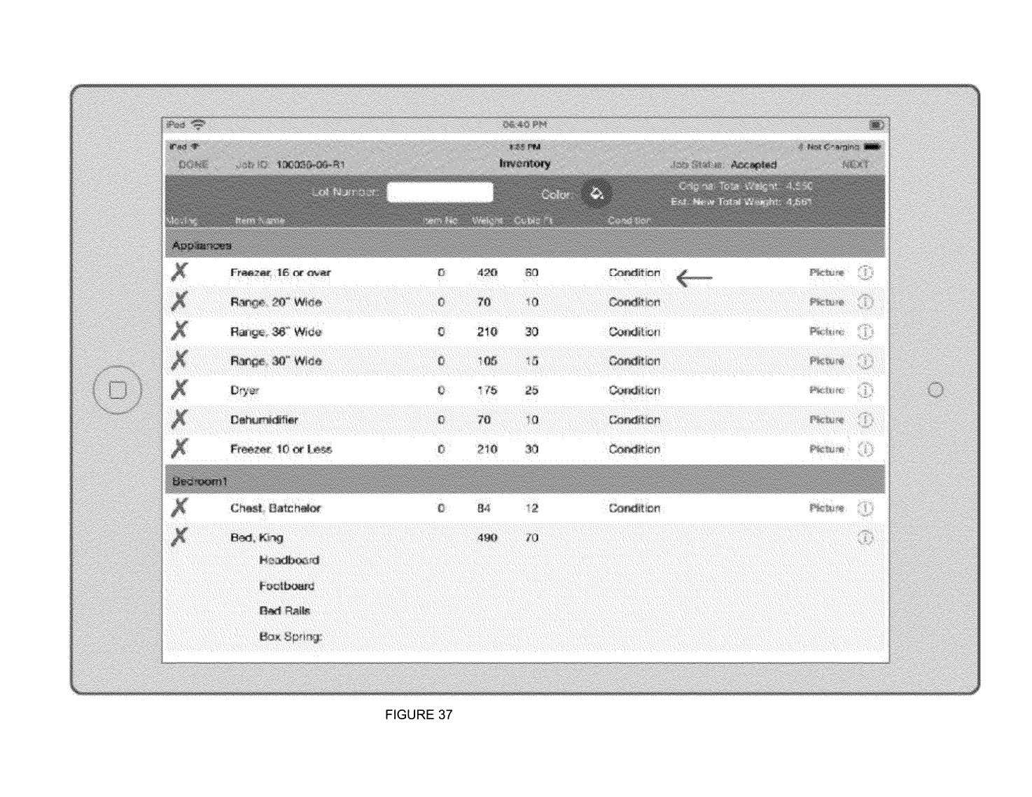

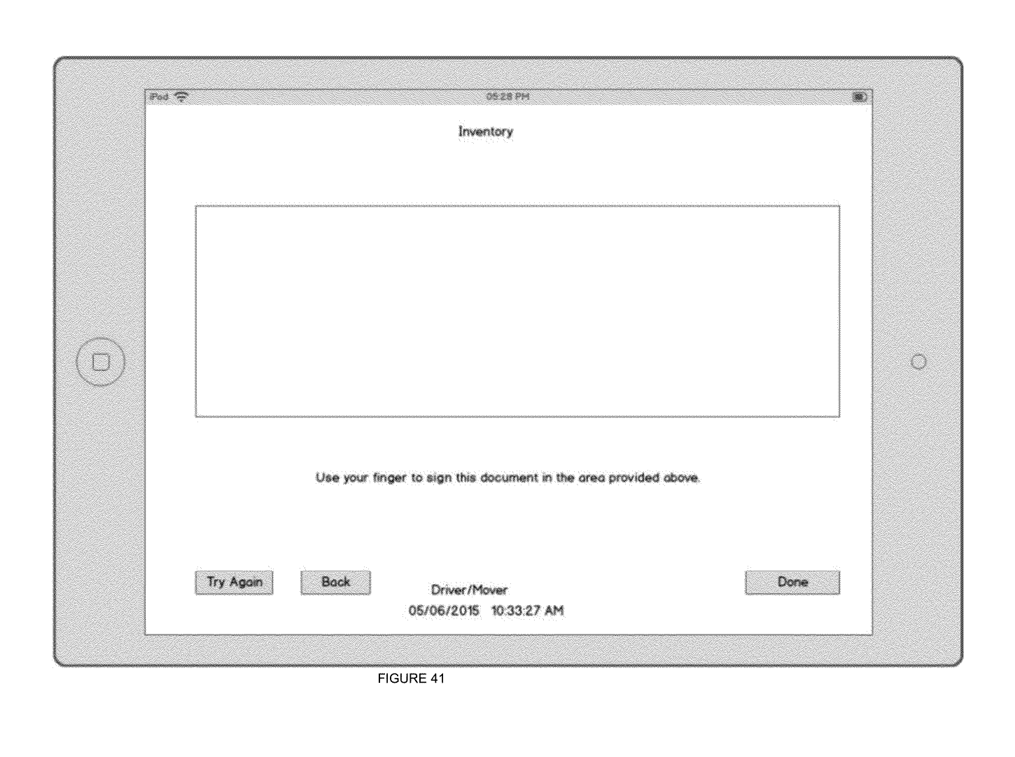

Likewise, the disclosed system may present to the bill of lading shown in FIG. 33 to the client. The client may be presented three areas to sign, not shown in FIG. 33. Interface shown in FIG. 34 may show the client break down of actual charges. Client may also be able to review a summary of deposit collected and balance that may be due upon delivery. Client may be prompted to agree with terms and conditions of the bill of lading via interface shown in FIG. 35 before accepting the charges via interface shown in FIG. 36. Interface shown in FIGS. 37-41 various interfaces associated with the inventory are displayed.

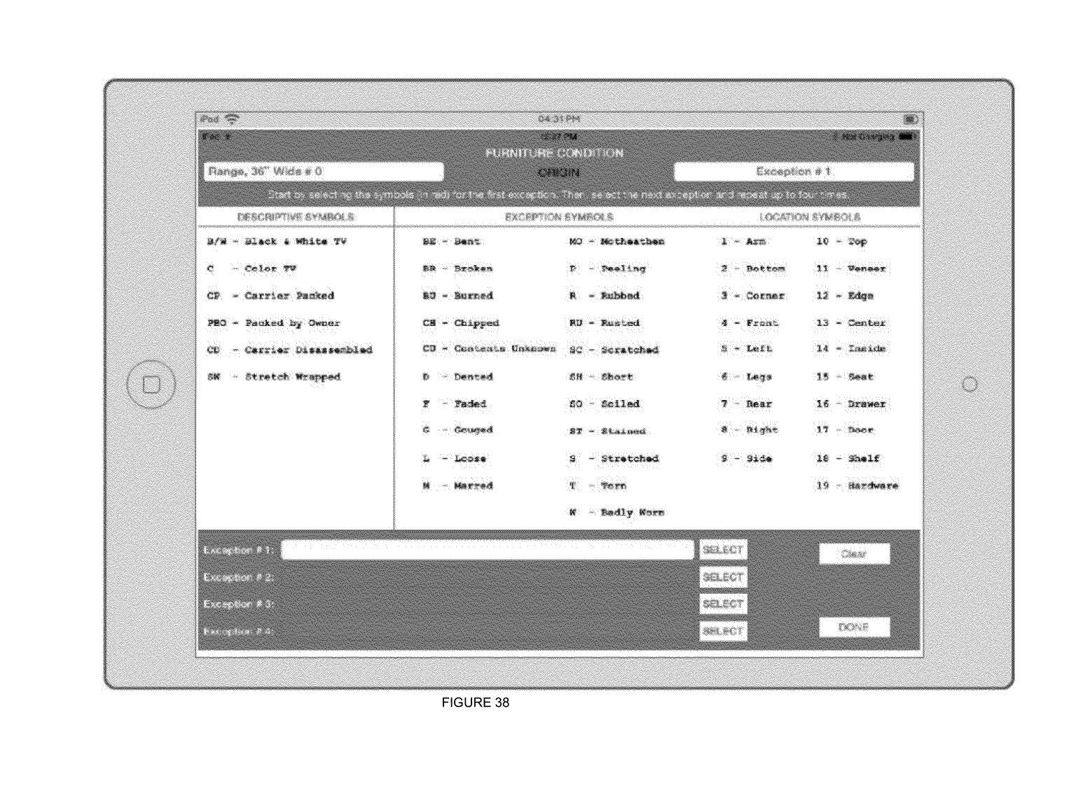

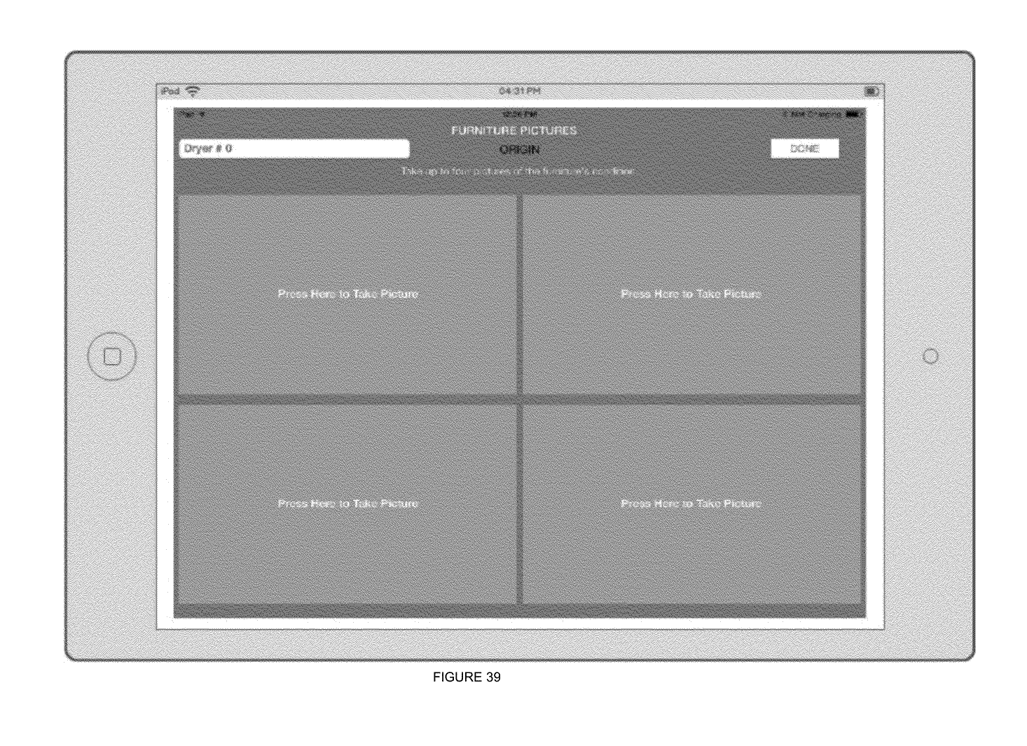

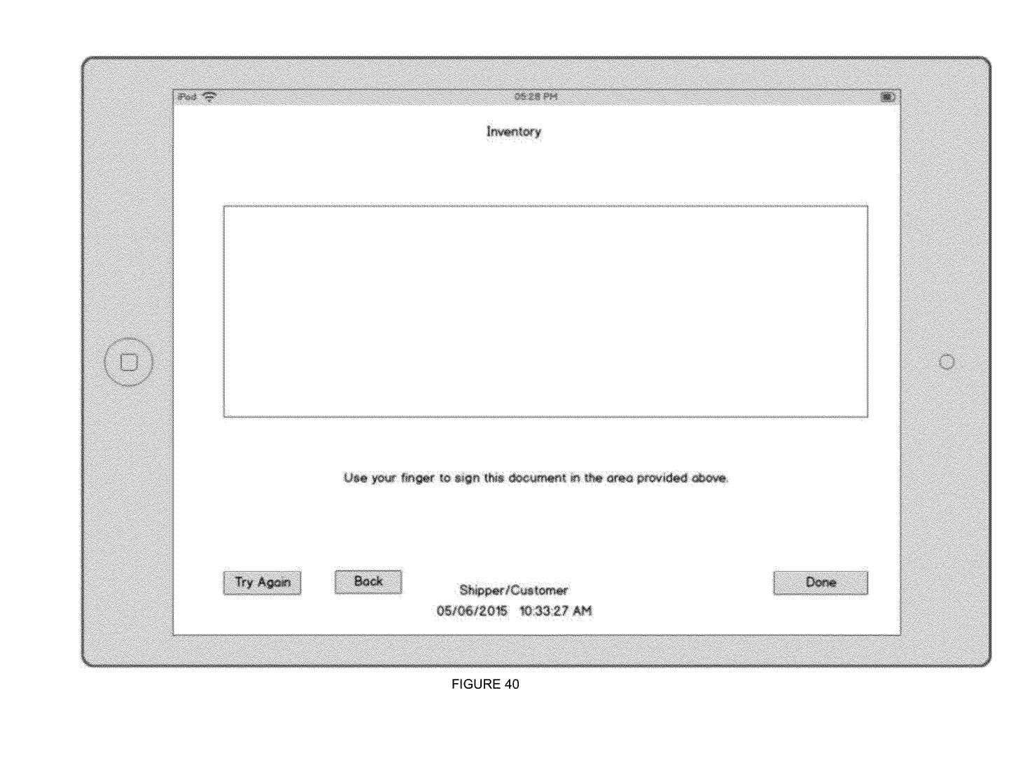

For example, inventory interface shown in FIG. 37 may show the items needed to be moved and packed. The driver may optionally assign a lot number and color to the client's load, before taking a picture of the actual item and entering a condition for each item. In other words, the driver may be required to note condition of each item listed on the interface shown in FIG. 37. The codes for indicating condition of the item are shown in FIG. 38. The driver may additionally be able to take pictures of the items via interface shown in FIG. 39. Once the above mentioned tasks are completed, client may be asked to sign the document showing the items to be moved and damages reported via interface shown in FIG. 40 and driver may counter sign via interface 41.

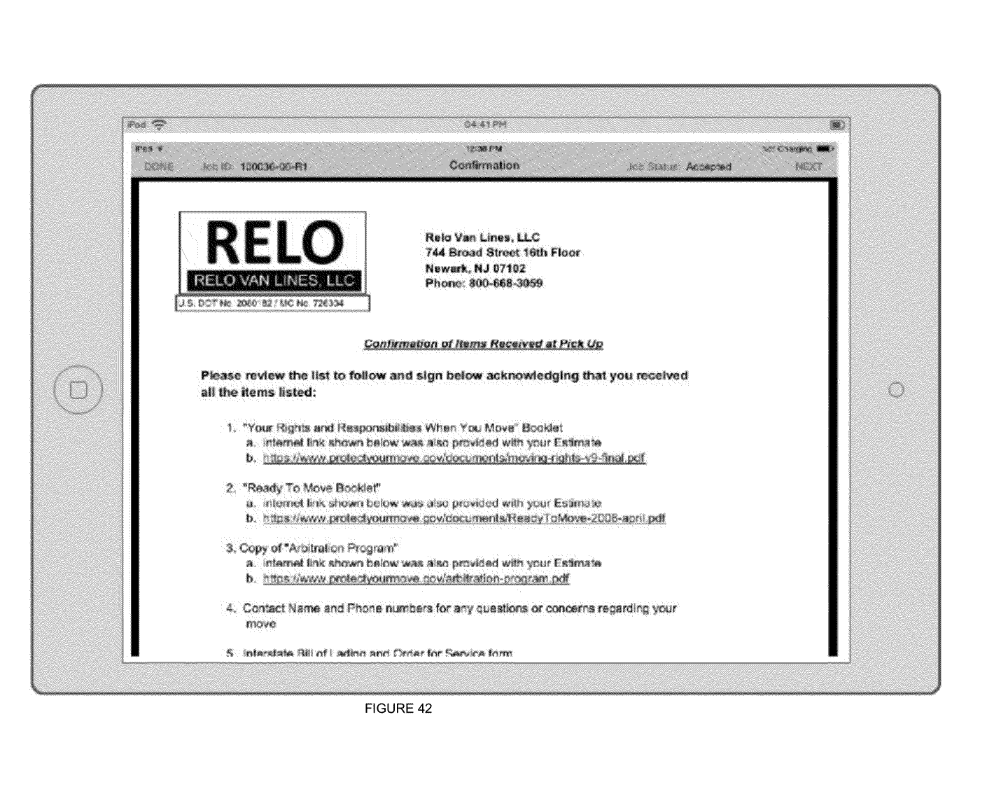

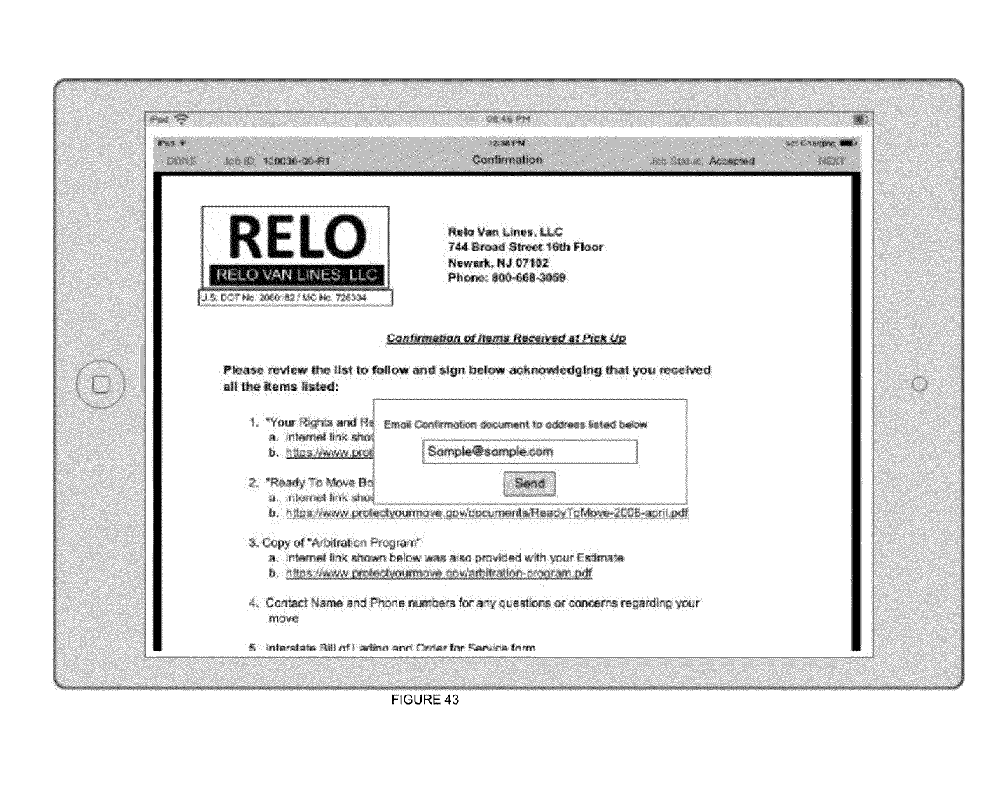

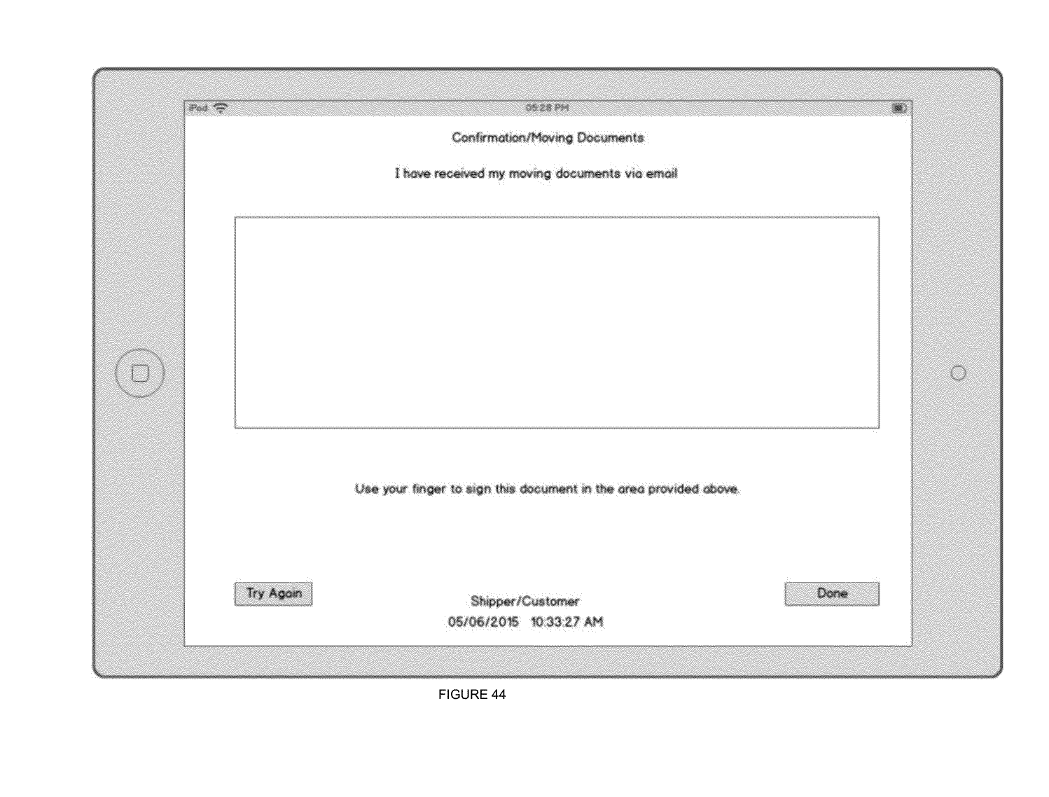

FIGS. 42-44 display a set of confirmation interfaces according to one embodiment of the disclosed invention. For example, the interface shown in FIG. 42 may display moving related documents that the client was supposed to received prior to or during pick up. Client may be via interface shown in FIG. 43 asked for email address so documents listed on the confirmation page can be emailed if the document are not already received by the client. Client may then be asked to sign acknowledging they have received said items via interface shown in FIG. 44.

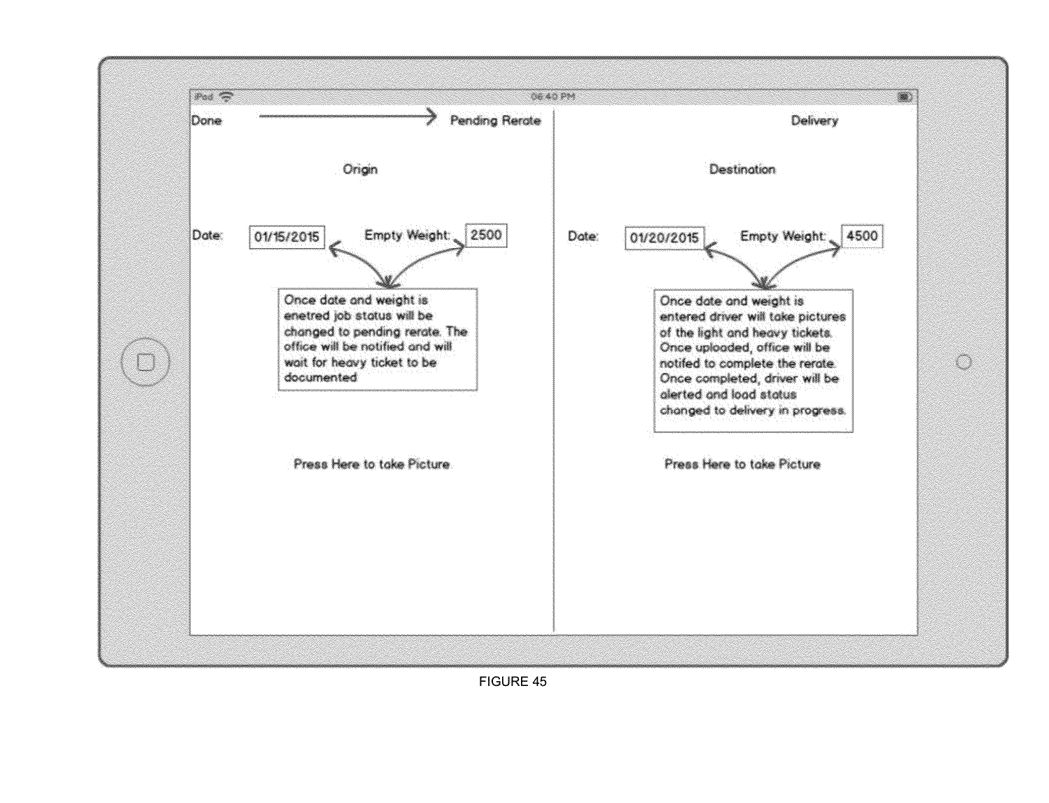

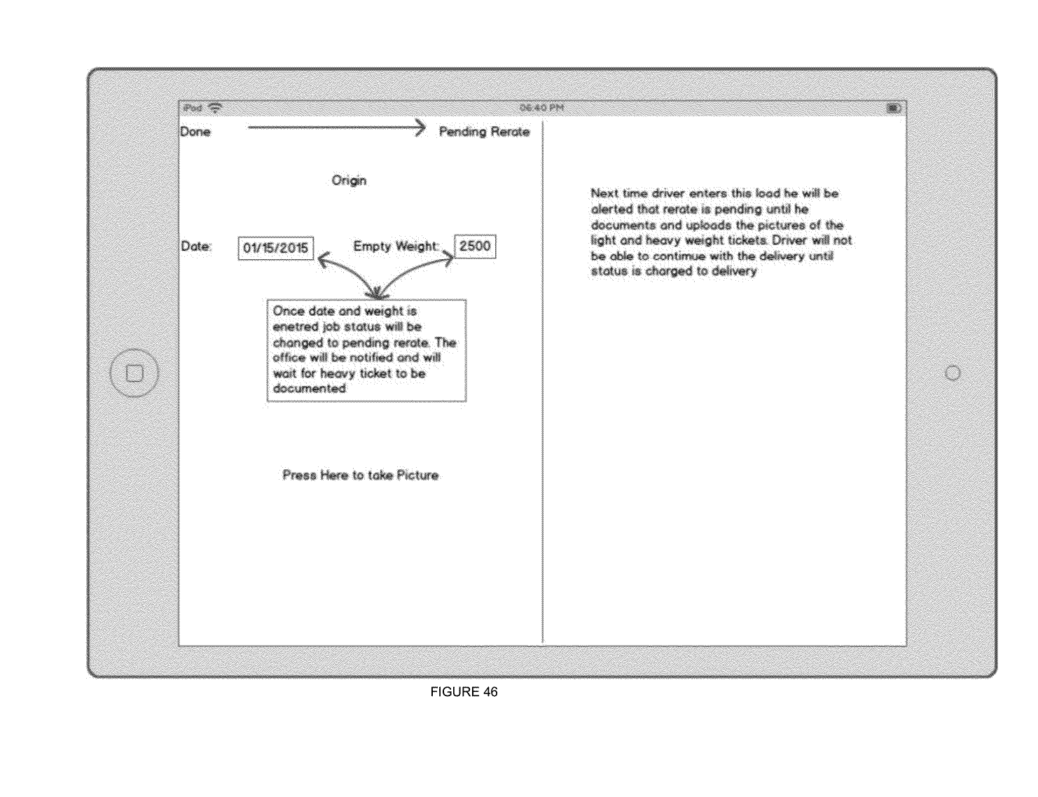

Interfaces shown in FIGS. 45-46 display weight ticket feature of the system of the disclosed invention. The interface shown in FIG. 45 allows the driver to take pictures of both weight tickets received by the driver when weighing the equipment. The driver may also be able input the date of the ticket and weight shown on the interface shown in FIGS. 45 and 46. When the light ticket process is complete, the load status may change to pending rerate status and optionally the office may be notified. The driver may wait for the heavy ticket to be uploaded so rerate procedure can be completed prior to delivery. The weight tickets may be sent to company office where rerate procedure may be performed for the weight tickets. Once rerate procedure is completed, driver may be notified and delivery can proceed as planned.

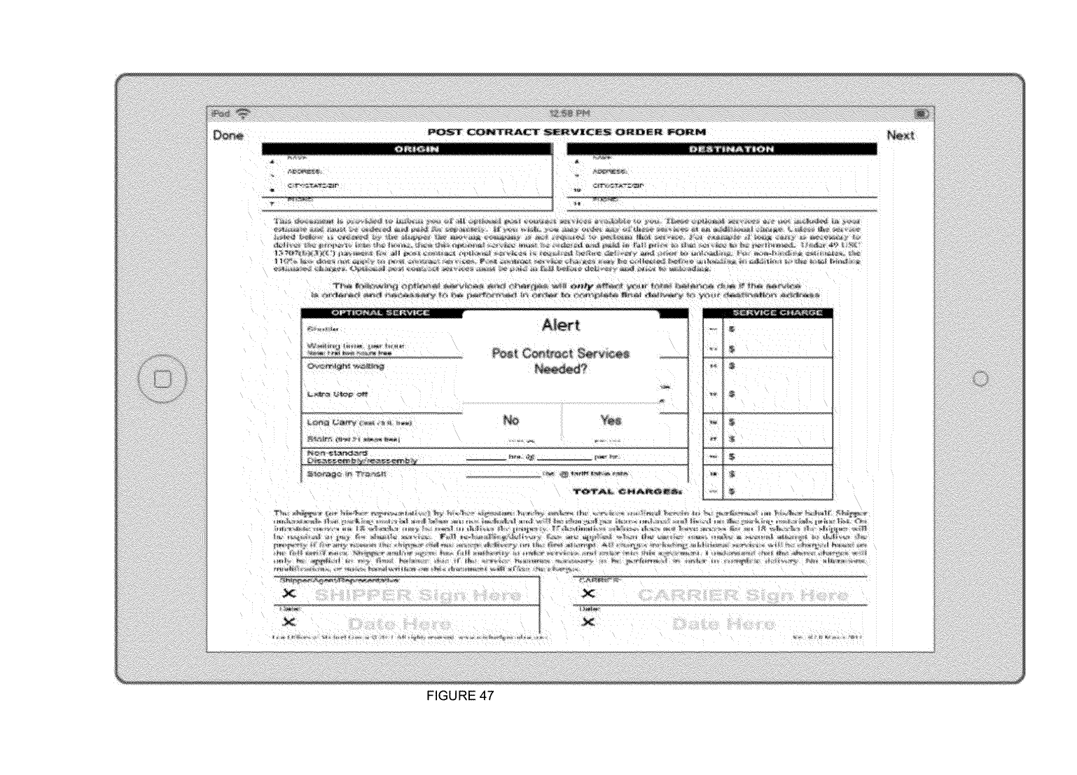

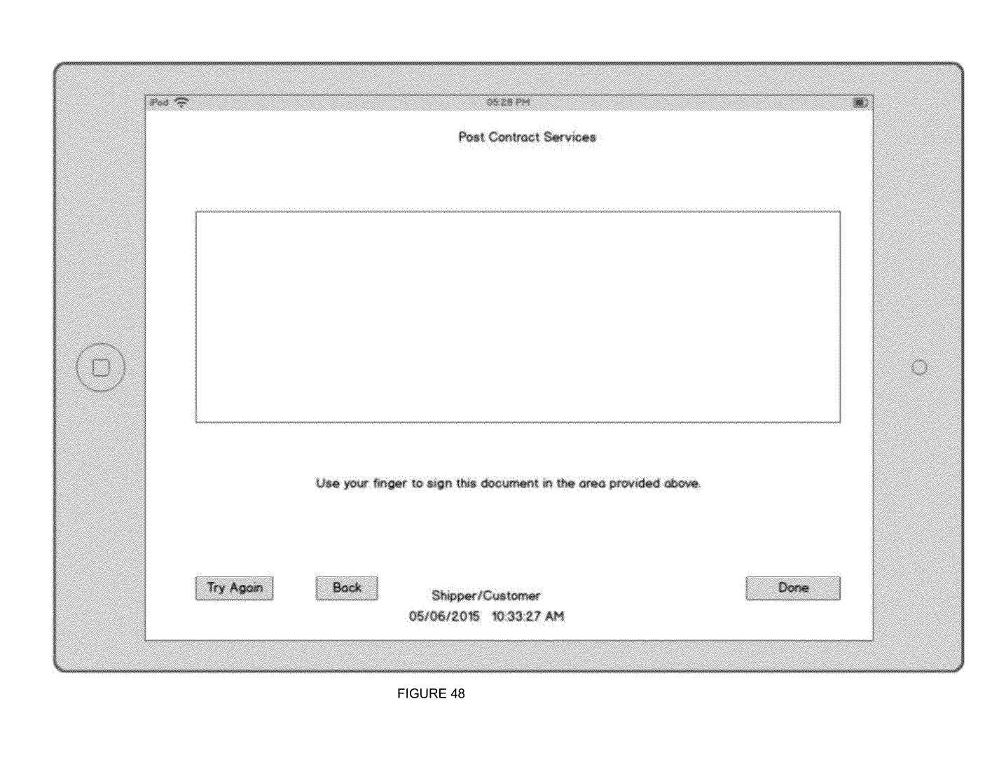

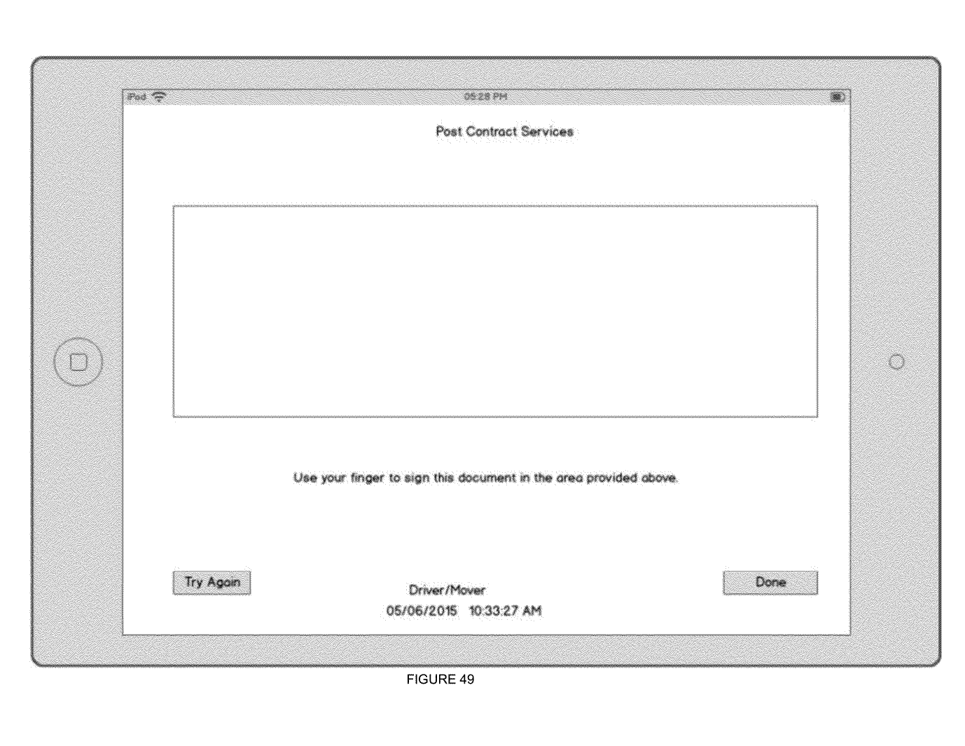

Interfaces shown in FIGS. 47-49 show various aspects of a set of post contract services that may be performed by the system according to one embodiment of the disclosed invention. The post contract services may refer to the services that were needed at time of delivery, which were not foreseen at the time of the pickup. As seen from FIG. 47, the driver may be presented a query as to whether or not the post contract services were needed. If the post contract services were needed, then the client may via interface shown in FIG. 48 may sign to indicate the client's agreement with the driver's assertion, and driver may counter via interface show in FIG. 49.

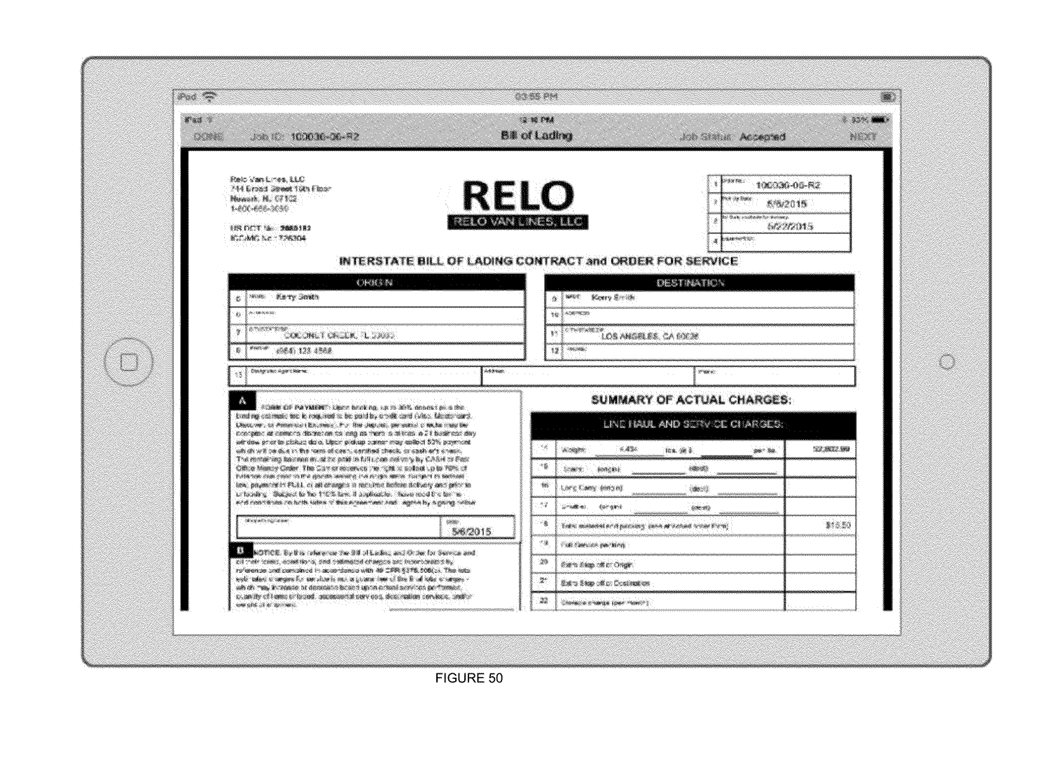

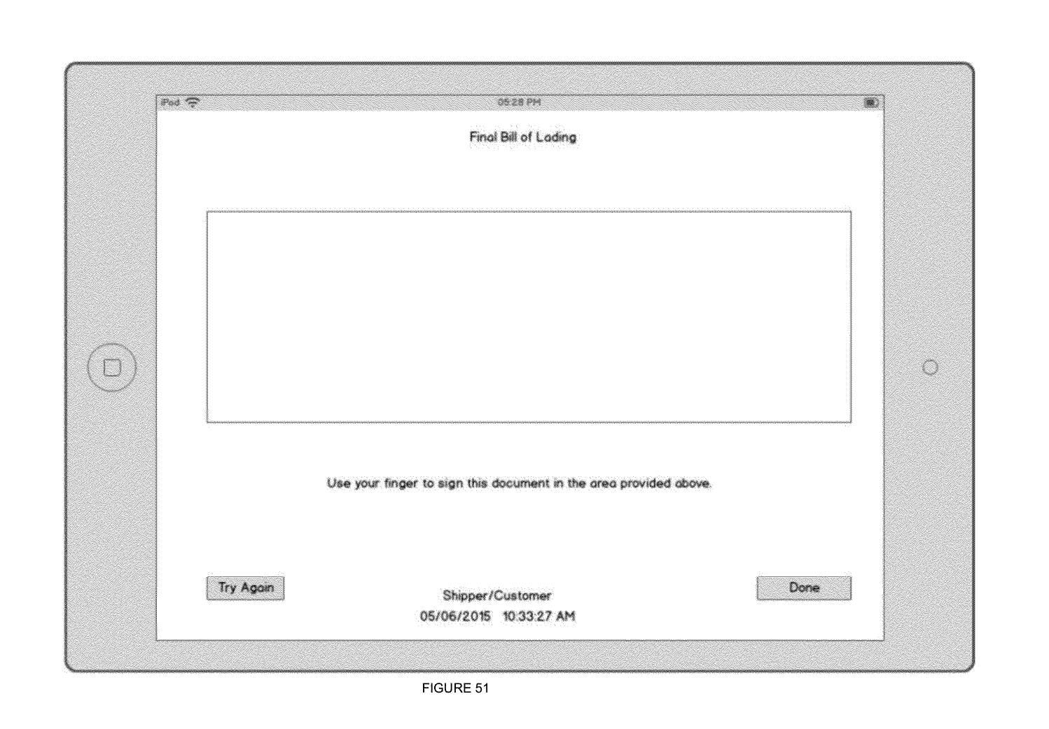

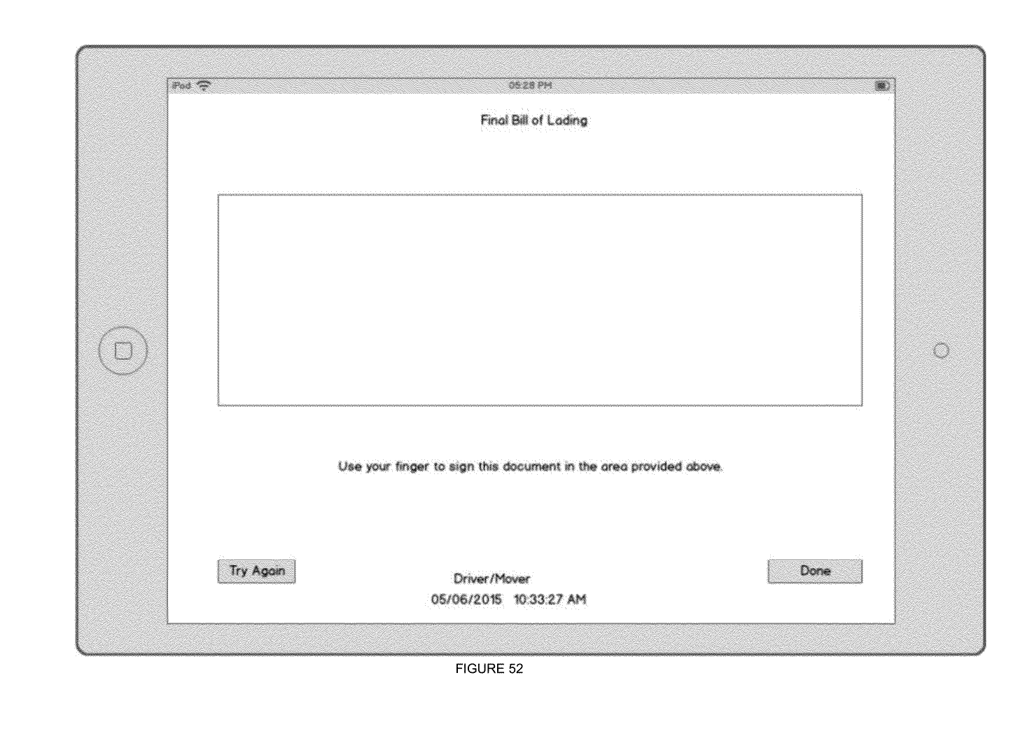

Further, interfaces 50-52 indicate the process where the final bill of lading may be presented to the client upon arrival of the client's load at the destination location. The interface shown in FIG. 50 may show client the final charges based on actual weight and services provided to the client. The client, as shown in FIG. 51 may sign indicating the client's agreement to the final bill of lading and the driver may counter seen in FIG. 52.

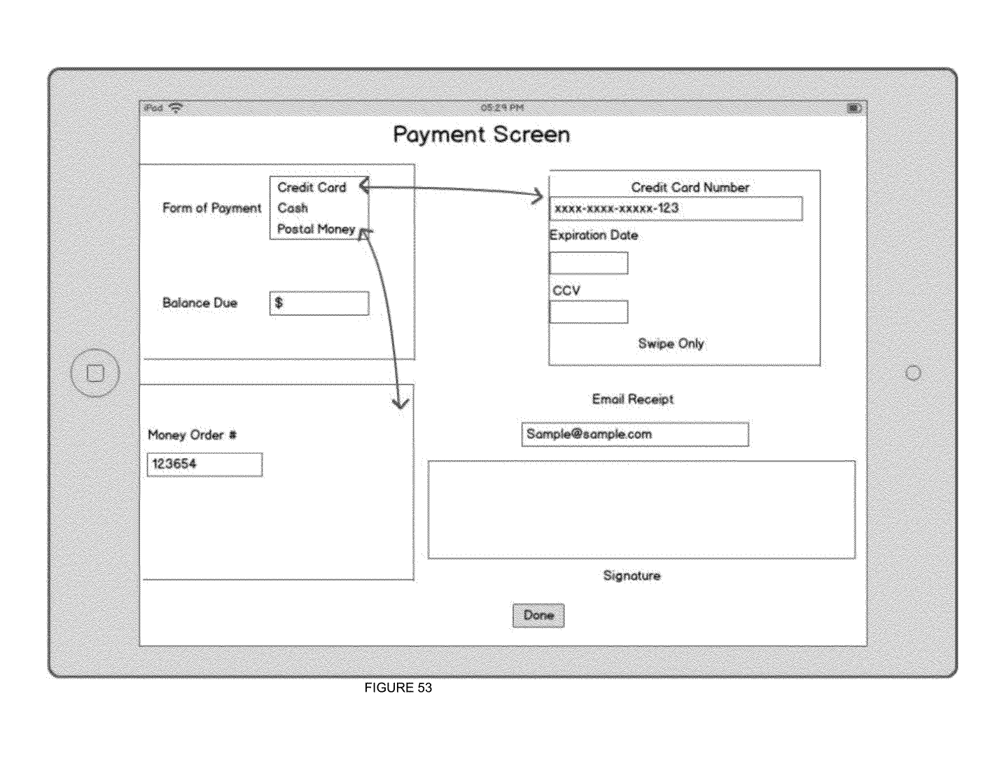

Interface shown in FIG. 53 may display interface depicting payment screen functionality of the disclosed system. The driver may select a form of payment (credit card, cash or postal money order) via payment interface. If the client selects to pay with a credit card, then the driver may swipe the client's credit card on the driver's reader attached to the driver's electronic device. Alternatively, if the client selects to pay via a money order, the driver may be able to log the money order number. Once the payment transaction is completed, the client may be asked to sign the form shown in FIG. 53 and the system may optionally have the receipt emailed to the client. In an event if the client's card is not available, then the admin may need to electronically charge the client's card from the office, the client's bank account or other finance account from a remote location via the internet connection.

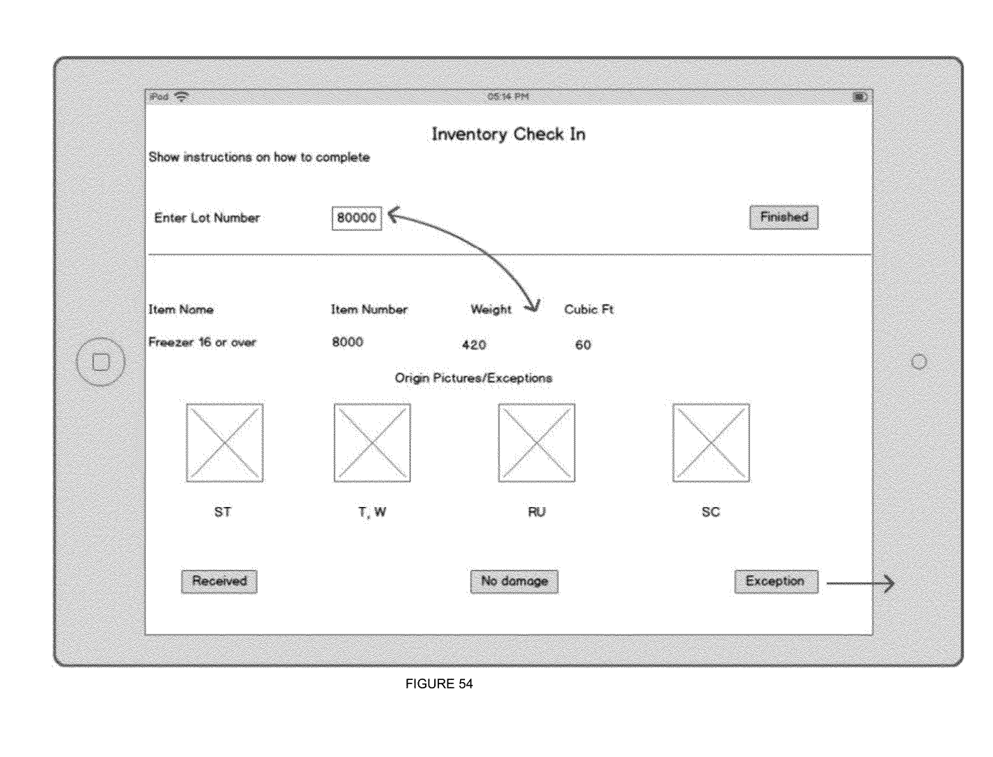

FIG. 54 depicts inventory check in interface according to a preferred embodiment of system of the disclosed invention. During the offload process, client may be able to check off each item that is placed in the destination location and inspect each item for any possible damage. The client may do this by inputting the lot number of the item presented and follow the select the received option to show items that were received. The client may place a double check mark next to said item.

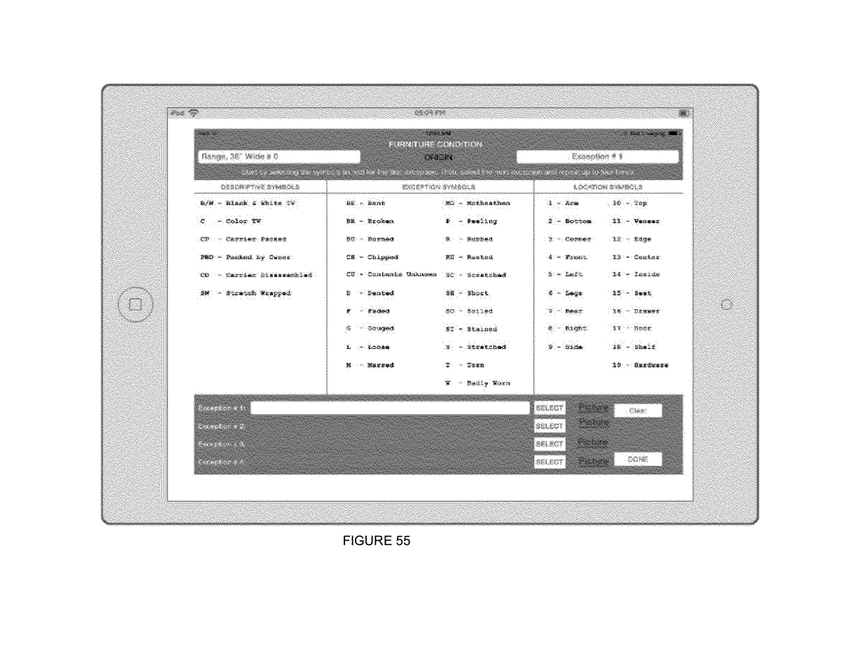

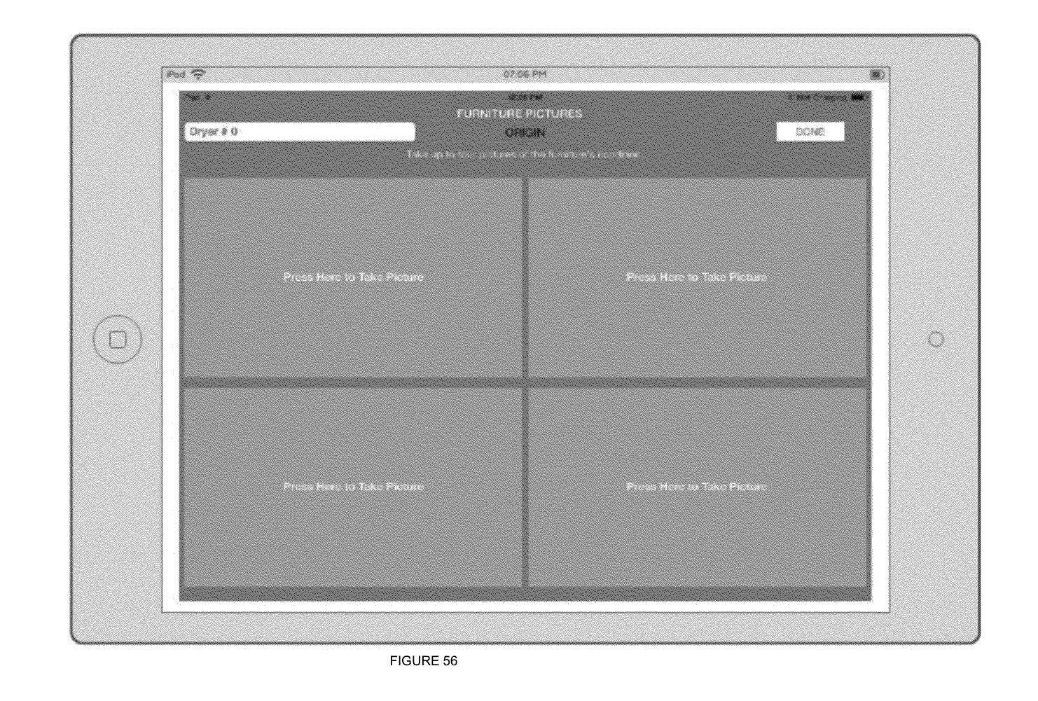

As a result, said item may show any pictures and damages reported at pick up. In other words, this functionality may present a before and after picture of the item in question. Therefore, if additional damage is present at the time of delivery, which was not present at the pickup time, then the client may be able to take a predefined number of pictures of the damaged item to precisely identify nature and location of damages as seen in the interface shown in FIG. 56. Damages may be adequately described via condition codes depicted in the interface shown in FIG. 55. The damages may then be sent for processing to the claims department.

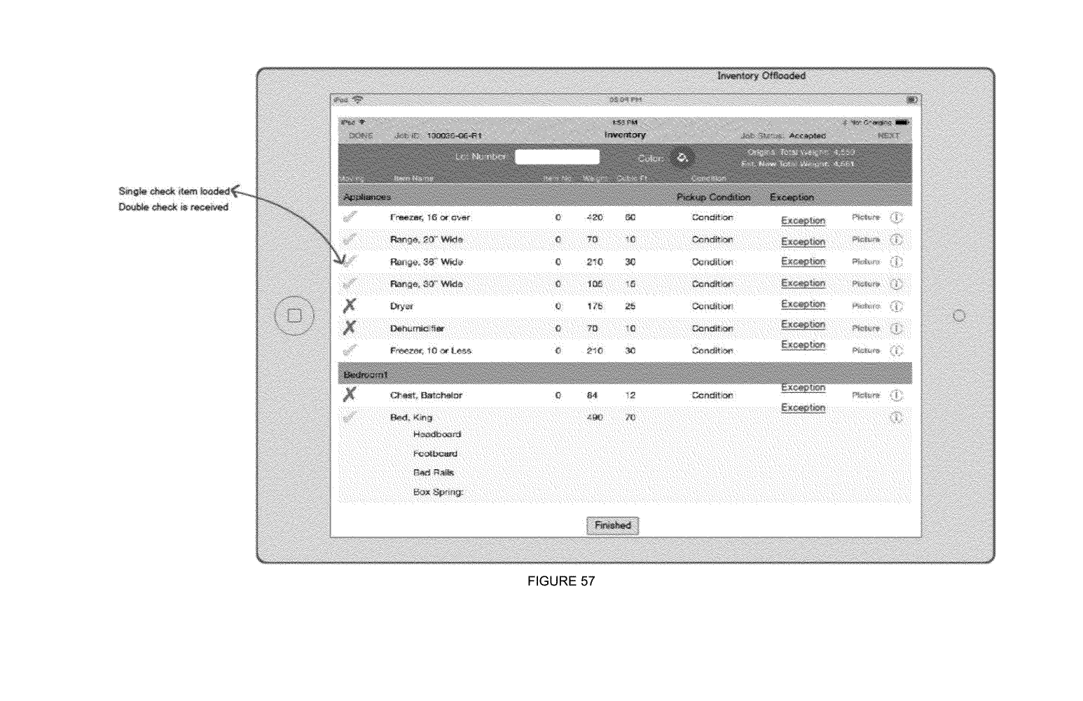

Once all items are processed via damage inspection, the client may view a summary of items received and summary of missing items as seen in the interface shown in FIG. 57. The each loaded item may be marked by a single check mark while each received item may be marked by a double check mark. Alternatively, if an item marked with a single check mark is not located after conducting a due search of the driver's equipment, and the destination location, then the item may be categorized as the missing item, and may be marked by a X. In other words, the identification of the missing items may cause the driver to search the truck and/or the client to search the destination location facility to locate the missing item. Even after conducting a due search if missing item is not located, then the missing item may be indicated on the claim form as a missing item.

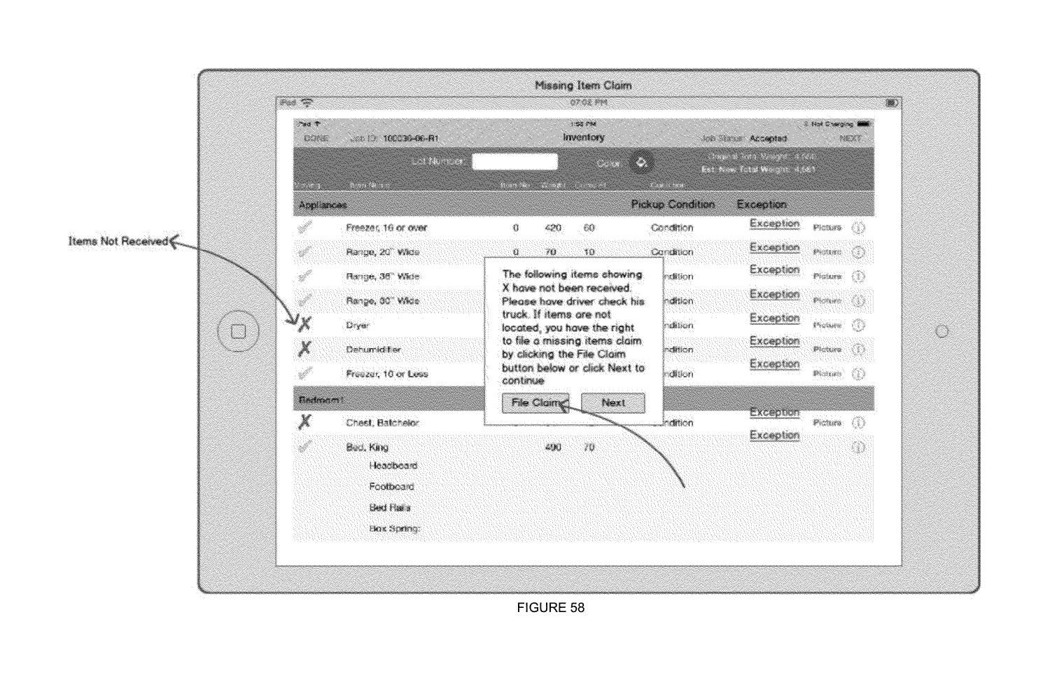

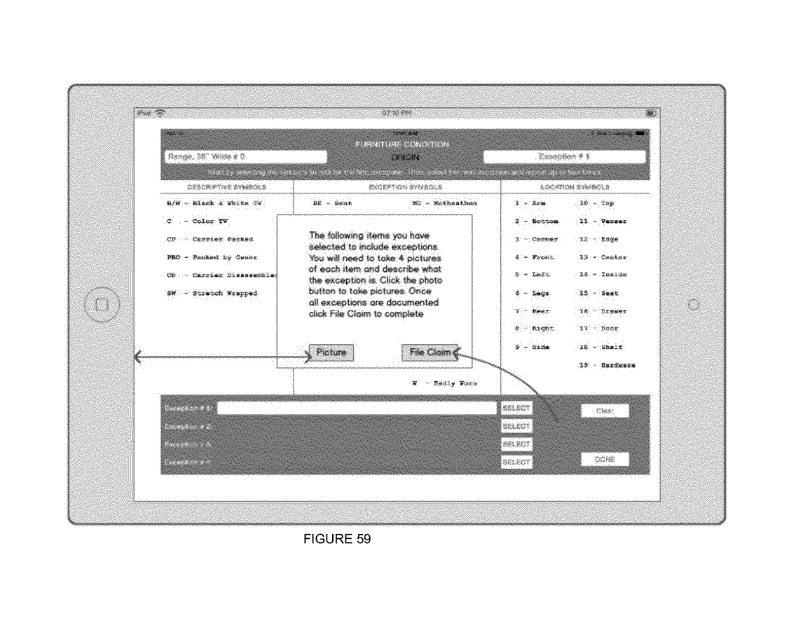

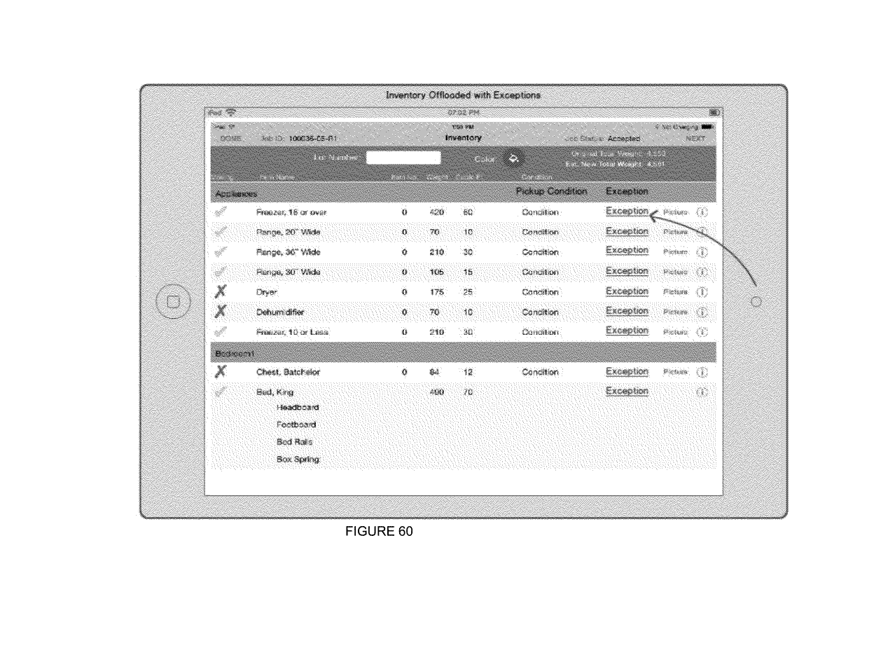

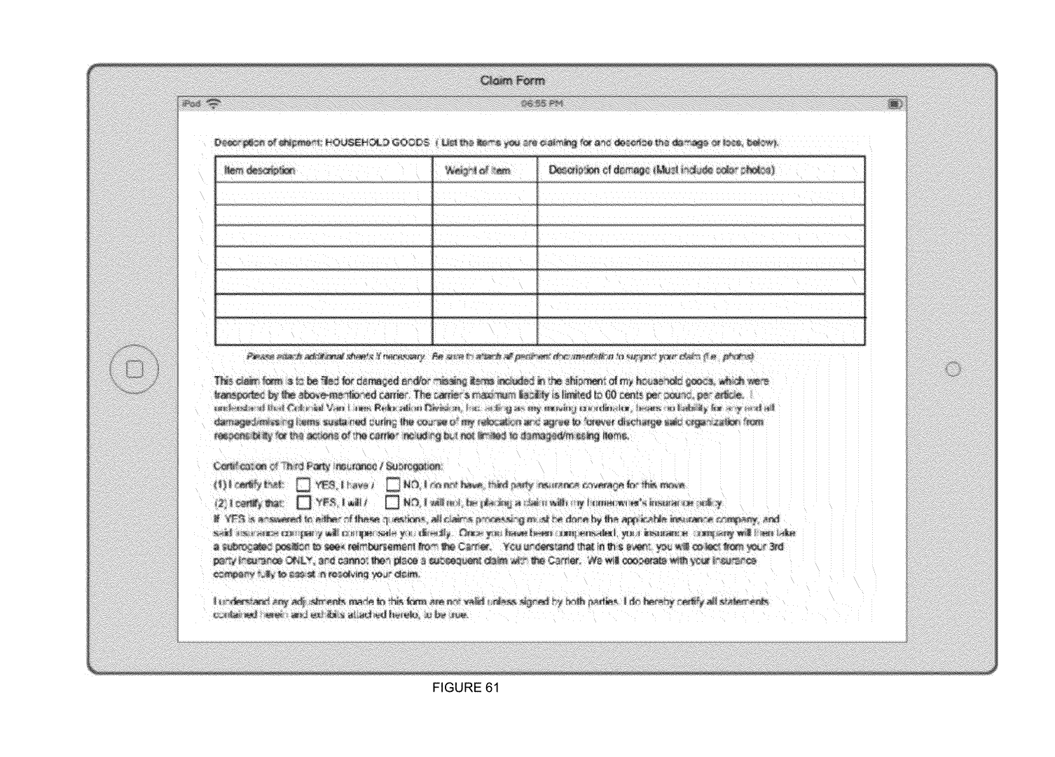

At this point, the client may select to file a claim or continue without filing a claim for the missing item as shown in FIG. 58. If the client selects to file a claim, then a furniture condition interface shown in FIG. 59 may be displayed where the client may be presented with a choice to take picture or proceed without taking picture to file a claim. If the client selects to take picture, then interface shown in FIG. 56 may be displayed, otherwise inventory interface shown in FIG. 60 and claim form shown in FIG. 61 may be displayed.

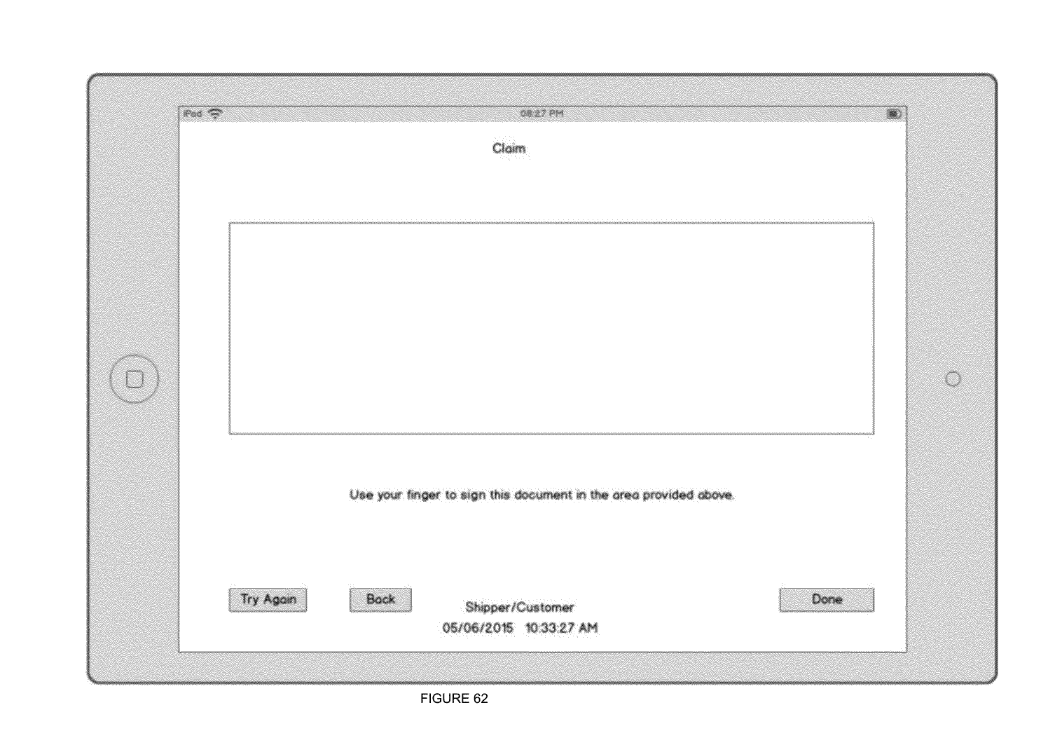

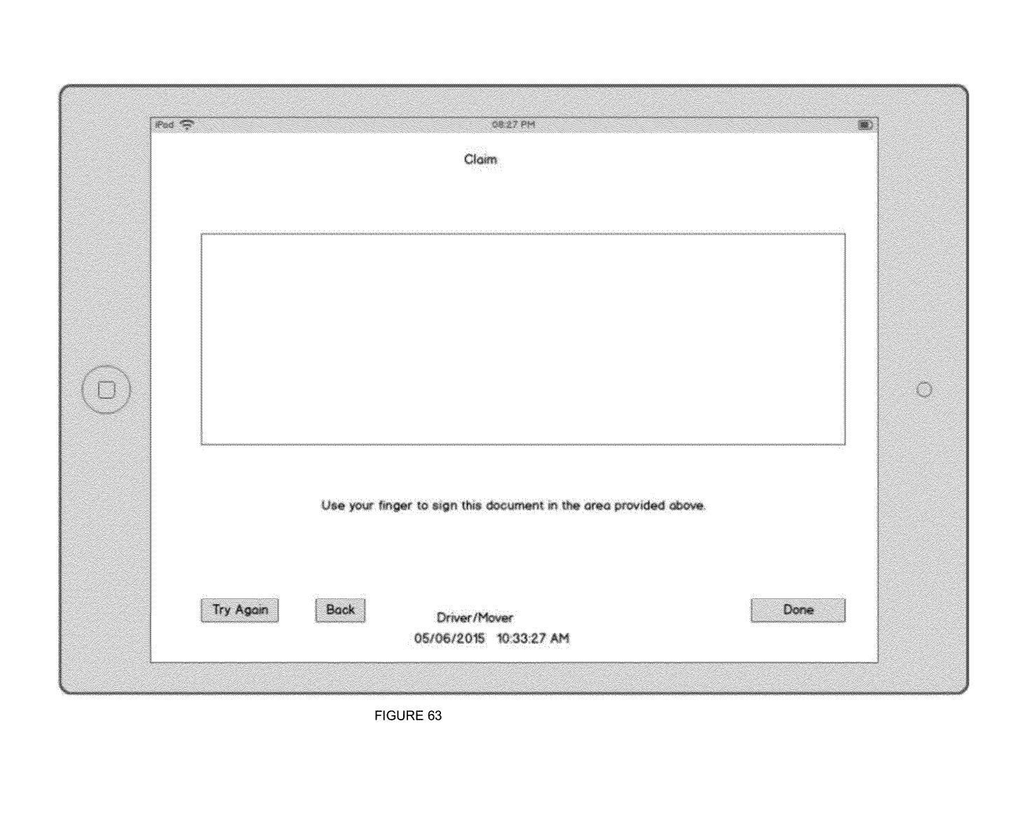

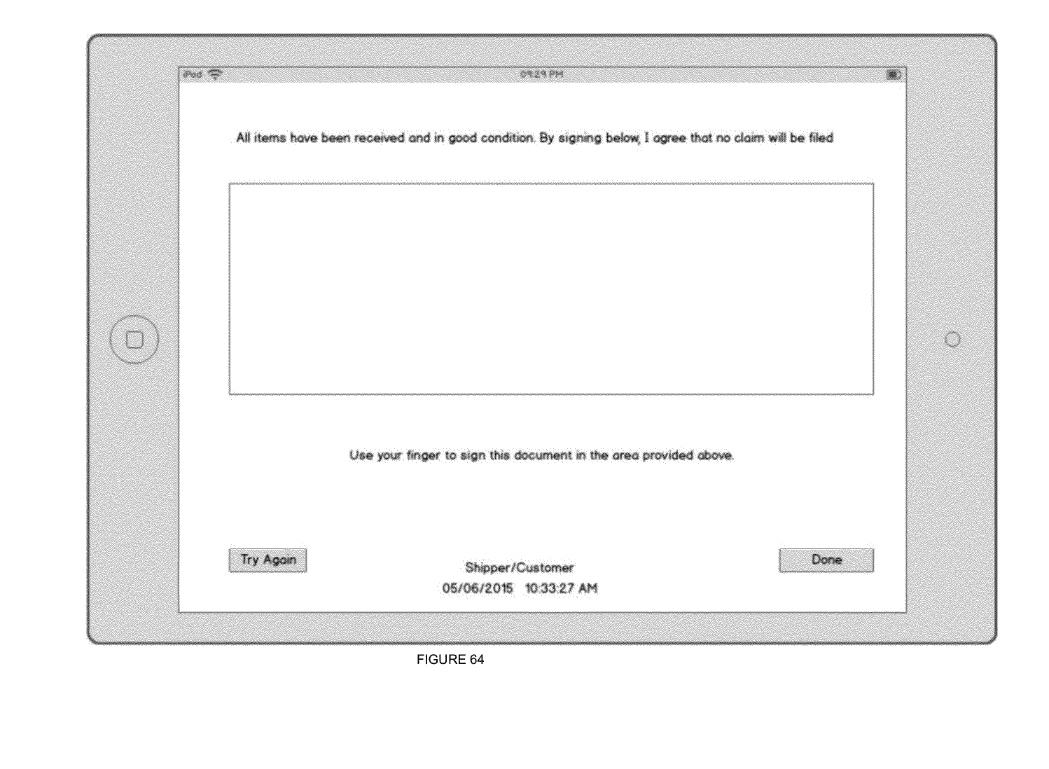

After the client filling the claim form the client may sign and the driver will counter sign as shown in FIGS. 62 and 63 respectively. The claim form may be sent to office for processing and a copy thereof may be sent to the client. Alternatively, if all items were received in a sound condition at the destination location and no exceptions were listed, then the client may be asked to sign a no claim form as shown in FIG. 64.

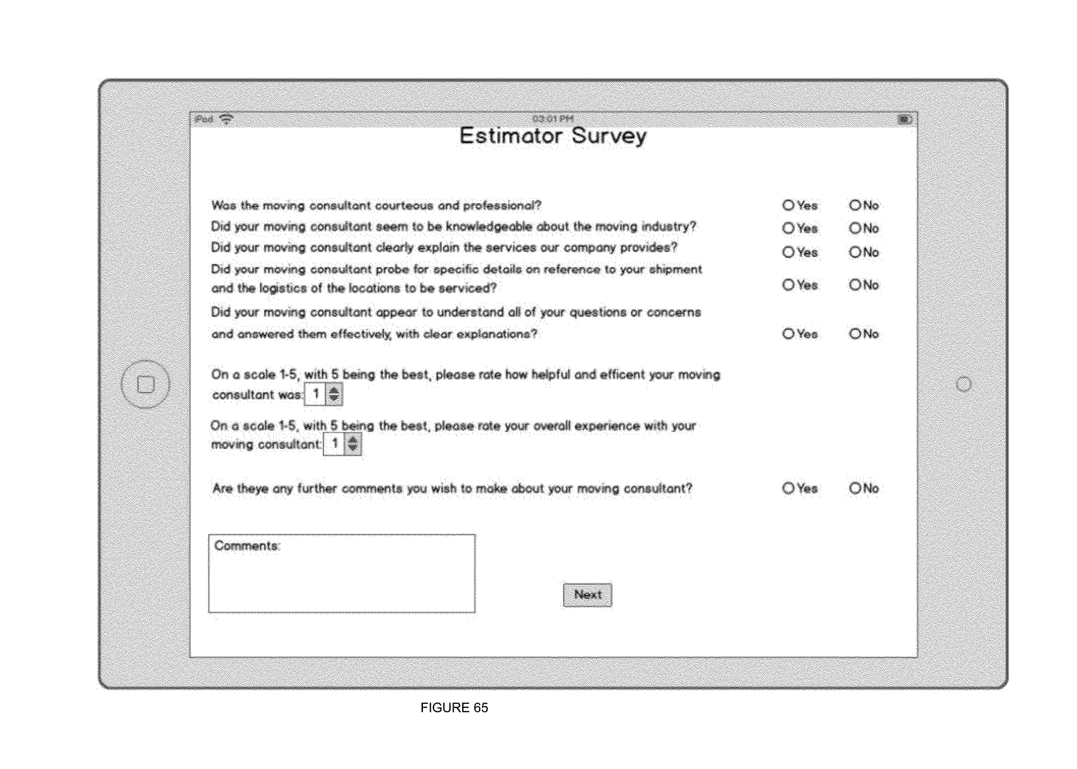

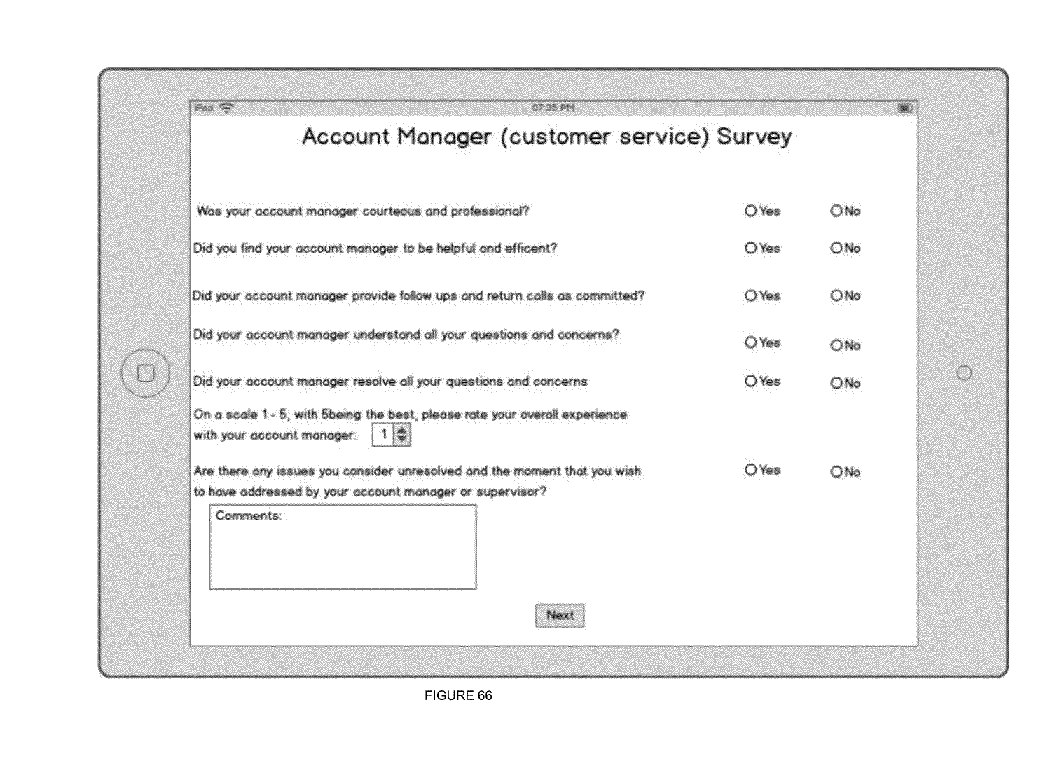

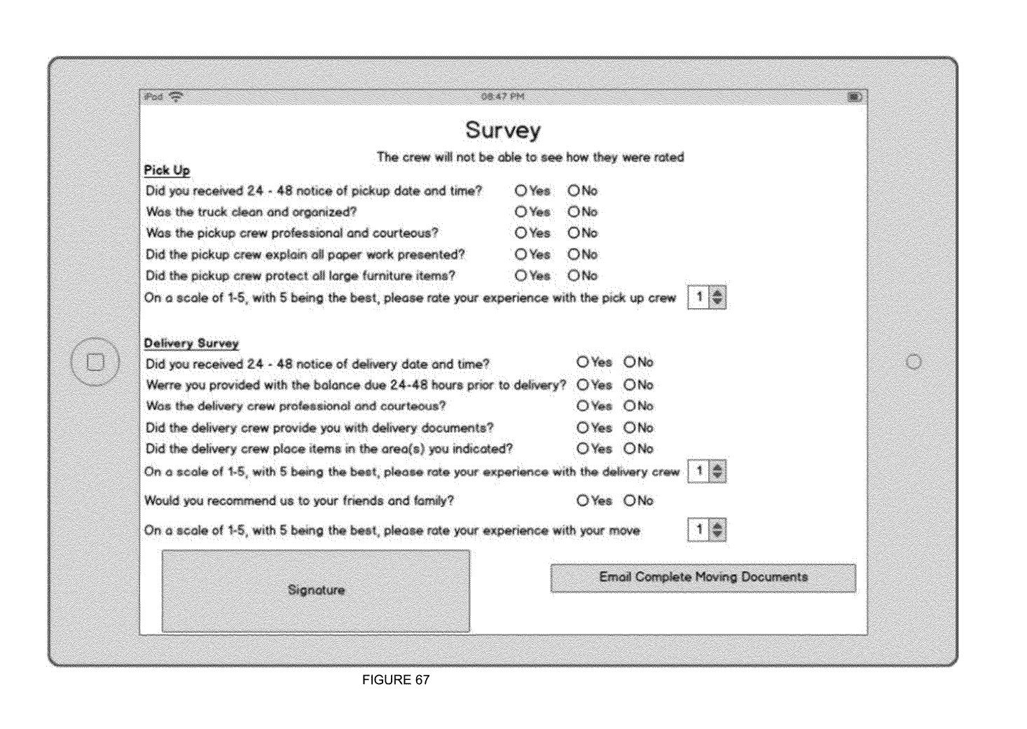

Client may be given an electronic device to take a brief survey. The survey may be broken down into an estimator survey shown in FIG. 65, an account manager (customer service) survey, and a pickup and delivery crew survey. An account manager survey may be displayed on the electronic device interface as shown in FIG. 66. Likewise, a general crew survey may be displayed on the electronic device as shown in FIG. 67. Once survey is completed, the final and complete moving documents may be emailed to client. The survey results may generate statistical information which may subsequently be used to rate various drivers and companies.

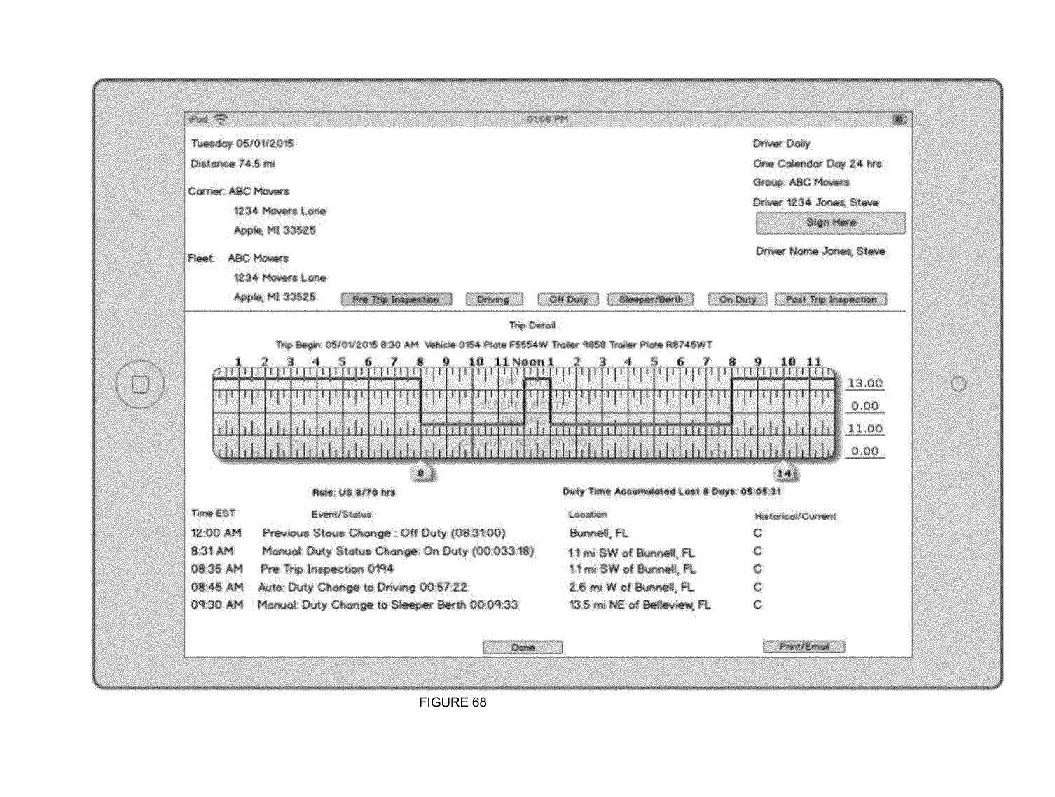

Turning now to FIG. 68, depicting an example of driver's log book wherein, the interface may show information regarding the displayed log such as driver's name, date, distance, carrier name and address, fleet name and address and the like. In an event a driver is using the disclosed system for the first time, then the driver may need to manually enter the miles on the odometer, but subsequently, the disclosed system may get the miles driven via the global position system in communication with the driver's communication device such as a tablet.

Typically, the department of transportation may need the information regarding the trip such as whether or not the given driver has performed pre trip and post trip inspection, time span when the given driver was driving, when the given driver was on duty and off duty, and the like. Instead of having each driver manually entering the above mentioned trip details, the disclosed system may enable the given driver to indicate a specific event by selecting various options shown in FIG. 68.

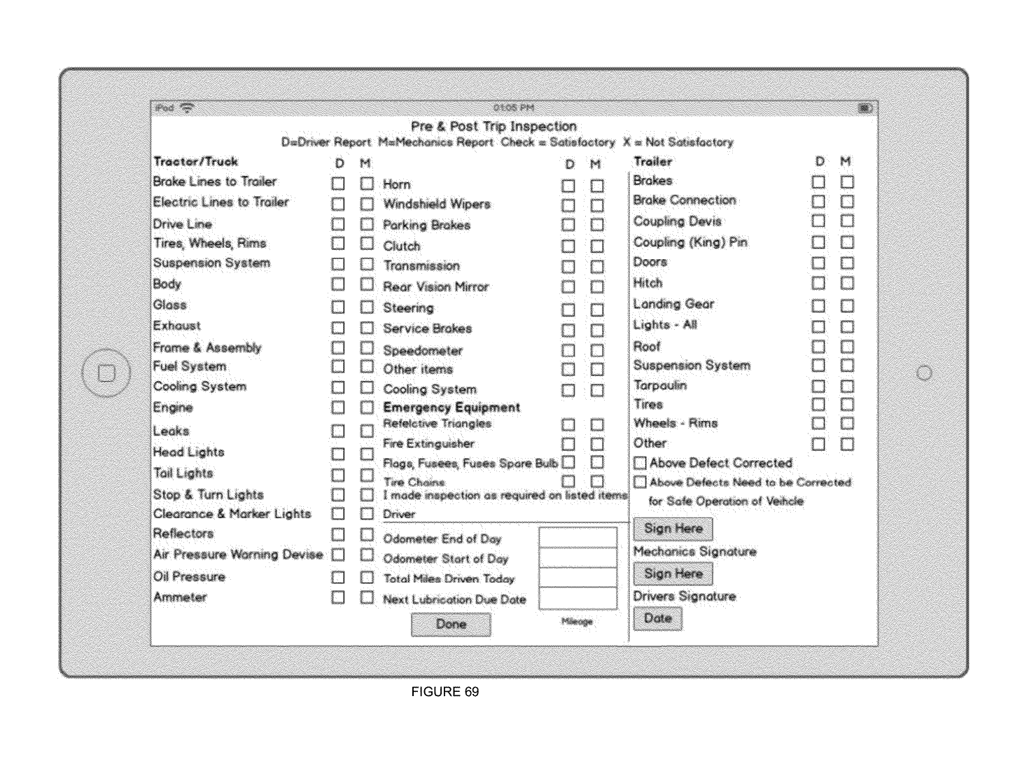

For example, the driver may select options pre-trip and post-trip options to denote that the driver has completed a pre-trip inspection and post trip inspection respectively. The pre and post trip inspection interface is displayed in FIG. 69.

The driver may select option driving to indicate that the driver is currently driving. Similarly, the driver may select on duty option and off duty option to reflect that the driver is on duty and the driver is off duty respectively. The driver may indicate that the driver was resting by selecting sleeper/berth option. In other words, instead of having the given driver manually note start and end times of the above mentioned events, the preferred embodiment may advantageously generate an electronic log as shown in FIG. 68.

In one embodiment of the disclosed invention, the disclosed system may provide a compliance company an access to the given driver's electronic logs. Thus, the compliance company may, remotely observe and process any infractions in real time. In this embodiment the system may optionally email the electronic logs of the given driver to the compliance company.

In other words, the log book may contain information within a specific time frame such as miles driven by the driver, hours of sleep, states the driver went through and the like. Furthermore, time, event, location, and historical or current log indicator may also be displayed on the interface shown in FIG. 68. After reviewing the information displayed on the interface, the admin and compliance companies may select to edit/rate the driver log, select print option to print or email log or select done option to conclude the driver log review.

Now discussing FIG. 69, displaying a pre and post inspection details that drivers, administrators and compliance officials may be able to view on demand. Various parts of equipment that need to be checked as part of pre and post inspection are listed under the heading tractor/truck such as breaks, horn, engine, oil pressure and the like. A pre-trip inspection may ensure that the equipment is in sound mechanical condition before the equipment departs for a delivery or a pickup assignment. Similarly, a post trip inspection may catch any equipment issues that need to be addressed after the equipment completes given assignment. For each category listed on the interface the driver may indicate in the D section a positive mark if the listed item is in a sound mechanical condition.

Likewise, the driver may, indicate a check mark in the selection box in D section, if the listed item in the category is in a sound mechanical condition. Alternatively, if the driver does not indicate a check mark in the selection box, it is assumed that the listed item in the category is defective and the item needs either repair or replacement.

Accordingly, for each item with a negative mark in the D section, a mechanic may fix the item and indicate an item fixed indicator mark in the M section. In other words, each item listed on the interface may either have a positive mark in the D section, or may have a negative mark in the D section. If a negative mark is indicated in the D section, and the mechanic may indicate a positive mark in M section after fixing the defect.

The interface may also indicate odometer information such as odometer reading at the start and end of the given day, total miles driven on the given day, the day when next lubrication is due, and the like. After performing the pre and post trip inspection, the driver and the mechanic may sign the log report. After indicating the inspection date the driver may conclude the transaction by selecting done option or alternatively, email or print the report.

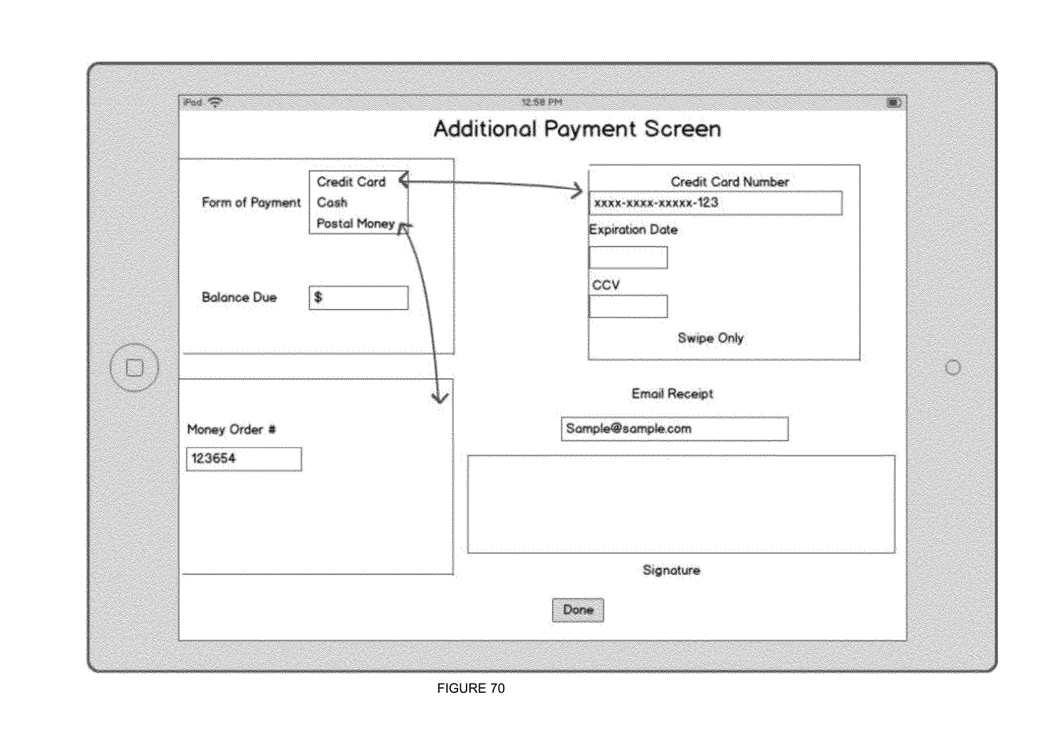

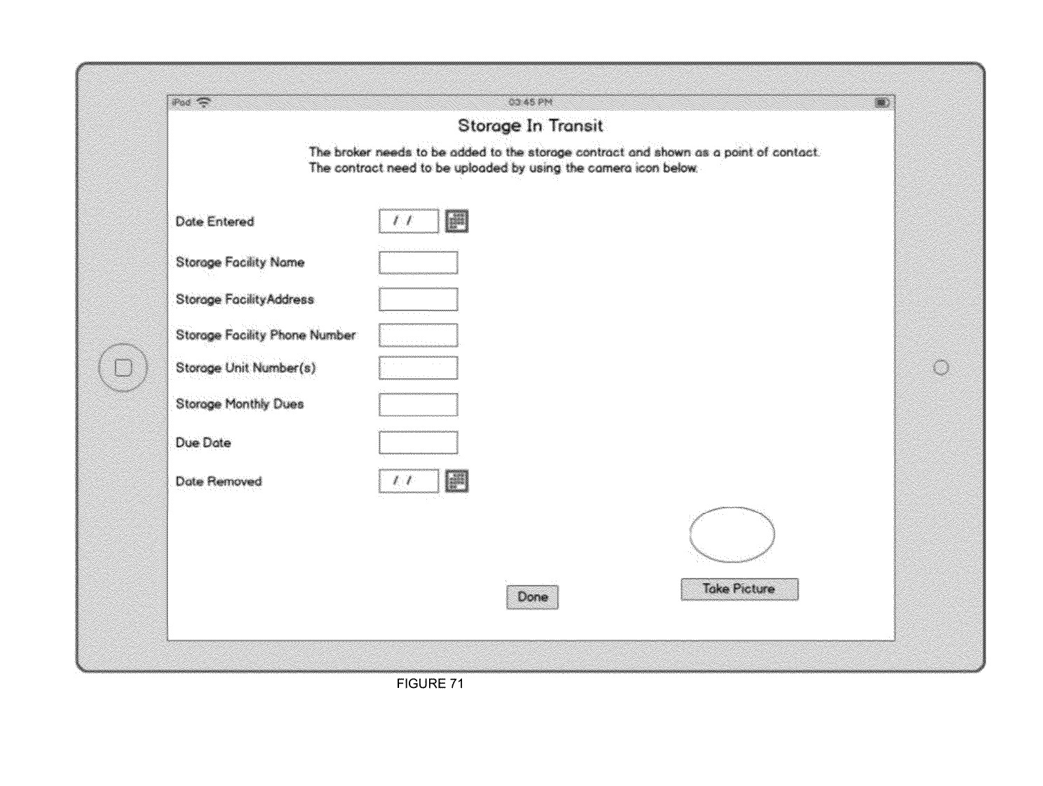

Now referring to FIG. 70 showing additional payment interface displaying credit card information input area and money order information input area. The client may after providing either credit card or money order information to pay additional payment and email address for emailing the receipt, may sign the form before selecting done option to cause the display of the storage in transit interface shown in FIG. 71.

The storage in transit (SIT) may be used when client is not able to take delivery and requires the load to be held on the truck or in a third party facility for a period of time. The driver will be required to specify the information regarding the storage in transit such as the date when the load was placed in the SIT facility, the SIT facility name, address, phone number, the unit number where the load is placed, monthly dues of the SIT facility, the due date when the load was to be moved, and the actual date when the load was removed, if the load was placed in a third party facility.

Furthermore, the driver may also need to take a picture of the contract and upload the picture into the system to ensure that the office is aware of the location of the load and make sure that the monthly bills are promptly paid to prevent a possible lockout. FIG. 72 shows a thank you page whereby the moving company may thank the client for the business opportunity.

Notably, all of the aforementioned links may be navigated by the driver via a set of voice activated commands. Likewise, all the aforementioned links are exemplary links. Many other similar links may be availed to the driver which can save valuable time and resources of the driver in electronically searching the information contained in these links. For example, if the driver senses vehicle battery issues, then the driver may not have time to pull over, stop the vehicle, turn the vehicle off and then pull up his mobile device, search for signal and then conduct a search for a nearby repair facility. Instead, using the voice activated interface, the driver may quickly identify the nearby repair facility and drive straight to the identified repair facility to get the repairs done.

Likewise, vehicle diagnostic systems may be electronically monitored from a remote location to reduce the driver's burden of vehicle maintenance. Similarly compliance with various state ordinances may also be electronically monitored from a remote location to reduce the driver's burden of maintaining ordinance compliance. Furthermore, driver's medical condition may also be electronically monitored from a remote location whereby the driver can indicate for example, “I can't breathe” or “My leg is frozen” and the administrator or an operator using the disclosed system may in addition to picking up the driver's call may also identify the nearby hospital or a peer deriver located in proximity to help the unwell driver.

The foregoing discussion of the preferred embodiments has been provided only by way of introduction. Nothing in this section should be taken as a limitation of the claims, which define the scope of the invention.

1. A method for dynamically orchestrating a set of driver functions during transportation of a load from a source location to a destination location, the method comprising:
authenticating credentials of a driver;
displaying a main interface presenting a set of options to the driver;
displaying an inventory list interface enumerating the items to be moved and packed;
displaying a furniture list enumerating a set of items and an associated set of furniture attributes for each item in the set of items;
displaying an estimate interface indicating a set of load attributes as received by the estimator at time of booking;
presenting a set of valuation coverage options to the client to protect the contents of the move;
displaying an inventory check in interface at the destination location for the client to inspect each item in the inventory for any possible damage; and
presenting a final bill of lading to the client upon arrival of the client's load at the destination location before displaying a payment screen interface for the driver to select a form of payment.

2. The method of claim 1, wherein the set of options presented to the driver via the main interface comprise:
displaying a dashboard interface presenting a set of dashboard options to the driver;
displaying a driver's route interface presenting the driver all the incomplete loads;
displaying a log book interface presenting the driver information within a specific time frame, the information comprising: a number of miles driven by the driver, a number of hours of sleep, a number of states the driver went through;
displaying a useful links interface presenting the driver useful links to identify a location of the nearby weight station, a packing material retailer location, a truck stop location information, a truck repair shop location information;
displaying based on a set of customer survey results, a my stats interface indicating the driver's statistical information comprising: the percentage of assignments where loads were picked up within the scheduled pickup dates, the percentage of assignments where loads were delivered within scheduled the delivery dates, and a claim percentage; and
displaying a completed jobs interface showing all the jobs completed by the driver in the past.

3. The method of claim 1, further comprising the step of displaying a weight ticket interface whereby the driver may capture the photographs of the weight tickets at the source location and at the destination location, and optionally conduct a rerate procedure if the weight ticket at the destination location is heavier than the weight ticket at the source location.

4. The method of claim 1, further comprising the step of performing a set of post contract services rendered at time of delivery, but not foreseen at the time of the pickup.

5. The method of claim 1, further comprising the step of comparing the photographs of the damaged items captured at the source location with the photographs of the damaged items captured at the destination location to identify the nature of the damage via a set of condition codes.

6. The method of claim 1, wherein the set of driver functions comprise:
viewing a dashboard displaying a list of loads assigned to the driver, a log book, weather information in the driver's location area, and the driver's statistical information;
viewing a list of incomplete loads before selecting a job for viewing the load specific information;
viewing a job acceptance form to ascertain a set of job attributes comprising: a job number, a job source location, a job destination location, a packing instruction, a storage instruction, an inventory information, and a special handling instruction;
accepting a selected job via the job acceptance form before getting directions to the selected job destination location and commencing paper work for the selected job;
creating an inventory indicating a list of items to be moved from the source location to the destination location by capturing a photograph of the actual item and describing a condition of the item;
creating an original cost estimation and revising the original cost estimation after reviewing at least one of: a move estimation as computed at time of booking, a furniture list, an additional charge, an additional service required during the pickup, an additional service required during the delivery, and the packing instruction; and
accepting a payment upon transmitting the inventory from the source location to the destination location.

7. The method of claim 1, further comprising the step of displaying a summary of items received and a summary of missing items and optionally displaying a claim submission interface for missing items.

8. The method of claim 1, further comprising the step of presenting a survey interface to the client to take at least one of an account manager survey, and a pickup and delivery crew survey.

9. The method of claim 1, further comprising the step of displaying a job acceptance form interface allowing the driver to view load details and begin the move paper work in response to the driver selecting a job acceptance form option.

10. The method of claim 1, wherein, the set of incomplete loads comprise a set of pending rerate loads, a set of pending pick up loads, and a set of pending delivery loads.

11. The method of claim 1, wherein the set of driver functions comprise performing a pre-trip and a post-trip inspection to indicate a condition of the driver's equipment, logging the distance driven by the driver, the locations visited by the driver, and time driven by the driver, and logging a status of the driver at all times to indicate a condition of the driver.

12. The method of claim 1, further comprising the step of displaying on the job acceptance form a pickup address, a delivery address, a client contact number, an estimated weight of the load, a pickup date, a delivery date, the miles between source and destination locations, and an estimated cash on demand.

13. The method of claim 1, wherein the step of maintaining the log book further comprises the steps of:
assigning a driving status to the driver indicating that the driver is driving;
assigning an off duty status to the driver indicating that the driver is not performing driving related duties;
assigning a sleeper status to the driver indicating that the driver was resting; and
assigning an on duty status to the driver indicating that the driver is not driving but performing work related duties.

14. The method of claim 13, further comprising the steps of displaying the starting odometer reading, the ending odometer reading and making available the driver's log book to a compliance official.

15. The method of claim 1, wherein the set of load attributes comprise a shipper name, a load number, a source location city, a source location state, a source location zip, a destination city location, a destination state location, a destination location zip, and an estimate summary, wherein the estimation summary comprises a transportation cost, a bulky furniture transportation charge, an accessory charge, a packing charge, an unpacking charge, a storage charges, and a binding estimate charge.

16. The method of claim 1, further comprising the step of presenting an add furniture interface to add furniture to the furniture list.

17. The method of claim 1, wherein the set of furniture attributes comprise an item type, an item weight, an item quantity, and a volume of an item.

18. The method of claim 1, further comprising the steps of:
displaying a revised packing charge for packing additional items requested by the client; and
generating a revised written estimate to reflect a change in the cost of the original estimate based on the revised packing charge, based on a set of added items and a set of additional services.

19. The method of claim 1, further comprising the step of noting a condition of each item in the inventory list and optionally capturing an item number, a lot number and a color code, and a video recording of each item in the inventory list.

20. A system for dynamically orchestrating a set of driver functions during transportation of a load from a source location to a destination location, the system configured to:
authenticate credentials of a driver;
display a main interface to present a set of options to the driver;
display an inventory list interface enumerating the items to be moved and packed;
display a furniture list enumerating a set of items and an associated set of furniture attributes for each item in the set of items;
display an estimate interface to indicate a set of load attributes as received by the estimator at time of booking;
present a set of valuation coverage options to the client to protect the contents of the move;
display an inventory check in interface at the destination location for the client to inspect each item in the inventory for any possible damage; and
present a final bill of lading to the client upon arrival of the client's load at the destination location before displaying a payment screen interface for the driver to select a form of payment.

21. The system of claim 20, wherein the set of options presented to the driver via the main interface comprise:
display a dashboard interface presenting a set of dashboard options to the driver;
display a driver's route interface presenting the driver all the incomplete loads;
display a log book interface presenting the driver information within a specific time frame, the information comprising: a number of miles driven by the driver, a number of hours of sleep, a number of states the driver went through;
display a useful links interface presenting the driver useful links to identify a location of the nearby weight station, a packing material retailer location, a truck stop location information, a truck repair shop location information;
display based on a set of customer survey results, a my stats interface indicating the driver's statistical information comprising: the percentage of assignments where loads were picked up within the scheduled pickup dates, the percentage of assignments where loads were delivered within scheduled the delivery dates, and a claim percentage; and
display a completed jobs interface showing all the jobs completed by the driver in the past.

22. The system of claim 20, further configured to display a weight ticket interface whereby the driver may capture the photographs of the weight tickets at the source location and at the destination location, and optionally conduct a rerate procedure if the weight ticket at the destination location is heavier than the weight ticket at the source location.

23. The system of claim 20, further configured to perform a set of post contract services rendered at time of delivery, but not foreseen at the time of the pickup.

24. The system of claim 20, further configured to compare the photographs of the damaged items captured at the source location with the photographs of the damaged items captured at the destination location to identify the nature of the damage via a set of condition codes.

25. The system of claim 20, wherein the set of driver functions comprise:
view a dashboard displaying a list of loads assigned to the driver, a log book, weather information in the driver's location area, and the driver's statistical information;
view a list of incomplete loads before selecting a job for viewing the load specific information;
view a job acceptance form to ascertain a set of job attributes comprising: a job number, a job source location, a job destination location, a packing instruction, a storage instruction, an inventory information, and a special handling instruction;
accept a selected job via the job acceptance form before getting directions to the selected job destination location and commencing paper work for the selected job;
create an inventory indicating a list of items to be moved from the source location to the destination location by capturing a photograph of the actual item and describing a condition of the item;
create an original cost estimation and revise the original cost estimation after reviewing at least one of: a move estimation as computed at time of booking, a furniture list, an additional charge, an additional service required during the pickup, an additional service required during the delivery, and the packing instruction; and
accept a payment upon transmitting the inventory from the source location to the destination location.

26. The system of claim 20, further configured to display a summary of items received and a summary of missing items and optionally displaying a claim submission interface for missing items.

27. The system of claim 20, further configured to present a survey interface to the client to take at least one of an account manager survey, and a pickup and delivery crew survey.

28. The system of claim 20, further configured to display a job acceptance form interface allowing the driver to view load details and begin the move paper work in response to the driver selecting a job acceptance form option.

29. The system of claim 20, wherein, the set of incomplete loads comprise a set of pending rerate loads, a set of pending pick up loads, and a set of pending delivery loads.

30. The system of claim 20, wherein via the set of driver functions the system is configured to perform a pre-trip and a post-trip inspection to indicate a condition of the driver's equipment, log the distance driven by the driver, the locations visited by the driver, and time driven by the driver, and log a status of the driver at all times to indicate a condition of the driver.

31. The system of claim 20, further configured to display on the job acceptance form a pickup address, a delivery address, a client contact number, an estimated weight of the load, a pickup date, a delivery date, the miles between source and destination locations, and an estimated cash on demand.

32. The system of claim 20, further configured to:
assign a driving status to the driver to indicate that the driver is driving;
assign an off duty status to the driver to indicate that the driver is not performing driving related duties;
assign a sleeper status to the driver to indicate that the driver was resting; and
assign an on duty status to the driver to indicate that the driver is not driving but performing work related duties.

33. The system of claim 32, further configured to display the starting odometer reading, the ending odometer reading and making available the driver's log book to a compliance official.

34. The system of claim 20, wherein the set of load attributes comprise a shipper name, a load number, a source location city, a source location state, a source location zip, a destination city location, a destination state location, a destination location zip, and an estimate summary, wherein the estimation summary comprises a transportation cost, a bulky furniture transportation charge, an accessory charge, a packing charge, an unpacking charge, a storage charges, and a binding estimate charge.

35. The system of claim 20, further configured to present an add furniture interface to add furniture to the furniture list.

36. The system of claim 20, wherein the set of furniture attributes comprise an item type, an item weight, and a volume of an item.

37. The system of claim 20, further configured to:
display a revised packing charge for packing additional items requested by the client; and
generate a revised written estimate to reflect a change in the cost of the original estimate based on the revised packing charge, a set of added items and a set of additional services.

38. The system of claim 20, further configured to note a condition of each item in the inventory list and optionally capturing a photograph and a video recording of each item in the inventory list.
